(19) United States
(12) Patent Application Publication
(10) Pub. No.: US 2003/0158960 A1
(43) Pub. Date: Aug. 21, 2003

(54) System and method for establishing a privacy communication path

(76) Inventor: Stephan J. Engberg, (US)

Correspondence Address: KLEIN, O'NEILL & SINGH, LLP, Suite 510, 2 Park Plaza, Irvine, CA, 92614, US

(21) Appl. No.: 10/302,738

(22) Filed: Nov. 22, 2002

Related U.S. Application Data
(63) Continuation-in-part of application No. PCT/DK01/00352, filed on May 22, 2001.
(60) Provisional application No. 60/206,565, filed on May 23, 2000.

(30) Foreign Application Priority Data
May 22, 2000 (DK) PA 2000 00814

(51) Int. Cl. G06F 15/16

(52) U.S. Cl. 709/237; 709/228

(57) ABSTRACT

A privacy infrastructure platform or system provides for privacy enabling communication and secures trade of both electronic and physical goods and services. Through user-controlled communication rules, including an access control filter and a dynamic routing service, the individual is in control of communication. The system enables a universal user-controlled opt-in filter for SPAM protection. Support is provided for privacy enabling the full value chain from the original supplier to the consumer. In addition, the system supports trade across existing standard barriers, supporting standard conversion, government reporting, and existing and future eCommerce standards such as EDIFACT, OFX, OBI and CBL. Privacy is established using a principle of multiple non-linkable pseudonyms or virtual identities (VID), combined with intermediation of on- and off-line communication channels.

### CROSS-REFERENCE TO RELATED APPLICATION

This application is a continuation-in-part of co-pending International Application No. PCT/DK01/00352; filed May 22, 2001, the disclosure of which is incorporated herein by reference. This application claims the benefit, under 35 USC Section 119(e), of U.S. Provisional Application No. 60/206,565; filed May 23, 2000.

### FEDERALLY-SPONSORED RESEARCH OR DEVELOPMENT

Not Applicable

### BACKGROUND OF THE INVENTION

A Chief Counsel for NSA, Baker, remarked once: “The biggest threats to privacy in a digital world come not from what we keep secret but from what we reveal willingly”.

Since identified individuals have to transfer personal information if they want to have customized products, services, advice etc., they may at the same time lose the rights of privacy. In an electronically connected world the threats to privacy are multiplied due to the ease of collecting and sharing information about individuals across multiple points of contact. Threats to privacy are real which are supported by multiple examples of hidden data collection and the fast growing industry of consumer profiling.

The central problem about privacy is that an individual when identified loses control over private information rendered. From this point the individual is exposed to all kinds of problems including errors, fraud, outdated information, identity theft, discrimination etc. Legislative initiatives or self-regulating mechanisms are not enough to remove this problem [S. A. Brands 1999 PHD thesis later published as “Re-thinking Public Structures and Digital Certificates”, MIT Press, 2000, ISBN 0-262-02491-8].

Only by non-identification can an individual retain his privacy while at the same time get the desired customized services. However, the problems of staying non-identified are massive.

Basically two approaches partially delivering non-identified trade have been used until now. One is total atomization of privacy without the use of a Trusted Party (for instance [S. A. Brands 1999 PHD thesis later published as “Re-thinking Public Structures and Digital Certificates”, MIT Press, 2000, ISBN 0-262-02491-8] focussing on a theoretical best case scenario in this direction). Another is use of a Trusted Party knowing the detailed profile of an individual and acting as a Customer Agent (for a worst-case scenario in the form of an infomediary see “Net Gain: Expanding Markets Through Virtual Communities” by John Hagell III & Arthur G. Armstrong, March 1997, Harvard Business School Press, ISBN 0-87584-759-5 and “Net Worth: Shaping Markets When Customers Make The Rules” by John Hagell III and Marc Singer, January 1999, Harvard Business School Press, ISBN 0-87584-889-3).

Due to the value of Customer Profile Data for marketing purposes, the Trusted Agent approach is very attractive, and many variations of this approach are implemented or under implementation. The main problem with this approach is the danger of abuse. Instead of obtaining privacy, the individual is giving someone total profile information. A trusted party selling individual profile information directly or indirectly, without the control of the individual, is a devil in disguise. The Big Brother scenario of a totalitarian government taking control of the database is a worst-case scenario, but merely leaving such detailed profile information to someone with a financial focus is troublesome due to natural incentives for abusing information.

Theoretically one should therefore favor the atomization of privacy without the use of a trusted party. Some solutions exist for online anonymous browsing, emailing, digital cash etc., with the Canadian Company Zero-Knowledge as the probable leading and most elegant implementation. However no solutions have proven able to handle the full range of aspects to cover these issues, as well as telephone service, financial credit, delivery and real-world transactions in a manner that is viable for implementation. It is of no help that some actions or information are anonymous when delivery is to an identifiable address.

One central problem with these theoretical optimal privacy solutions is that they do not protect the rights of the non-anonymized parties from different forms of fraud. Without any form of traceability the anonymized party is free to do or say anything without the risk of being brought to justice. Credit—for one—is risky business, dangerous if not impossible.

More importantly humans want to have relations with other humans and suppliers. Values and history have big impacts on loyalty of customers. If anonymity were more important than relations, then branding and loyalty would not have such a focus.

The basic demand for a privacy solution is that it has to cover the full Customer Life Cycle, including interactions around needs and suggestions over the actual trade process to post-trade service, repeat sales etc. More importantly this has to be non-restrictive on communication and include real-world trade also. Solutions only covering the online interactions and purchase of electronic goods, such as knowledge or online services, will not start to cover the full range of privacy issues. Existing standards around privacy are totally inadequate to provide anonymity. P3P—a standard pushed by for instance Microsoft—is basically an automatic profile information pusher. It totally fails to handle the basic issue of releasing identifiable information, per definition leading to total loss of information control.

State of the art security methods for private information delivery and filtering in public networks, such as described in U.S. Pat. No. 5,245,656, incorporated herein by reference, generally fail to disclose information regarding bi-directional requests of communication paths. The referenced US patent describes a method for an end-user of a network, which end-user remains anonymous to a service provider during a request for information from the service provider to the end-user. This disables the service provider's tracing of the end-user, and consequently the communication path is terminated.

Partners in commercial and other relationships want convenience and trust in continuous interactions. Society as a whole is based on a principle of responsibility or accountability to law.

An individual wants privacy control, which is presently a full trade-off with the goals of convenience and accountability, because privacy control requires non-traceability of information to an individual identity, or more precisely non-linkability across actions, knowledge, or other types of information without an individual's consent.

Society is increasingly witnessing a process where privacy is reduced due to absolute identification. Linkable information about individuals is accumulating in multiple databases outside individual control, and is available for any type of abuse. This problem is a fundamental threat to freedom as the very basis of a democratic society and for the social and economic well being of society because of reduced quantity and quality of relationships as individuals refuse to accept giving up privacy.

An object of the present invention is therefor to provide a system to solve this problem such that individuals have full privacy control over persistent and convenience-rich relationships—only restricted by minimum requirements to accountability in case of fraud as defined by law.

### SUMMARY OF THE INVENTION

The invention implements a Privacy Infrastructure Platform that provides a solution for privacy enabling communication and secure trade of both electronic and physical goods and services. Through user-controlled Communication Rules including an Access Control Filter and a Dynamic Routing service, the individual is in control of communication and enables a universal user-controlled Opt-In filter for SPAM protection.

The invention builds a support for privacy, enabling the full value chain from the original supplier to the consumer. In addition the invention can support trade across existing standard barriers supporting standard conversion, government reporting and existing and future eCommerce standards such as EDIFACT, OFX, OBI and CBL.

Privacy is established using a principle of multiple non-linkable pseudonyms or Virtual Identities (VID) combined with intermediation of on- and offline communication channels. The solution is Privacy Enhancing, putting the individual in control. The Individual is free to encrypt content of communication and private data using any encryption technique. The Individual will retain the ability to stop any further contact with specific companies without these companies having identifiable private information to abuse. In case of criminal activity the trusted party can reveal the identity of the individual after legal proceedings protecting individual rights, which can include anonymous legal representation.

The invention establishes an infrastructure for communication, trade and marketing services for personal relationship management and corporate customer relationship management. The invention builds a service platform for communities, auctions and market makers, combined with a service interface for privacy-enabled customer agents and selling agents, where private information can be made available for analysis under individual control.

The invention also provides a solution to reverse the increasing sales/marketing communication pressure on the individual by resort to a “suggestion house” where the individual is in control. The suggestion house structures the pre-purchase phase, handling inbound suggestions, requested offers, interest lists, wish lists with restricted access, shopping lists and full use of the Privacy Platform Trade services for fulfillment of purchases including anonymous delivery.

Businesses restricted by law from using customer data will be able to fully utilize customer information for improving customer offerings and service, because all private individual data are anonymous, and public reporting intermediation services are available.

The above described objects, advantages and features together with numerous other objects, advantages and features of the present invention which will be evident from the following description of preferred embodiments of the present invention are, according to a first aspect of the invention, obtained by a method of establishing a communication path between a first and a second legal entity, comprising the steps of:

providing a first virtual identifier of the first legal entity to the second legal entity,

and establishing a communication path in accordance with a set of communication rules specified by the first legal entity between the first and the second legal entity, the first legal entity remaining anonymous to the second legal entity.

A communication path could be any path adapted for communication between two legal entities such as between two persons or between a person and an electronic agent of a legal entity such as an Internet shop. As an example a regular phone line, a mail system, a postal mail delivery, a short-range wireless session involving infrared or other wireless communication protocols, a physical contact in a store, a confirmation request, a payment request, a legal dispute settlement or any Internet related communication attempt.

A set of communication rules could be a list of logical rules determining whether said communication path should be established, how such a communication path should be established, by whom such a communication path should be established, to whom such a communication path should be established, based on access to actual information related to any of the legal entities, the actual situation, the history leading to the situation, expert or other advice such as a content scanner, information about the communication path or the communication itself whether based on information freely, compulsorily, or otherwise collected, accessed or evaluated. A set of communication rules further could include information as to providing the second legal entity with authentication or profile information related to said communication path and/or the first legal entity.

A virtual identifier could be a virtual identifier of a company combined with a company only unique identifier, such as a company tax registration number combined with a random, but unique, customer number or a customer chosen nickname. A virtual identifier could also be related to a specific communication channel such as an email-address or a public digital signature key related to a company-specific pseudonym. A preferred embodiment involves providing a virtual identifier equaling establishing an authenticated yet anonymous session in any kind of communication path.

A first or second legal entity could be a person acting in any role such as a legally identified person acting as a private individual, or an employee acting as a purchaser of a company. It could also be an electronic agent acting on behalf of a legal entity.

The first legal entity is established with means to remain anonymous to the second legal entity even with multiple establishments of any communication path across online and offline channels such as telephone conversations, physical appearance in a shop, package deliveries, payments, interactive internet sessions or email.

The second legal entity according to the first aspect of the present invention may be provided with means for obtaining a legal identification of the first legal entity based on the virtual identifier. Further, the means for legal identification may be provided by a third legal entity according to a set of rules agreed between the first legal entity and the third legal entity. Additionally, the means for legal identification may be provided by a third legal entity according to a set of rules determined by a fourth legal entity.

The method according to the first aspect of the present invention may further comprise a step of providing the second legal entity with means for associating a first virtual identifier of a first legal entity with a previous communication path established with that first legal entity. Further, the second legal entity is provided with means for obtaining information about a previous communication path for a first virtual identifier of a first legal entity.

The method according to first aspect of the present invention may further comprise a step of providing a second virtual identifier of the second legal entity to the first legal entity, the second legal entity remaining anonymous to the first legal entity.

The method according to the first aspect of the present invention may further comprise the step of providing legal identification of the first legal entity to the second legal entity upon request from the first legal entity.

The method according to the first aspect of the present invention may further comprise the step of establishing a communication path to the first legal entity in response to receiving a request from the second legal entity.

The method according to the first aspect of the present invention may further comprise the step of establishing a communication path in accordance with a second set of communication rules specified by the second legal entity.

The method according to the first aspect of the present invention may further comprise the step of establishing a communication path to the second legal entity in accordance with the second set of communication rules in response to receiving a request from the first legal entity.

The method according to the first aspect of the present invention may further comprise the step of establishing the communication path between the first legal entity and the second legal entity in response to a request from a third legal entity, the communication path being established in accordance with the first set of communication rules and the second set of communication rules.

A communication path according to the first aspect of the present invention may be established between the first legal entity and the third legal entity and wherein another communication path is established between the second legal entity and the third legal entity so as to establish communication between the first legal entity and the second legal entity. The communication path between the first legal entity and the third legal entity may be established in accordance with the first set of communication rules. Further, the communication path between the second legal entity and the third legal entity may be established in accordance with the second set of communication rules. Furthermore, the communications path may be categorized, wherein the communication path is established in response to a request, and the request may comprise a communication path category and a virtual identifier of a legal entity. Additionally, the communication path may be adapted to transfer information between the first and the second legal entity and the information may be evaluated based on a pre-determined criterion determined by the first legal entity. The selected information may be transferred to a first information carrier based on the evaluation and/or the first set of communication rules.

The third legal entity according to the first aspect of the present invention may be provided with a profile of the first legal entity, and the third legal entity may be invited to transfer selected information from the first information carrier to a second information carrier based on the profile. Further, the third legal entity may be provided with information about a communication path established between a first and a second legal entity, wherein the first legal entity remains anonymous to the third legal entity.

A commercial transaction according to the first aspect of the present invention may be established based on information comprised in the first and/or the second information carrier.

The communication path according to the first aspect of the present invention may be established between a first legal entity and a second legal entity based on information about a previous communication path established with the second legal entity. A preference list of the first legal entity may be created from the information about the communication path.

The second legal entity according to the first aspect of the present invention may be provided with a profile of the first legal entity. Further, the third legal entity may confirm the profile, the first legal entity remaining anonymous to the second legal entity. Furthermore, the second legal entity may be provided with means for requesting the profile based on rules defined by the first legal entity. Additionally, the second legal entity is provided the profile by the first legal entity.

The method according to the first aspect of the present invention may establish a communication path between a first legal entity and a second legal entity based on information about a previous communication path established with the second legal entity.

The method according to the first aspect of the present invention may enable a “closed loop control” of communication interactions, wherein evaluation of a previous interaction can be used, e.g., to establish trust in a company using the communication path to advertise. If the company behaves maliciously, this information will be available, e.g., for potential customers of that company who may have a filter rule which is based on the evaluation as part of their communication rules. Another consequence of malicious behavior is that customers may as part of their set of communication rules have a threshold evaluation value for accepting authentication.

The above described objects and advantages, together with numerous other objects, advantages and features of the present invention which will be evident from the following description of preferred embodiments of the present invention are, according to a second aspect of the invention, obtained by a method for commercial transactions between a first legal entity and a second legal entity, wherein a communication path may be established by the method according to the first aspect of the present invention, and wherein the communication path may be adapted for providing a legal commitment of one of either the first or the second legal entity, the first legal entity remaining anonymous to the second legal entity.

A third legal entity according to a second aspect of the invention may confirm existence of a traceable non-reputable legal commitment of the one of either the first or the second legal entity. Further, the third legal entity may provide proof of the existence of the legal commitment.

The method according to a second aspect of the invention may further comprise a step of providing the second legal entity with means for associating a first virtual identifier of a first legal entity with previous legal commitments established with that first legal entity. Further, the second legal entity may be provided with means for obtaining information about previous legal commitments for a first virtual identifier of a first legal entity.

A legal commitment according to a second aspect of the invention may be established between a first legal entity and a second legal entity based on information about previous legal commitments established with the second legal entity.

A third legal entity according to a second aspect of the invention may be provided with information about legal commitments between a first and a second legal entity, and the first legal entity may remain anonymous to the third legal entity.

The legal commitment according to a second aspect of the invention may comprise performing at least one of the following activities:

transferring legal rights between a first and a second legal entity,

transferring goods or services between a first and a second legal entity,

arbitrating a dispute between a first and a second legal entity.

The first legal entity according to a second aspect of the invention may remain anonymous to the second legal entity. The second legal entity may remain anonymous to the first legal entity.

The first legal entity according to a second aspect of the invention may transfer a financial instrument to the second legal entity, the first legal entity remaining anonymous to the second legal entity. The first legal entity may transfer a first financial instrument to a third legal entity, upon receipt of said first financial instrument, the third legal entity may transfer a second financial instrument to the second legal entity, the first legal entity remaining anonymous to the second legal entity.

The method according to a second aspect of the invention may further comprise the second legal entity delivering a service to the first legal entity, the second legal entity addressing a virtual identifier of the first legal entity. Moreover, the method may further comprise the steps of:

depositing a financial instrument with a third legal entity,

the first legal entity ordering a service from the second legal entity,

the second legal entity requesting confirmation of payment from the third legal entity, and

the second legal entity delivering the service addressing the virtual identifier of the first legal entity upon receipt of the confirmation.

The address of the virtual identifier according to a second aspect of the invention may comprise an identifier of the third legal entity, a virtual identifier of the second legal entity, and encrypted: the virtual identifier of the first legal entity, and an identifier of the service. The encrypted identifiers may be decrypted by a key common to the second and third legal entity.

The step of delivering according to a second aspect of the invention may comprise the steps of:

forwarding the service to a fourth legal entity, and

requesting a physical delivery address from the third entity by means of the fourth legal entity.

The method according to the second aspect of the present invention may further comprise the step of the third legal entity providing the physical delivery address to the fourth legal entity according to the first set of communication rules. Additionally, the step of delivering may further comprise the step of: receiving a receipt acknowledging delivery of the service at the physical address by means of the fourth legal entity. The receipt may comprise a proof of delivery at the physical delivery address. The proof of delivery may be verified by the fourth legal entity.

The method according to the second aspect of the present invention may further comprise the step of releasing payment according to a pre-defined set of trade rules. The set of trade rules is agreed between the first and the second legal entity.

The step of ordering a service according to the second aspect of the present invention may be performed in a physical or electronic market place, such as an auction, a stock exchange, a community, a trade portal, etc.

The above described objects and advantages, together with numerous other objects, advantages and features of the present invention which will be evident from the following description of preferred embodiments of the present invention are, according to a third aspect of the invention, obtained by a method for commercial transactions between a first legal entity and a second legal entity, wherein a first communication path is established between the first legal entity and a third legal entity, and wherein a second communication path is established between the second legal entity and the third legal entity, and wherein the first and second communication path is adapted for providing a legal commitment of the first legal entity towards the second legal entity, said legal commitment comprising the steps of:

the first legal entity providing the second legal entity with an identifier,

the second legal entity requesting from the third legal entity a first legal commitment provided the identifier,

the third legal entity requesting from the first legal entity a second legal commitment, and

the third legal entity accepting the request from the second legal entity upon receipt of the second legal commitment.

The communication according to the third aspect of the present invention may be between the third and the first legal entity established by a fourth legal entity, the communication path to the first legal entity remaining unknown to the third legal entity. Further, the communication path is established according to the method according to the first aspect of the present invention.

The methods according to the first, second or third aspects of the present invention relate to methods for commercial transactions between a first legal entity and a second legal entity, wherein a communication path is established according to the previously mentioned method for communication, and wherein the communication path is adapted for providing a legal commitment of one of either the first or the second legal entity, the first legal entity remaining anonymous to the second legal entity.

Anonymous legal commitments, such as a trade of goods or payment for an item, can be established using a trusted party acting on behalf of an entity who wants to remain anonymous. The trusted party could, e.g., be provided with means for proving the existence of an identifiable legal commitment. This could, e.g., be a message containing a legal commitment—such a contract—encrypted using a key shared between the parties of the legal commitment but unknown to the trusted party. The trusted party thus receives a signature from the parties of the legal commitment that they agree to the commitment. Upon receiving an identified or traceable identifiable signature by an entity, the trusted party can confirm the existence of the signed legal commitment to any other entity by providing the encrypted message, e.g., signed by the trusted party on the behalf of a client taking part in the legal commitment.

The method according to the first, second or third aspect of the present invention relates to methods for commercial transactions between a first legal entity and a second legal entity, wherein a first communication path is established between the first legal entity and a third legal entity and wherein a second communication path is established between the second legal entity and the third legal entity and wherein the first and second communication paths are adapted for providing a legal commitment of the first legal entity towards the second legal entity, said legal commitment comprising the steps of:

the first legal entity providing the second legal entity with an identifier,

the second legal entity requesting from the third legal entity a first legal commitment provided the identifier,

the third legal entity requesting from the first legal entity a second legal commitment, and

the third legal entity accepting the request from the second legal entity upon receipt of the second legal commitment.

The identifier provided by the first legal entity to the second legal entity could, as an example, be a credit card. A customer, e.g., in an Internet store or in a restaurant, provides a credit card for paying the bill. The restaurant then contacts a credit card verifier for verification of the credit card payment. Before providing the restaurant with verification, the credit card verifier establishes a strong authenticated contact with the customer, before returning a confirmation of the payment to the restaurant. The strong authenticated contact session can be an access controlled mobile phone, through an Internet connection or by means of any other direct way of addressing the customer—even by addressing the customer through the restaurant using a previous agreed one-time-only challenge-response sequence.

The methods according to the first, second or third aspects of the present invention relate to methods of contacting the customer, and may be characterized in that the communication between the third and the first legal entity is established by a fourth legal entity, the communication path to the first legal entity remaining unknown to the third legal entity.

The fourth legal entity may, as an example, be a trusted party providing anonymous legal commitments from the client or customer. According to this embodiment, the Internet store, restaurant or similar credit card payment requester is not provided with information as to identify the customer.

The commercial transaction could be established by means of the previously described method of communication.

The above described objects and advantages, together with numerous other objects, advantages and features of the present invention which will be evident from following description of preferred embodiments of the present invention are, according to a fourth aspect of the invention, obtained by a system for establishing a privacy communication channel between a first client and a second client and said system comprising:

(a) a general authentication device for providing said first client control of a private encryption key stored in a mobile processing and memory unit,

(b) a communication channel provider for communicating with said first client and for establishing a privacy communication channel for said first client,

(c) an authentication unit for communicating through said privacy communication channel with said first client and for providing a first intermediary between said first client and said second client, said authentication unit enabling said first client to establish a first virtual identity having a first virtual communication channel and to establish a rule-based communication routing scheme for said privacy communication channel, and

(d) a trust unit for communicating with said authentication unit through said virtual communication channel providing a second intermediary between said virtual identity of said first client and said second client and for providing storage of first client profile information,

wherein said first client applies said private encryption key for encrypting said profile information so as to enable anonymous communication from said first client to said second client.

The authentication unit according to the fourth aspect of the present invention may further enable the second client for establishing a second virtual identity having a second virtual communication channel and establishing a rule based communication routing scheme for a privacy communication channel between the authentication unit and the second client. Alternatively, the system may further comprise an integration unit for communicating with said second client and for providing said second client an interface to said first virtual identity of said first client.

The mobile processing and memory unit according to the fourth aspect of the present invention may comprise SmartCard enabling Zero-knowledge authentication.

The general authentication device according to the fourth aspect of the present invention may comprise:

(a) a main processing unit for establishing and controlling communication with a communication channel provider interconnecting said general authentication device and said authentication unit,

(b) a unit reader for connecting a mobile processing and memory unit with the general authentication device, and

(c) a memory space for containing a persistent identifier of said general authentication device accessible by said mobile processing and memory unit, and/or said mobile processing and memory unit authenticating the privacy communication channel to the authenticating unit on the basis of the persistent identifier in the memory space.

The system according to the fourth aspect of the present invention may further comprise an ID Unit issuing said mobile processing and memory unit for the general authentication device. The ID unit may store identifiable information encrypted by applying a plurality of encryption keys comprising a public key of a legal institution. Thus the system may provide the client with full privacy control of the first client identity and information related to the first client, however the information is subject to basic accountability principles.

The authentication unit according to the fourth aspect of the present invention may enable the first client signing an agreement and authenticate towards a third-party based on a sign-on identity stored in the mobile processing and memory unit. Further, the authentication unit may enable the first client establishing a plurality of virtual identities each having a set of virtual communication channels.

The system according the fourth aspect of the present invention may further comprise a device authentication unit providing a certificate to the general authentication device to authenticate any device and verify the certificate.

The trust unit according to the fourth aspect of the present invention may store relationship information and enable access to the relationship information for the first client and the second client, and may protect the authentication unit from knowledge relating to the virtual identity.

The system according to the fourth aspect of the present invention may further comprise a first plurality of general authentication devices, a second plurality of communication channel providers, a third plurality of authentication units, a fourth plurality of trust units, and a fifth plurality of integration units. Further, the system may further comprise a first multiplicity of first clients and a second multiplicity of second clients. Furthermore, the second client may be constituted by a company, a group of companies, a community or any combination thereof.

The system according to the fourth aspect of the present invention may enable anonymity of the first client relative to the second client during a bidirectional communication through the authentication unit. Alternatively, the system may enable anonymity of the first client relative to the second client and enable anonymity of the second client relative to the first client during a bi-directional communication through the authentication unit.

Full privacy control may be achieved by a principle of establishing continuous relationships only needing a persistent virtual identity, a set of related virtual communication channels and services to manage structured interactions.

A number of profile data elements constituting profile information may be attached to any relationships, which number of profile data elements are under the first client's control and may be verifiable by a third party and may provide the specific necessary information for relationship convenience for all parties.

The system according to the fourth aspect of the present invention wherein the first client enabling access for multiple clients having decryption keys to pre-defined data elements of the relationship information for the first client. For instance only some of the multiple clients may have access to data elements containing identifying information while others have only access the non-identified profile information.

It should be noted that the system might privacy-enable even mobile phones without eliminating the convenience of advanced location-tracking services or preventing police etc. from using the same services to investigate crimes.

A particular advantage of the system according to the fourth aspect of the present invention is the ability to enter into a two-way anonymous relationship and sign legally binding documents while still eliminating the risk of a man-in-the-middle-attack.

A primary object of the present invention is to eliminate linkability without individual consent—except for mentioned minimum access to accountability. This can be translated into possible abuse of persistent identifiers whereas related to client, communication devices or communication channels. A secondary object is to build-in damage control in case of linkability. A third object is to ensure convenience and usability, as this is necessary for real-world value of the invention.

According to the fourth aspect of the present invention the first and/or second client may establish a minimum convenience set-up disabling violation of privacy of the client. Alternatively, the first and/or second client may establish a maximum convenience set-up having identified and non-identified relationships incorporated together with privacy communication channels and/or virtual communication channels so as to provide the first and/or second client with full control of communication and relationships with a minimum of linkability.

According to the fourth aspect of the present invention the authenticating unit and the trust unit may be established based on a proxy including mapping routers. The privacy communication channel and or virtual communication channel may be based on a separate mapping unit, such as an email gateway mapping email addresses to ensure that no linkable identifiers are present.

The system according to the fourth aspect of the present invention may incorporate any features as described with reference to the method according to the first, second or third aspect of the present invention.

The above described objects and advantages, together with numerous other objects, advantages and features of the present invention which will be evident from the following description of preferred embodiments of the present invention are, according to a fifth aspect of the invention, obtained by a general authentication device for establishing a privacy communication channel between a client and an authentication unit, and said general authentication device comprising:

(a) a main processing unit for establishing and controlling communication with a communication channel provider interconnecting said general authentication device and said authentication unit,

(b) a unit reader for connecting a mobile processing and memory unit with the general authentication device, and

(c) a memory space for containing a persistent identifier of said general authentication device accessible by said mobile processing and memory unit,

and/or said mobile processing and memory unit authenticating the privacy communication channel to the authenticating unit on the basis of the persistent identifier in the memory space.

The general authentication device according to the fifth aspect of the present invention may only be accessible under control by the mobile processing and memory unit.

The general authentication device according to the fifth aspect of the present invention may incorporate any features as described with reference to the method according to the first, second or third aspect of the present invention and incorporate any features as described with reference to the system according to the fourth aspect of the present invention.

### BRIEF DESCRIPTION OF THE DRAWINGS

In the following description, the invention will be described by means of example with reference to the drawings, in which:

FIG. 1: “100 Systems Overview” shows the logical layer structure of an embodiment implementation.

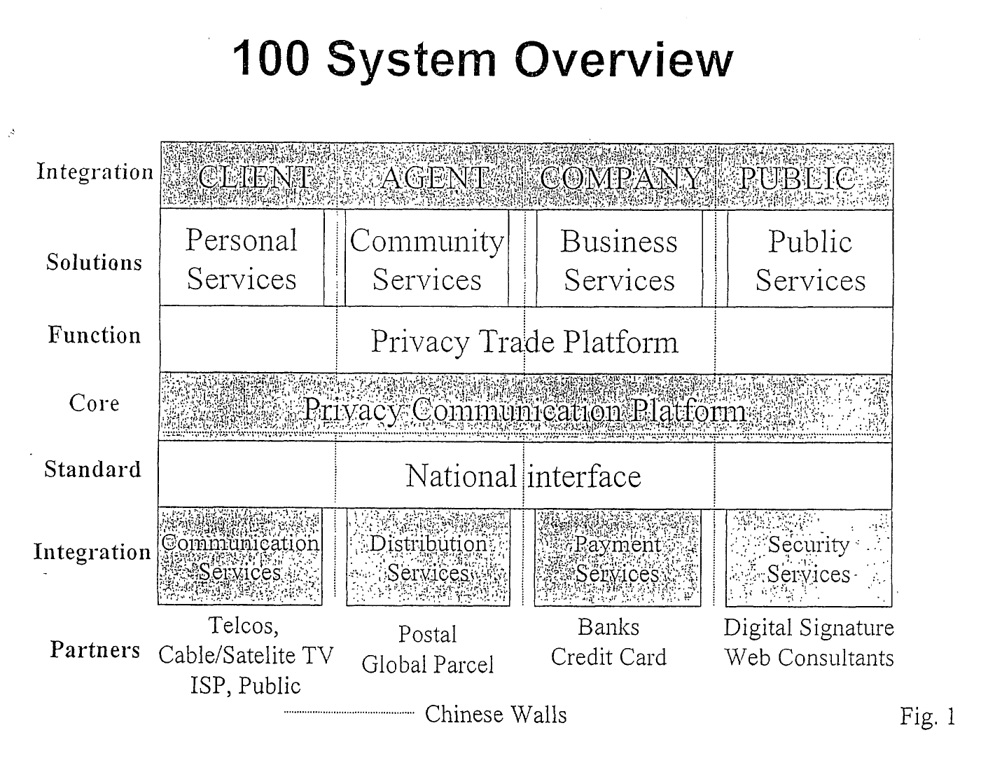

FIG. 2: “200 Central Entities” shows a logical connection diagram between some of the central entities in an embodiment implementation.

FIG. 3: “300 Communication Intermediation” shows an overview of the central principles of communication intermediation in an embodiment implementation.

FIG. 4: “310 Encryption and Intermediation” shows the central logical steps in the session management in an embodiment implementation.

FIG. 5: “320 Establish VID” shows the central steps when establishing a new identity in an embodiment implementation.

FIG. 6: “325 Generate Symkey” shows a principle in which a key only shared between the first and second legal entity can be established without a Trusted Party sheltering the identity of one of the entities knowing the key in an embodiment implementation.

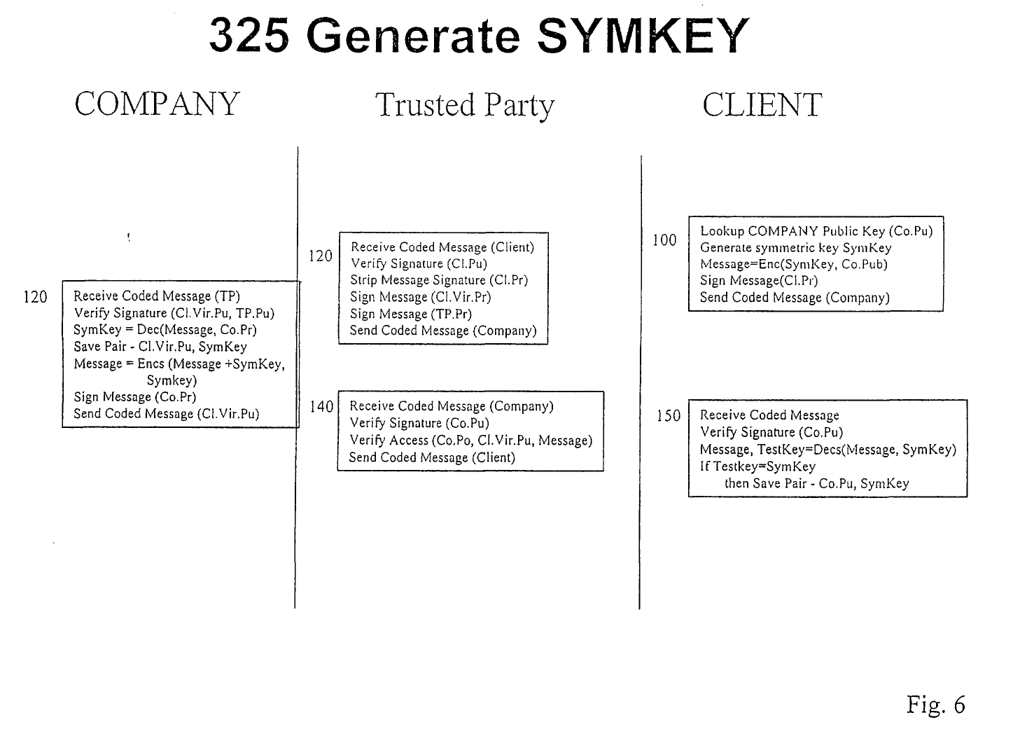

FIG. 7: “330 Communication Encryption” shows in more detail some of the central session management steps for certain communication paths in an embodiment implementation.

FIG. 8: “340 Inbound Intermediation” shows the main steps in the inbound communication intermediation in an embodiment implementation.

FIG. 9: “345 Outbound Intermediation” shows the main steps of the outbound communication intermediation in an embodiment implementation.

FIG. 10: “350 Privacy Enabling Public Reporting Communication” shows the central steps of public reporting respecting CLIENT anonymity in an embodiment implementation.

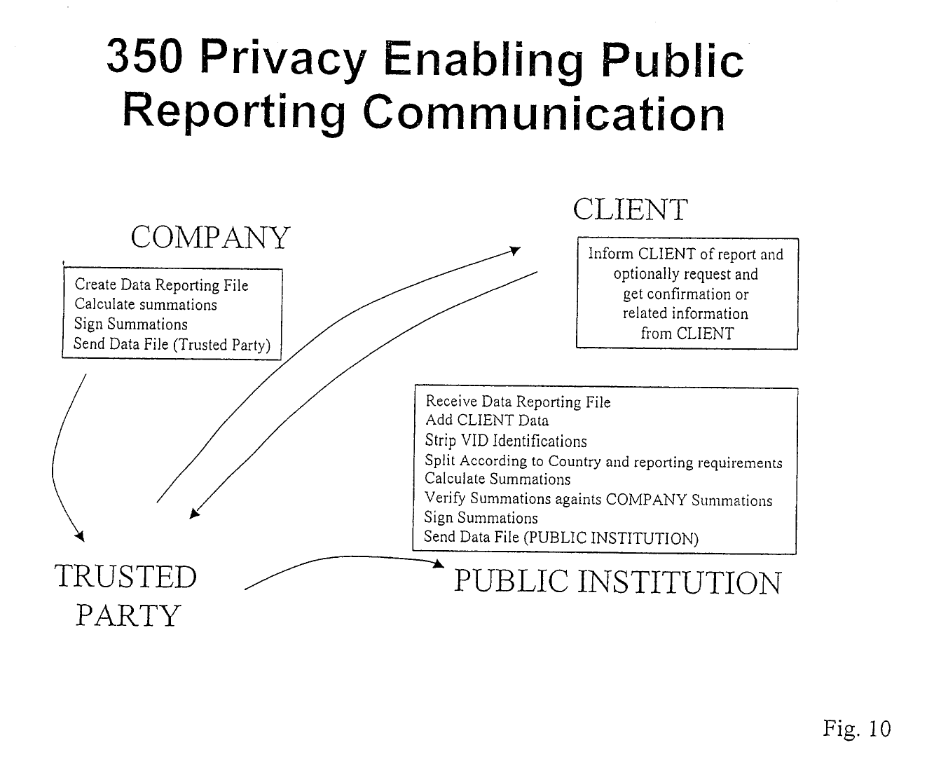

FIG. 11: “360 Private Data Storage” shows a high-level logical structuring of the Private Data Storage in an embodiment implementation.

FIG. 12: “400 Traceability Route” shows how traceability can be implemented respecting multiple interests, protecting each entity from fraud even by the other entities in union in an embodiment implementation.

FIG. 13: “410 Realworld Authentication” shows some of the multiple ways a zero-knowledge authentication can occur in an embodiment implementation even in offline environments such as a store.

FIG. 14: “420 Anonymous Delivery” shows the central steps in achieving anonymous intermediated delivery of physical goods in an embodiment implementation.

FIG. 15: “450 Securing Standard Credit Card Payment” shows how strong authentication can be added to existing standard credit card payments in an embodiment implementation.

FIG. 16: “460 Anonymous Credit Card Payments” shows how anonymous strong authentication can be added to Standard Credit Card payments and intermediated in an embodiment implementation.

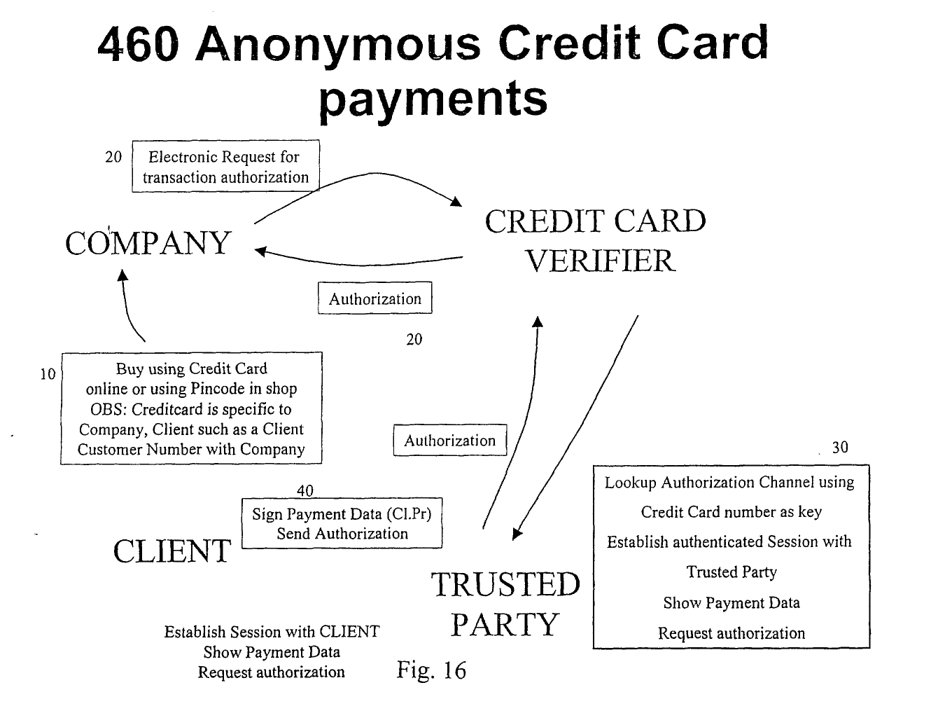

FIG. 17: “470 Realworld Privacy Trade” shows how anonymous strong authentication can achieved in a realworld offline situation such as a normal store purchase in an embodiment implementation.

FIG. 18: “500 Privacy Trade Platform” shows the logical structure of a combination of functions in a full-service Privacy Trade Platform in an embodiment implementation.

FIG. 19: “510 Authentication” shows the main steps in the Authenticator in the direct simple authentication procedure in an embodiment implementation.

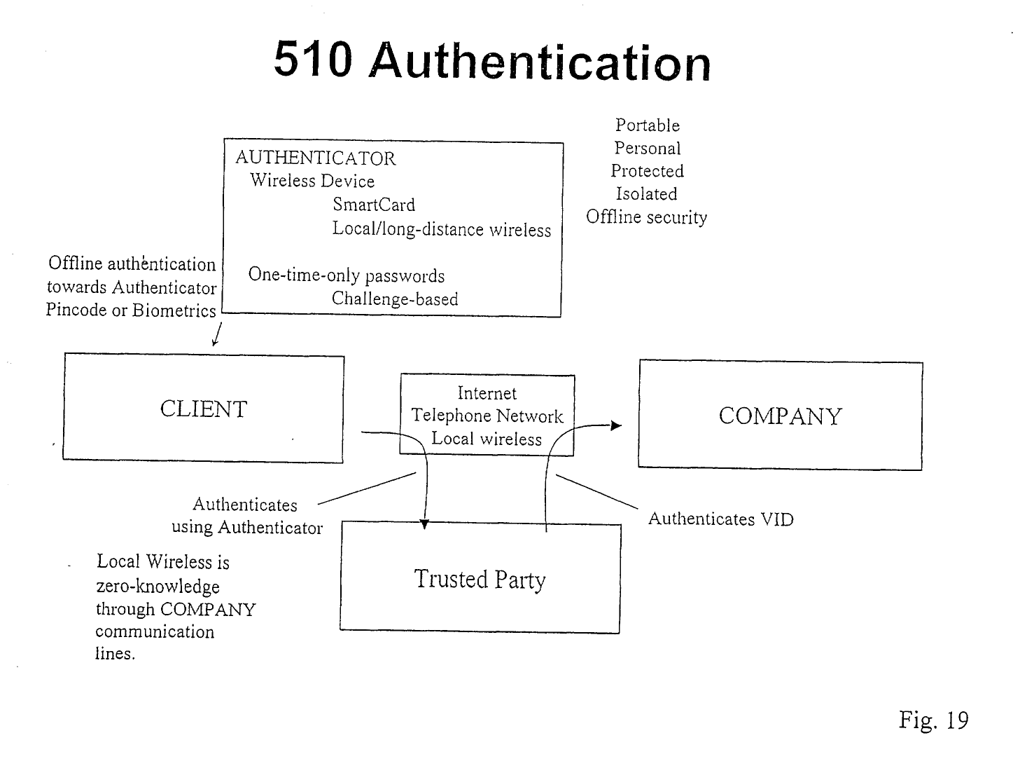

FIG. 20: “520 Anonymous Signature” shows how a legal commitment can be established anonymously using a Trusted Party in an embodiment implementation.

FIG. 21: “560 Online Privacy Payment Intermediation” shows how the online payment process can be intermediated and privacy enabled in an embodiment implementation.

FIG. 22: “590 Anonymous Secure Trade” shows how secure trade balancing releasing payment and goods or services can be implemented in a privacy-respecting manner in an embodiment implementation.

FIG. 23: “600 Community Secure Trade” shows how a secure privacy-respecting trade process can be supported even if CLIENT is identified to one entity by intermediation by a Trusted Party in an embodiment implementation.

FIG. 24: “610 Anonymous Auction” shows how an auction marketplace situation can be supported with secure privacy-enabled trade processes using a Trusted Party in an embodiment implementation.

FIG. 25: “660 Privacy Enabling OBI Standard Trade Specifications” shows an example of how the full value chain can be supported, secured, and privacy enabled by a trusted party using open standard interface specifications in an embodiment implementation.

FIG. 26: “700 Personal Services” shows an example of the outline menu available to CLIENT in a wireless device or online in an embodiment implementation.

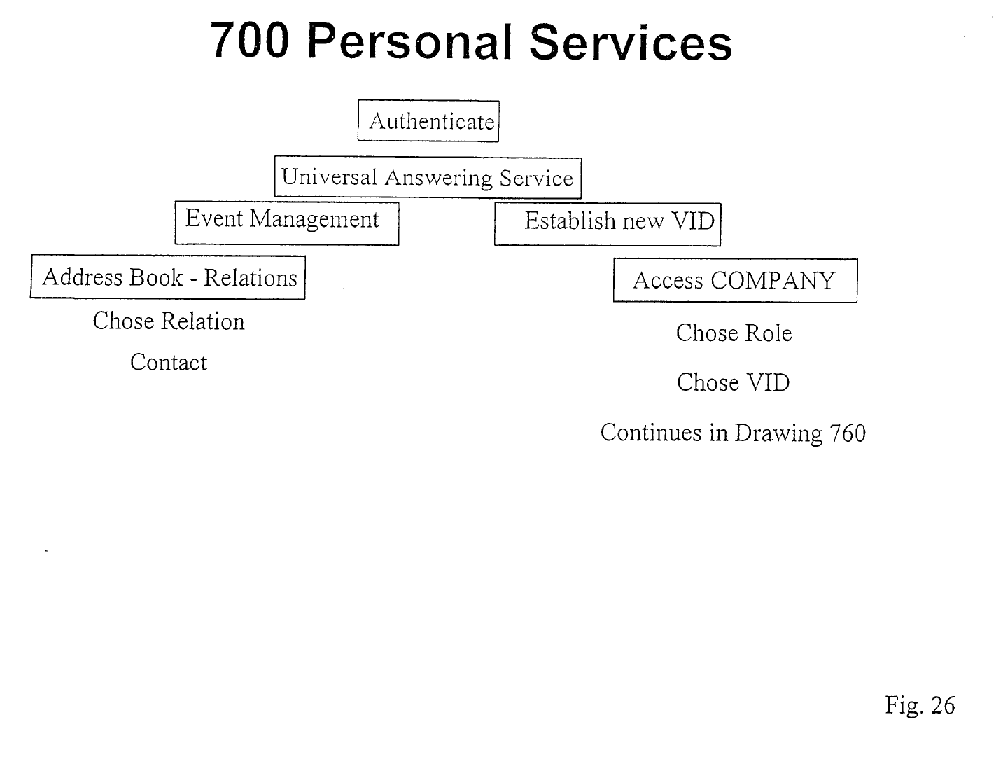

FIG. 27: “710 Suggestion House” shows the logical information flows when Trusted Party support privacy-enabled product and service information search in an embodiment implementation.

FIG. 28: “750 Business Services” shows the logical structure of services towards COMPANY in an embodiment implementation.

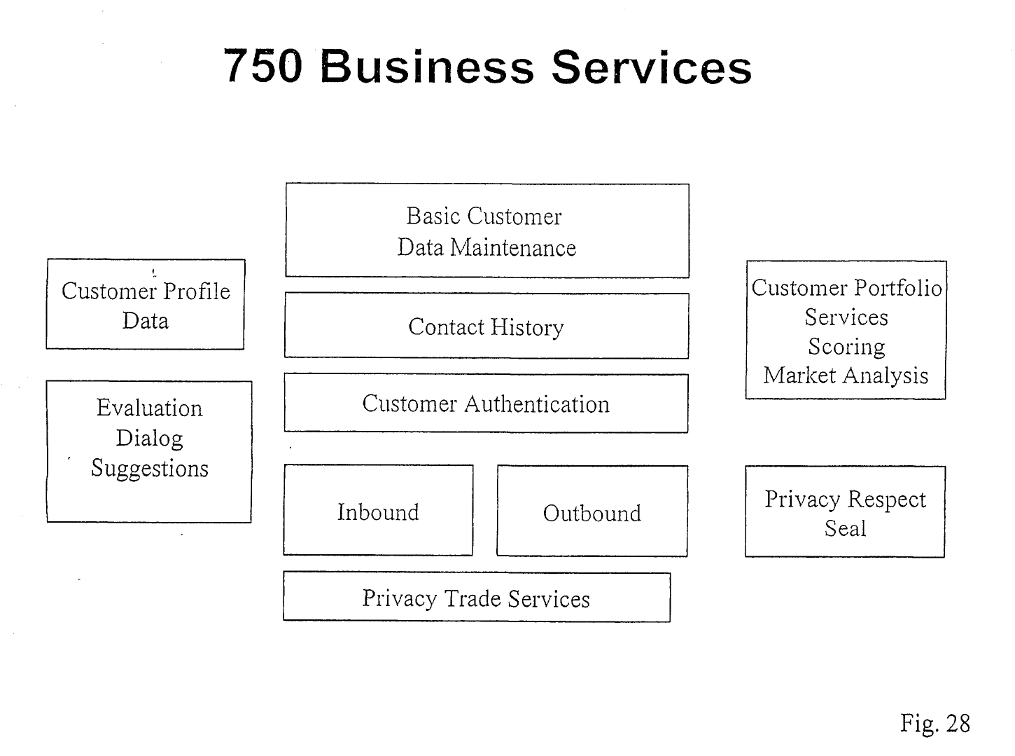

FIG. 29: “760 Business Services Inbound” shows the logical steps in the improved inbound corporate customer communication process using the trusted party dialog service in an embodiment implementation.

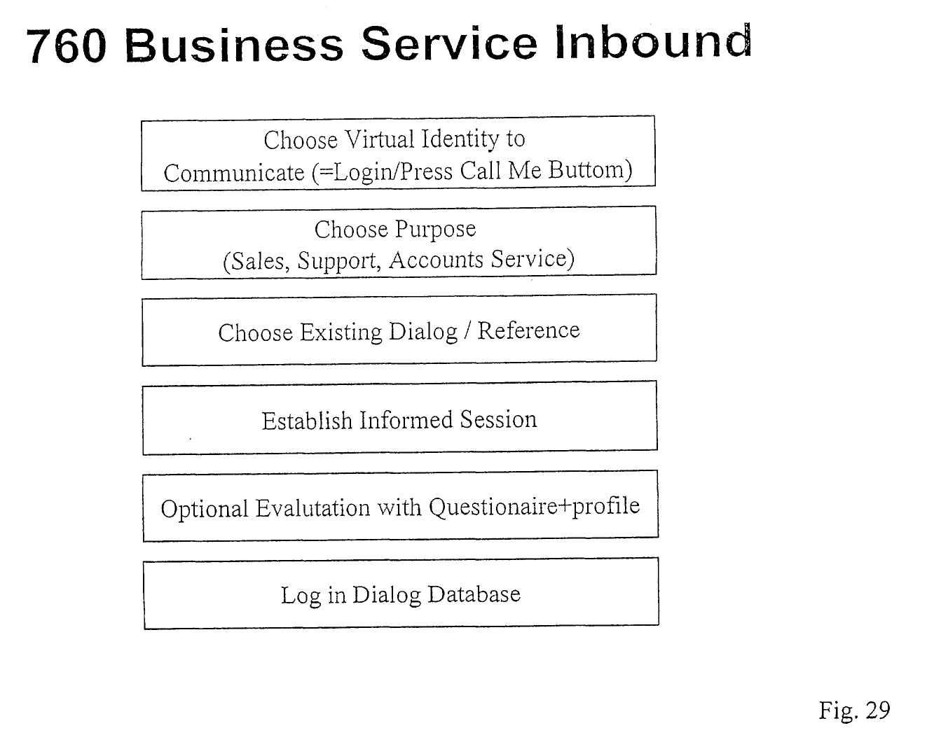

FIG. 30: “770 Business Service Outbound” shows the logical steps in the improved outbound corporate customer communication process using the trusted party dialog service in an embodiment implementation.

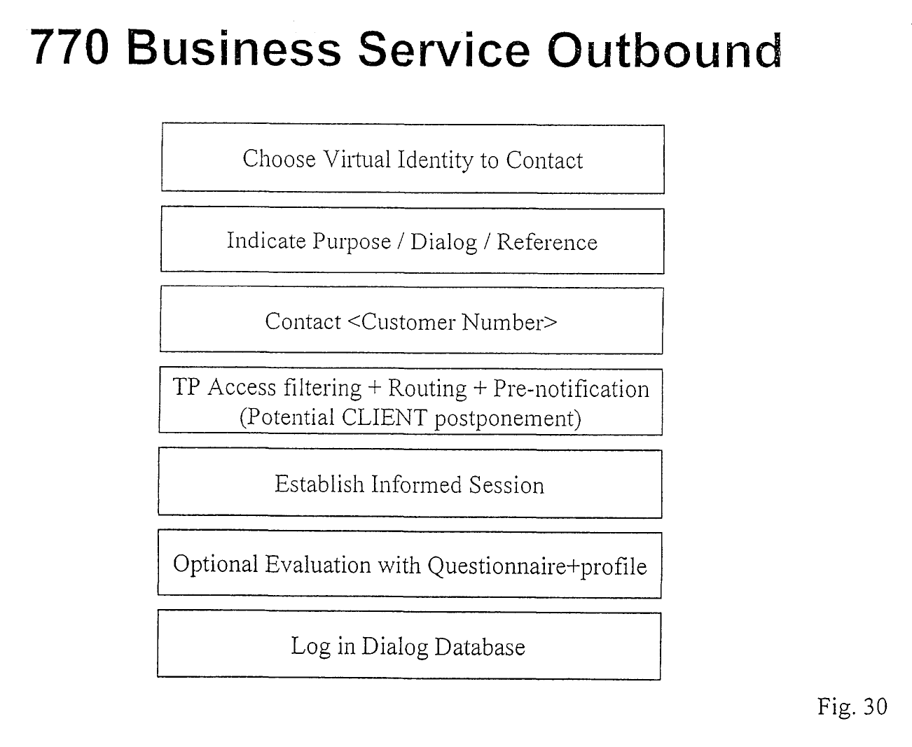

FIG. 31: “780 Privacy Care Trust Certificates and Evaluation Service” shows the logical information flows implementing a closed-loop feedback Trust certificate in an embodiment implementation.

FIG. 32: “80 Total System View” shows the preferred embodiment of the system according to the present invention.

FIG. 33: “50 General Authentication Device” shows the preferred embodiment of a general authentication device of the system according to the present invention.

### DETAILED DESCRIPTION OF THE INVENTION

The invention is implementing a third route in between the infomediary and the total atomization of privacy without the use of a trusted party by describing a Privacy-Enhancing Trusted Party without the need of knowing private data. The individual is in full control of his/her own data unless respect for other trading parties' rights requires special attention, such as traceability in case of fraud. Even in this situation the Trusted Party (TP) can reveal identity but not the contents of communication.

In order to provide secure trade, the solution has to ensure same-time release of payment and delivery for both parties. For remote sales this requires at least one trusted party.

This invention is a solution implementing a platform of non-identified secure communication and trade. The platform is open for integration with existing Websites, communication and real-world transactions. It establishes the necessary basis for Individuals to interact non-identified both online and offline, transferring detailed personal information over the full customer life-cycle. It creates a platform for intelligent agents analyzing and communicating with CLIENTs without the ability to identify the individual behind the data.

The full range of Customer Life Cycle from first customer contact over suggestive selling and interaction to order fulfillment, distribution and payment with post-service, warranty handling and dispute arbitration is supported both online and off-line.

Parts Overview

This invention is made up of multiple parts. First is a central distributed on-line service acting as a Trusted Party implementation. This online service is separated into in five principal layers:

1) A national standardization layer for translating national payment, telephone, distribution standards into universal or internal standards;

2) A physical layer working with services for identified communication channels and identities;

3) A Privacy Core communication layer taking care of the critical and sensitive and basic handling of virtual identities and translations between physical and virtual communication channels and entities;

4) Generic Trade and communication services building on the virtual part; and

5) An advanced service layer using generic services to create advanced targeted solutions like total eCRM outsourcing, etc.

Second is a CLIENT part called an Authenticator, which is a client-side device handling services such as Universal Sign-On, CLIENT anonymization and Identity switching. The Authenticator services depend on the physical device in question. The two primary implementations are a Desktop Computer Add-on Software and a mobile wireless device such as a mobile phone or a PDA. An important task of the Authenticator is to isolate the Authentication identification information from COMPANY. For instance, if the device contains a biometrics reader, then this device is completely isolated and only accessible for authentication towards TP.

Thirdly, a COMPANY Side part to be installed at COMPANY devices provides interface services for COMPANY-CLIENT Relationship Management, trade and agent/communities.

In addition the national channel solutions will require additional parts.

What Happens if Anonymity is Violated.

For all practical concerns total privacy in not achievable. Even if the perfect security protected system could be achieved, the weakest link is the CLIENT himself. A slip of the tongue or lack of attentiveness when filling out a form will result in loss of anonymity, and privacy is by definition violated. If a supplier of physical goods really wants to trace the CLIENT in the practical world, one cannot prevent implementing traceable objects in electronic goods or in all circumstances to avoid breaking the security around the required fraud-protecting traceability.

Security cannot be better than the encryption tools employed and procedures around this. Since theoretically perfect privacy is not practicable or possible, the second best is close-to-total privacy combined with procedures in case privacy is violated. This includes

a) containing the privacy violation by enforcing a principle of non-linkability across relations;

b) creating the ability of the CLIENT to go into hiding after violation and to reappear non-linkably; and

c) minimizing damage from a violation with a catastrophe scenario breaking the central internal security.

Even though the CLIENT identity is violated and someone has been able to obtain private and identifiable information about CLIENT, it will be of limited use. The individual will change virtual identity and will not later be traceable to the identified VID. Company will know personal details but cannot interact in a practical context if email, telephone, etc. are shielded. For all practical purposes a CLIENT is able to change identity with a minimum of effort even though valuable relations can be lost.

When CLIENT buying power is accumulated in (perhaps multiple) TPs, the force for deletion of data for violated identities can be strong, because COMPANY, if refusing or being unwilling to allow control can be put on a blacklist, shutting off other non-identified customers without COMPANY having ways to prevent this. This blacklist can be interchanged between TPs, thus accumulating individual power to match even multinational corporations with poor ethics.

This blacklist is further enhanced if a marking arrangement is in place either under the TP Brand or as a collaboration with others with a revocable online indicator at COMPANY websites, shops etc. because (a critical mass of) individuals only deal with suppliers able to prove compliance to privacy standards.

Simultaneously the Individual is not restricted from operating since he will be able to re-emerge under a new Virtual Identity that cannot be traced to the identified individual.

When ensuring that each COMPANY has unique non-linkable CLIENT IDs, a violation can be contained to a minimum and only the violated identities eliminated. The rest of CLIENT relationships can be preserved.

However in the digital world personal data gathered must be assumed to be stored indefinitely. Once acquired, data can be copied and stored remotely before a violation is even discovered. No individual can be assured that total privacy is achievable.

The Trusted party itself is the most dangerous part in a catastrophe scenario:

a) If the central internal security is broken so that someone can impersonate the TP, all present and future Identities are violated.

b) If the TP turns malicious and systematically abuses trust.

c) A “Big Brother” attempt from a government with skill, brute force computing power, and access to necessary resources.

However, to minimize these risks central principles and procedures are included and will continuously be updated:

a) Internal security is built on the guidelines from the open source experts providing multilevel key generation based on short term often rolled signatures, separation of responsibilities, and access to keys and backups, organizational split according to the same guidelines as external security, and of course technical protection using firewalls etc.

b) The invention is designed to minimize TP knowledge of content in communication and data since CLIENT can encrypt using any method desired. Control of the central Identity-VID combination is isolated and separately monitored. On top of this external inspection mechanisms will be set-up.

c) The government “Big Brother” attempt is serious. Measured against this are the use of the national external controlling system access (for instance time-limited key certificates requiring cross-national issuing of certificates), and storing of the central Identity-VID combinations combined with a disaster procedure for primitive deletion.

The basic fact is that loss of Trust will damage business, and therefore it is in the interest of TP to work for whatever is necessary to maintain trust. This is combined with openness in procedures.

Note that an Infomediary selling individual customer profiles has an interest in knowing contents and two-sided interests towards the Privacy questions.

Better Relations and Solutions for All

Even though some COMPANIES will shortsightedly object to such a transfer of control to the Individual, this invention will increase benefits for all parties.

Because of the shift to anonymous relations, COMPANIES will be able to get more accurate and detailed data from CLIENTs, making true One to One customization easier. This will increase the value that COMPANY can supply to CLIENT and thus increase potential profits.

With the built-in loyalty service, COMPANY can now get access to link previous discrete transactions into a full anonymous customer profile and use this for suggestive selling, customer loyalty programs, and improved business intelligence.

A COMPANY may only have anonymous data in industries formerly restricted by law to analyze private customer data such as finance, retail etc. (depending on nationality).

Cryptography

Encryption is central to privacy. This invention works on top of standard cryptography making use of well-established techniques. The basic principle of all cryptography security is NOT to keep methods secret, but only to rely on the secrecy of keys. This invention makes use of tested vendors and open source tools for cryptography.

No perfect encryption mechanism exists, so the encryption part will have to be continuously updated as methods are developed and computing power increases.

The following are short definitions of the techniques used:

Symmetric Encryption

Symmetric encryption is when two parties share a common key used for both encryption and decryption. Fast and generally accepted secure methods are available for symmetric encryption for key size large enough.

This invention makes heavy use of symmetric encryption and therefore the below functions are described.

Decs (Cleartext, symmetric key) and Encs (Cleartext, symmetric key) respectively are the symmetric decryption and encryption algorithms using the Symmetric Key to encrypt or decrypt Cleartext.

Decs(Encs (Cleartext, Symmetric Encryption Key), Symmetric Encryption Key)==Cleartext

Hash Functions

For multiple purposes One-Way hash functions are used to generate a summary of a data block. Hash-functions are designed so that it is computationally infeasible to generate a message that produces a specific hash value. In parallel to this, Hash-functions are also designed so that it is computationally infeasible to find two input that generate the same hash-value [NIST FIPS 180-1].

Hash functions are referred to as H (ClearText)

Asymmetric Encryption

Asymmetric encryption covers processes where a key pair is used. What is encrypted with one key must be decrypted with the other key. This is advantageous because one part of the key can be kept private and only accessible to the owner. The other part of the key—the public key—is published in for instance X.500 or X.509 tables together with identifiable or pseudonymous information. These set-ups are implemented under national law all over the world

Reversible Asymmetric Encryption

This invention makes heavy use of reversible asymmetric encryption and therefore the below functions are defined

Dec (Cleartext, key) and Enc (Cleartext, symmetric key) respectively are the reversible asymmetric decryption and encryption algorithms using keys to encrypt or decrypt Cleartext.

Keys will be referred to as <party identifier>.<key type identifier>, where party identifier can be Cl for CLIENT identified, Cl.Vir for Virtual Client Id, Co for COMPANY, TP for Trusted Party and Sh for shipper. Key type identifier is Pr for Private key and Pu for Public key. Cl.Vir.Pr is thus the Private key of a key pair related to a CLIENT VID.

Cleartext==Dec(Enc(Cleartext,Private Key)),Public Key)==Dec(Enc(Cleartext, Public Key), Private Key),

but

Cleartext # Dec(Enc(Cleartext, Private Key), Private Key) and

Cleartext # Dec(Enc(Cleartext, Public Key), Public Key)

Since asymmetric encryption has more constraints to it, the asymmetric encryption method has to use longer keys to give the same brute force attack security as compared to a symmetric method.

Since asymmetric encryption is performance slow it is often used and accepted to generate a symmetric encryption key and use this for symmetric encryption while only the symmetric key is encrypted and enclosed by the asymmetric key.

Non-Reversible Asymmetric Signature-Only

In order to sign a document or agreement a non-reversible asymmetric encryption is used. The special part about these methods are that any part is able to use the public key to verify a signature made by the private key without knowing the private key.

To produce a digital signature, the corresponding one-way Hash value is encrypted by the Private key. When verifying a signature the recalculated hash value of the assumed document is compared to the decrypted signature using the public key. If they do not match, then this document was not signed by the private key resulting in the signature forwarded. One special advantage of this procedure is that the integrity of the document is verified simultaneously. If the document has been changed then its hash value will also change and the signature no longer holds.

Sign (X, Private Key)==Enc (H(X), Private Key)

Proof of signature

Dec (Sign(ClearText, Private Key), Public Key)=H(ClearText)

A digital signature is an attachment to a document and can as such be removed from the document. A digital signature without the original document is not usable.

Establishing New Keys

To avoid violation of the Master key it is a normal practice to use set-ups where the Master Key is used to sign the public key of a new set of keys. The new set of keys is then used as a temporary signature or encryption keys traceable to the master key. The main advantage is that the temporary keys can be revoked or periodically rolled without having to replace the Master Key. This can be in multiple layers depending on the importance. Large commercial systems work with hourly replaced server keys in with a multi-layer structure with increasing intervals between key replacement.

This principle is generally used for CLIENT keys also because the temporary keys can be anonymised but still be provably traceable to an individual. All keys throughout this invention are thus to be considered as temporary keys signed by the corresponding master key.

Zero-Knowledge Authentication

Central to this invention is use of Zero-knowledge authentication without exchanging identifiable or linkable information. The most used basic principle is to demonstrate the ability to present the correct response to challenged information.

B to prove to A that he is B in a PKI-scenario.

A sends to B: Enc((A's Random chosen number), B.Pu).

B gets Random Chosen number: Dec(Enc((A's Random chosen number), B.Pu), B.Pr)

B responds to A: Enc(A's Random Chosen Number, A.Pu)

B has now proven to A that he is B because he has access to B.Pr (B's secret key) without exchanging any identifiable information.

This can also be done unencrypted, but that requires a prior agreed one-time only key-pair.

A to challenge B with a one-time only challenge number.

B looks up the related one-time only response and replies with this number.

B has now proven to A that he is B without exchanging any identifiable information.

A has now established authentication of B.

Both the encrypted and non-encrypted version can be repeated to establish a two-way zero-knowledge authentication.

Zero-Knowledge Generation of One-Time Only Keys or Key-Pairs.

A very simple but useful technique is to generate prior agreed keys or key-pairs (challenge plus related response). When a number or a pair has been used it cannot be used again. An attempt to reuse a number is an indication of attempted fraud by third-party.

A list of numbers or number-pairs can be generated at both sides using a shared algorithm and seed values combined with a shared secret value. This can be built-in in SmartCards etc. so they are portable and non-accessible before use, and so that new numbers can be created anonymously and with zero-knowledge communication with the TP.

Zero-Knowledge Generation of Symmetric Encryption Key

Several zero-knowledge protocols exist to generate keys across a non-secure line. The most generally used is Diffie-Hellman which is based on Discrete Log. The general principle is that two parties share separate parts of information based on randomly chosen numbers and some openly shared numbers. Based on their own secret and randomly generated number and the information from the other part both are able to calculate the key, but it is very difficult to calculate the key based only on the information exchanged.

An embodiment of this invention uses a combination of asymmetric encryption and Diffie-Hollman to ensure that the TP cannot listen in on communications between CLIENT and COMPANY. This works only if one part is identified.

Two-way unidentified security without a trusted party is theoretically very difficult if not impossible to established due to the man-in-the-middle attack. Anonymous auction services as the ones implemented are, because of this, very dependant on Trusted Parties.

Limited Show Keys

Limited show keys are a special type of certificates that if used more times than built-in, then a third-party, typically the Certificate authority, can prove abuse.

In the obvious case of virtual cash, an attempt to use digital anonymous cash more than once is attempted fraud. If the certificates contain a signed confession and the account number from which the money was drawn, fraud is proven and the guilty identified in the same operation [S. A. Brands 1999 PHD thesis later published as “Re-thinking Public Structures and Digital Certificates”, MIT Press, 2000, ISBN 0-262-02491-8].

Attribute Certificates

Attribute Certificates are a special type of anonymous certificates where the holder is able to demonstrate to third-party with zero-knowledge communication that he holds or does not hold a certain credential.

Attribute Certificates can be positive in terms of an academic degree verified by the educational institution, or negatively in terms of proving no major criminal offenses have been committed, as verified by the relevant public authorities.

This can be done anonymously and without the certificate authorizer being informed about the information to be stored in the certificate [S. A. Brands 1999 PHD thesis later published as “Re-thinking Public Structures and Digital Certificates”, MIT Press, 2000, ISBN 0-262-02491-8].

Virtual Identity

Separating Personal Information from Identity

In order to establish privacy and at the same time enable customization of products and services, private data concerning an individual is separated from the Identity of the Individual. This is done using Virtual Identities (termed VIDs).

A Virtual Identity is a pseudonym for an individual created for a specific purpose. Using the Trusted Party (TP), an individual can assume use a VID to communicate, trade etc. anonymously and under full control of the process. A VID covers the range of communication channels and services if appropriate to the type of VID. A key element is that a VID can be eliminated without a trace except in the case of fraud or other criminal activity.

When assuming a virtual and anonymous identity individuals can share even detailed private information without fear of the same information being abused outside of their control.

The core part is thus the principle that any player will either interact with an Identified individual who will only share limited information or interact with a virtual, but anonymous identity about which detailed information is much more easily obtainable since risks are greatly reduced.

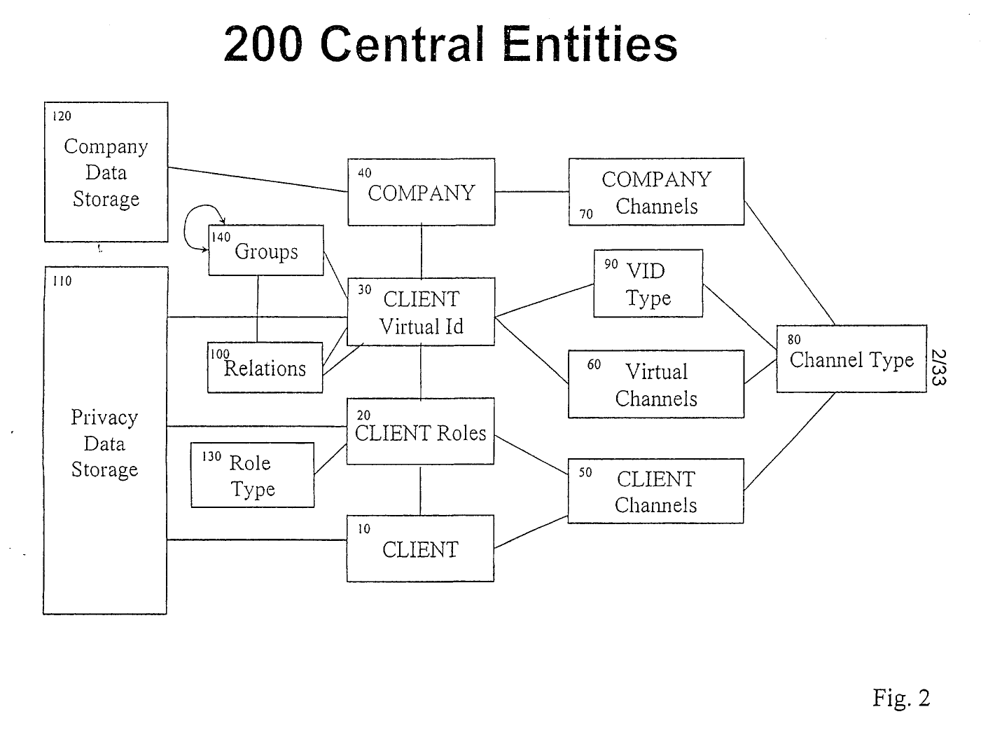

The basic structure behind Virtual Identities is exemplified in FIG. 2.

TP Identification

TP—Trusted Party—is generally treated as one entity identified by a TP Token Identifier or the public key of TP (TP.Pu) that can be verified in official registers such as X500 or X509.

However the physical implementation TP is assumed to be multiple, both virtually and geographically, and perhaps organisationally distributed servers. All implementations of CLIENT, COMPANY or other entities include identification of the TP handling the entity.

Also multiple distributed TPs are internally linked virtually, geographically and organisationally in order to appear as one entity externally.

Role Based.

The basic structure of virtual identities takes into consideration that a person may have multiple roles to handle. Each role can have a number of virtual identities and each role will have a specific set of primary communication channels.

CLIENT roles are separated into private roles such as a family member, friend, sports club leader; and business roles such as board member, employee, corporate purchaser, etc. The main reason for using roles is to establish a structure, overview and services for the Individual.

Privacy issues are different for private and business roles, since a business role is representing something else, whereas a private role is representing the individual. For individuals, privacy is a fundamental right that may be threatened, whereas to the business role anonymity is primarily useful because it changes the power structure, enables confidentiality of source, eliminates biases etc.

VIDs

To each role belong a number of Virtual Identities. In principle, one VID is created for each contact. Three basic forms of VIDs are implemented.

Firstly the key VIDs are based on links into other structures such as a COMPANY customer database with added security and services. They are identified by a COMPANY Token Id and a COMPANY-only unique identifier. This identifier will avoid linkage because it is only unique in regard to the specific COMPANY. Authentication is strong between COMPANY and TP. COMPANY has adopted Privacy Trade functions such as Privacy Payments and Privacy Delivery.

Secondly CLIENT can setup all his existing logins as migration VIDs (e.g. user-id, password and e-mail address for a web-site). These are identified. Authentication is weak as user-ids and passwords are easily violated by a third-party.

New anonymous VIDs are used to create new registrations in existing setups. They resemble the migration VIDs except that they are anonymous and only based on virtual channels intermediated by TP. Authentication is still weak as COMPANY ability to authenticate is the bottleneck. These VIDs can be continued as the primary VID form in case no linkable interaction has taken place. COMPANY can have adopted Privacy Trade in key areas.

Privacy is violated if a non-identified VID is mixed with an identified VID. This includes situations where the Individual personally reveals identifiable information while using a non-identified VID.

Identified VIDs are often used in combinations where some identity information is known and other information is not. This could for instance be an instance where a customer's name and address are known, but communication channels are intermediated for update efficiency and in order to minimize linkability. This type of semi-identified VID is particularly useful for personal relations (friends), special online communities, or suppliers where identity is to be known. This kind of supplier can be utilities who by definition have, need to have, or are desired by CLIENTs to have, access to identifiable information such as postal services, fixed-line telephone, power, house repair, doctors, hairdressers, dentists etc.

Level of identification. Firstname only or . . .

Communication Channels virtualization and access

Access to Private Data

Identity Types include

Login (existing login)

Login outside (Unique create by TP)

Login Business Service Integrated (only mail plus voice answering)

Semi-identified (for personal use)

Identified Integrated (fully enabled)

Mailings (only inbound, Specific Opt-in list)

Address Book only (For non-TP customers to be entered into a TP CLIENT Personal Address Book)

Suggestion House (No communication Channels, access to some private data)

One-time trade ID (for a one-time only Privacy Trade transaction)

Delivery Only (Outside delivery, no communication enabled)

Internal Identified (TP Customer Service—no access to private data)

Internal Anonymous (TP Customer Service—no access to identifiable data)

Identified Credit Card

Anonymous Credit Card

Mobile Phone

Web Surfing (frequently rolled, No communication channels)

In addition to this each combination of channels can have its own subtype.

The outcome is a multidimensional matrix where a VID can be anonymous, semi- or fully identified with no, selective or full access to private data. In addition communication channels open to a VID and message filtering are customizable to make VIDs a very flexible setup.

In one end highly privacy-concerned individuals can be very closed without private data being available. In the other end, a TP can be used for convenience intermediation alone without any privacy being established. More important the individual can selectively decide which relation belongs where in the matrix.

Relations

CLIENT can create a RELATION (FIG. 2 reference numeral 100) with other CLIENTs (See FIG. 2) for multiple purposes.

RELATIONS such as RELATION 100 (FIG. 2) are a push solution in the sense that a CLIENT give access to his/her data to another target CLIENT and at the same time can request the target CLIENT to accept a two-way relation. Target CLIENT accepts by choosing a VID to use for the RELATION.

In case the target CLIENT is previously unknown to TP, the target CLIENT is able to do initial registration with a detailed registration to follow to accept a two-way RELATION.

CLIENTs control how much information is revealed to relations using the VID they link from and to. This includes access to private data, communication channels set-up in the sense of both intermediation and access in general, filtering etc. A CLINT can have RELATIONs linked to different VIDs.

CLIENT can attach multiple symmetric encryption keys to a RELATION for communication encryption. Keys are encrypted using encryption keys not known to TP. Since RELATIONs are identified they can use their digital signatures to establish whatever kind of key exchange and encryption method they want. For CLIENT relationships not encrypting themselves, communication encryption TP handles encryption towards a third-party as close to CLIENT as possible in the specific channel as part of the normal TP service.

RELATIONs are typically used for linking personal relations like family, friends and business associates which are the basic of the Personal Address Book service. A special RELATION is a GUARDIAN which is a parent or other person who is a guardian of children. A GUARDIAN RELATION manages, controls, approves and has access to multiple parts of children CLIENT registrations.

Groups

Except for the natural grouping from the role structure and VIDs, a CLIENT can create flexible GROUPS. Groups can be nested. (FIG. 2 reference numeral 140).

Groups are multipurpose controlled by CLIENT. They can be used as simple structuring tools, as communication distribution lists or as bases for other services like Personal Event Management, Project Team Management etc.

Identifiers

Central to Privacy is non-linkability and anonymization. The Identifier for a VID or channel can in itself be the source of linkability when used across companies. Identifiers are therefore non-information carrying. The standard identifier is a combination of <COMPANY-identifier>, <COMPANY-unique identifier for CLIENT> since this will by definition not be linkable across COMPANIES.

An email-address in the form <COMPANY id>.<CLIENT id> is traceable. In case a COMPANY sells contact information to information resellers etc., the contact information can be traced to the COMPANY it relates to without information about CLIENT.

Rollover

Rollover is the action that occurs when an outstanding VID is replaced by a new VID in order to minimize risk of violation. The larger the risk of violation of identity, the more often will the VID be rolled over.

A Rollover will for external parties look as a total new identity without any way to link the new identity with the old identity.

VIDs used for linkable activities like Internet surfing, old-fashion credit card authentication, cable set top box or mobile phone anonymization etc. will be rolled according to use in order to minimize the risk of linkage based on the Token Identifier itself (linking a COMPANY A customer to a COMPANY B customer because they use the same credit card number).

In addition to this it gives a strong incentive for COMPANY to establish an agreement since CLIENT will not be reachable when the VID is rolled.

Initial Identification

This invention includes implementing a Trusted Party for CLIENT to construct virtual Identities. Since a TP is also a trusted party for anyone interacting with a VID, they must trust that the TP knows the CLIENT's real identity in case of fraud.

The risk of identity fraud—identity theft where someone is trying to impersonate another or create a totally false identity, and then build VIDs on top of a false identity—is serious.

Protection is required first for the COMPANY the fraud is directed at, and second the individual whose identity is abused for fraud purposes. The trust image of the TP also needs to be maintained.

The individual is far more damaged by the fraud than the COMPANY since the COMPANY mostly risks losing a smaller amount of money, whereas the individual, being the innocent victim of identity fraud, can spend years trying to solve the problem, perhaps being denied access to credit, jobs etc.

It is not practically possible as of today for anyone to guarantee 100% identification, as identity fraud is very well established, and any system will have flaws.

This invention generally works on the basic assumption that initial identification is taken place at least with the level required for creating officially accepted digital signatures or other central papers in the home country of the individual or the country in which the individual does trade or communication.

Initial identification is important to be able to establish authentication in daily operation. Several identification methods will be used in parallel in order to make Identity fraud as close to impossible as practically achievable. The more methods of identification, channel verification, RELATION verification, existing identified interactions etc. being used the more difficult it will be for an individual to commit fraud, and the higher the chance that the real individual will be informed in case of attempted identity theft.

One important aspect of identification is to ensure that in case of fraud a verified picture is obtainable because pictures are usable for investigations of electronic fraud.

Four levels of CLIENT identification are used. Non-CLIENT is used for CLIENT own registrations of relations in Address Book not confirmed by the individual in question. Not-identified is for registered CLIENT not satisfying sufficient criteria to be considered as Identified. When classified as Identified absolute identification with traceability is established. In addition to this a special One-time-Only is used for Community and portal services where a TP is acting as a temporary trusted party for a non-CLIENT customer trade.

Functionality for a Non-identified CLIENT will be limited—signing an agreement is not possible with an unidentified CLIENT.

Requirements for a Non-identified CLIENT to be classified as Identified are a matter of Policy. 100% identification is only done when biometrics are surely introduced and only then if biometrics are securely linked to identity.

A combination of a bank transfer from a named bank account, a copy of a public identification paper such as a passport, a biometric, several communication channels (including a telephone and a delivery address) cross-verified and a number of RELATIONS are together an identification that requires considerable skill to defraud.

Some of the methods used are listed in the following.

Identification Certificates

This can be in the form of an X509 or X.500 Identification certificate but for practical matters this calls for a strong identification procedure at least to the level of the strongest requirements in the countries and the participants covered by the service. It is possible to buy weakly checked Identification Certificates.

However when a Certification Authority formally certifies identity, then identification is generally considered strong.

Biometrics

Biometrics, working with recognition of unique or close to unique bodily characteristics such as fingerprints, iris patterns, DNA etc., are expected to grow in importance. Fingerprints have been used for many years. DNA analysis is growing in importance as evidence in courtrooms and for paternity cases.

Biometrics are excellent for authentication and especially for the mobile Authenticator. Iris pattern readers and fingerprint readers are already available for ordinary desktop computers such as windows. Fingerprint readers are being built into Smart Cards etc. A central task for the TP CLIENT services is to make use of biometrics while at the same time to isolate the biometrics reading devices from COMPANY.

The final way in which biometrics are very useful for initial identification is in the investigation of identity fraud. If a case of identity fraud is discovered, only biometrics are both very likely to free the victim (the real individual) and to provide the criminal investigators with material to recognize the offender.

Identification Papers with Picture

Official identity documentation with pictures has a double purpose. Firstly it provides a fairly strong level of identification, and secondly it requires updated pictures in order not to be discovered as false.

A copy of an official document with personal interaction is therefore fairly strong identification.

Bank Account Transfers

Banks in most countries have strong procedures for identifying customers, primarily because they are trusted to take care of customers' money and not to let anybody else access customer accounts. Also, the banks take credit risks that need to be traceable to the individual, and must comply with public requirements as to tax reporting etc.

A bank transfer from a Customer Account contains detailed information as to the identity of the account owner. Since the account owner has been through a strong authentication to establish the account and again to transfer money, a match between registering information and information from the bank account is close to a strong authentication.

In addition to this most banks today are video surveyed and produce identification Id's with pictures. The likelihood of pictures obtainable in case of fraud is strong.

Existing Logins

CLIENT online access to utility companies, insurance, banking etc. all require some sort of identification and later authentication to be put in operation.

If CLIENT establishes and demonstrates access to such logins, then these levels of identification have been done.

External Channel Verification

All communication channels registered have to be cross-verified. This implies that the CLIENT show that he/she has access to the channel. A simple way to do this is the one-time only key-pair with challenge and response challenge or just a keyword or number to pass when channel authentication is done.

Theft of mobile phones has led to strong identification procedures around establishing and use of mobile phones. Existence of an unpre-paid mobile phone is normally an indication that a certain level of identification has taken place.

In addition to CLIENT cross-verification this can be done using publicly accessible records such as online phone catalogues, address registers etc.

If documentation for long-term relations can be established, the likelihood of Identity fraud is small.

Relations Confirmation

The more relations confirming a CLIENT and an interaction, the less the chance of someone succeeding in identity theft.

Establish Relation CLIENT

The process of establishing a relation with CLIENT is central. The key problem is that the TP will eventually start authentication on behalf of CLIENT. The registration process involves a basic minimum registration combined with a series of steps that take place over time as the relationship and trust are building.

According to TP internal policies certain requirements have to be meet in order for CLIENT to get the status of IDENTIFIED and thereby a TP accepting to confirm knowledge of CLIENT identity in case of fraud.

The basic relationship set-up involves the following steps:

Transferring of basic identification information and communication channels such as name, email, address, telephone, mobile telephone etc.; and

Establishing a basic authentication scheme in accordance with CLIENT abilities.

This authentication scheme is used to cross authenticate Communication Channels thereby linking them to CLIENT. Depending on national conditions this can be improved by using electronic means for confirming information integrity in, for instance, phone books, etc.

Creation of a set of new TP and CLIENT specific Digital Signature keys. Existing Digital Signature keys are used for signing these keys if existing. Let CLIENT authorise.

Establish a CLIENTKey which is a general symmetric encryption key between TP and CLIENT.

Payments from a known bank account to establish an internal account and for identification purposes.

Tools for setting up the basic CLIENT-ROLE-VID structure which includes linking physical communication channels to the basic ROLEs and VIDs and creation of a starting Access Control Filter and basic routing controls.

Tools for facilitating the personal Address Book services which include the linking of RELATIONS to the CLIENT-ROLE-VID structure.

Providing CLIENT with a CLIENT side part to ensure anonymization of browser etc.

Providing CLIENT with a digital AUTHENTICATOR to enter into more complex processes with COMPANY.

Providing CLIENT with an anonymized credit card with partner agreements on the credit card verifier side to ensure strong real-time authentication for payments.

Setting up the Delivery Channel and a default delivery path in partnership with national or international shippers.

Setting up the Electronic Bill Presentment service and starting to move recurring payments.

Establish Relation COMPANY

The basic process of establishing a connection to a COMPANY is separated into a basis creation of an internal reference with very basic information and a series of steps to develop the relation.

The basic creation of a TP internal reference will most likely be done by a CLIENT creating a VID mirroring an existing login in order for a TP to establish connection.

It is central to note the this basic creating of a COMPANY combined with an anonymized (and real-time cross-authenticated) credit card payment procedure in partnership with credit card verifiers and virtual delivery addresses in partnership with shippers can be established outside COMPANY without changing anything in COMPANY infrastructure. Secure anonymized ecommerce can be thus established with existing infrastructure without the consent of COMPANY.

Creating a Relation involves the following logical steps:

Identification—The company has to be legally Identified. A digital Signature key (Public key Co.Pu) exchange is considered as a natural way to do this. If COMPANY does not have a digital Signature then alternative identification will involve the creation of a Digital Signature.

In addition to securing identification and a set of digital signature keys then TP will establish a symmetric encryption key between TP and COMPANY for message encryption—CompanyKey.

Communication Channels verification—Related to the identified COMPANY is the different communication channels such as Physical Address, Telephone, Fax, Email, Internet-address, bank-account etc. These channels are cross-authenticated to establish an initial link to COMPANY. The structure of Communication channels will evolve as purpose and COMPANY Customer responsibilities are built into the structure facilitating the interaction between COMPANY and CLIENT.

One important Communication Channel is the payment channel. Default TP will set up an internal account for COMPANY which COMPANY can address and transfer money to where-ever. Payment to this account shall be considered legal payment for CLIENT. However in principle a Privacy Payment is always implementable as two separate payment instructions.

If COMPANY is supplying physical goods then the Delivery Channel also is central. From the outset this can be done through the virtual address, but in order for the interaction with CLIENT to operate the best COMPANY will need to integrate the Delivery procedure into COMPANY logistics in order to provide CLIENT with relevant information in the delivery process. Before this integration the virtual process-specific delivery address can be constructed by the TP in the trade process.

The process of integration involves a COMPANY side service to facilitate communication services and integration of the Privacy Trade Platform services into CRM and ERP systems.

The Communication Channel set-up will be augmented with an eCRM service modelling the internal COMPANY service functions such as Support, Sales, Delivery, Finance etc. Integration of the Privacy Trade Platform is done through an open interface that COMPANY can address, defining the set of services and a Business Component infrastructure to exchange messages according to open standards.

Corporate Customer Registration

The eCRM services involves an integration with COMPANY Customer Relationship Management Systems through an Open Interface.

A part of this is the online access control where a Privacy Server supplies authentication of Virtual Identities at a customer's Website. The Privacy Server is integrated to maintain part of the Corporate Customer Database

For inbound and outbound communication and trade the Privacy Server can interact with COMPANY internal communication and trade systems to support the ongoing relationship between CLIENT and COMPANY. This includes authentication, establishment of outbound communication paths based on generic information only (CLIENT internal ID, channel type depending on the type of communication, and optionally additional information to improve CLIENT inbound access control procedure.)

Establish VID (CLIENT/COMPANY)

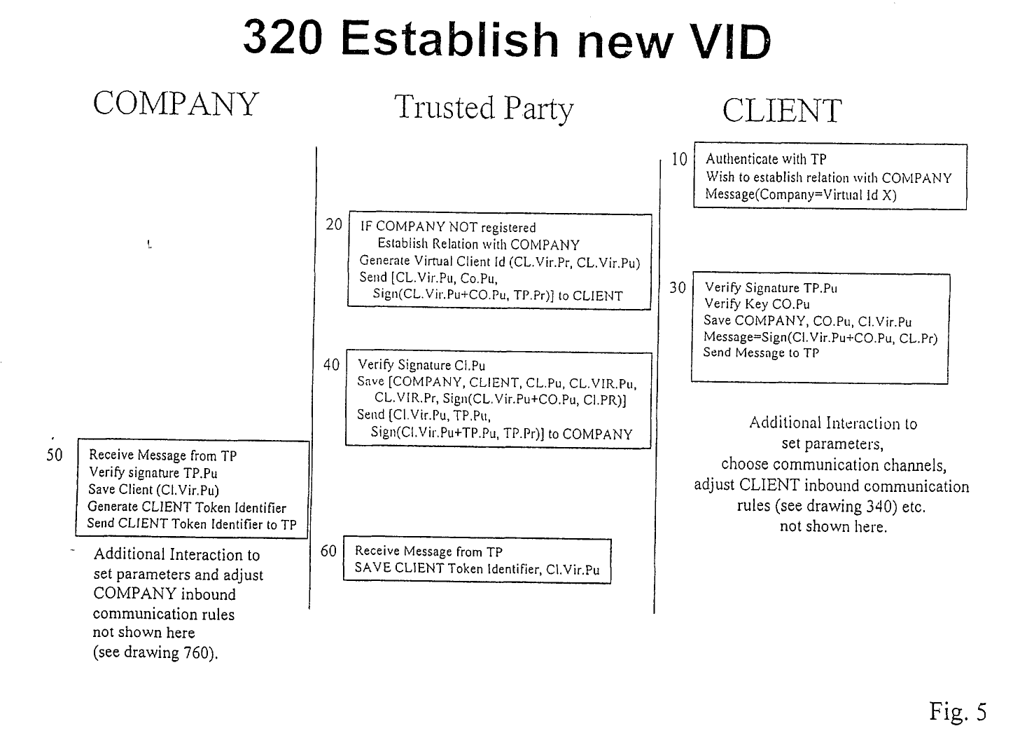

The purpose of this procedure is to establish a new VID (Virtual Identity) for a CLIENT towards a specific COMPANY without transferring linkable or identifiable information zero-knowledge communication except for the encrypted published Public Key of the new VID (See FIG. 5).

COMPANY and CLIENT are in the following assumed known to TP. If COMPANY is not known, then this procedure will be augmented by a TP customer care support process helping CLIENT to identify and model the COMPANY customer registration and authentication procedures and to provide the needed information for registration.

TP is able to prove that VID belongs to CLIENT in case of fraud.

CLIENT establishes an anonymous identity towards a relation under full CLIENT control. Contents of communication can be private from TP because a symmetric encryption key SYMKEY has been exchanged with COMPANY without revealing this to TP.

COMPANY establishes a new customer relationship with CLIENT together with trade and communication support according to the wishes of the customer, a Customer specific encryption key SYMKEY and a signature from TP confirming knowledge of customer identity in case of fraud.

COMPANY does not receive any identifiable or linkable information.

CLIENT indicates COMPANY (or other party) with which he/she wishes to establish a VID.

TP creates a VID and links this to COMPANY.

TP creates key pair (Cl.Vir.Pu, Cl.Vir.Pr). The Public Key is forwarded to and signed by CLIENT and the signature is returned to TP.

Secret key of VID (Cl.Vir.Pr) is known only to TP, as TP is backing the authenticity of VID to CLIENT.

TP then authenticates VID Public key to COMPANY towards the COMPANY created Customer Token ID which will typically be a customer number from the internal COMPANY Customer Relationship Management System. COMPANY is informed of the virtual communication channels open to this VID.

TP verifies COMPANY Public key towards CLIENT.

This invention works with a secret shared symmetric key SYMKEY to encrypt communication between CLIENT and COMPANY. In the following the SYMKEY is treated as if it is reused from session to session; however the SYMKEY can just as well be generated as part of establishing a session as a session specific encryption key which is saved together with communication encrypted by the public key of CLIENT (Cl.Pu).

SYMKEY can be created without revealing this to TP.

One embodiment is the straight forward situation where CLIENT creates SYMKEY and encrypts this together with a random challenge text using the Public Key of COMPANY (Co.Pu) and forwards this to COMPANY. Since TP cannot read this message, TP can not know the SYMKEY. COMPANY verifies by returning the Challenge Text encrypted with SYMKEY. Now CLIENT can verify that the key has been exchange without TP knowing.

Another embodiment with the desired outcome that does not include transferring the SYMKEY itself is by using a slightly modified Diffie-Hellman protocol making use of the fact that CLIENT can do a non-TP controlled verification of the Public Key of COMPANY.

CLIENT forwards the CLIENT part of the Diffie-Hellman asymmetrically encrypted by the Public Key of COMPANY ((Agreed Generator, Agreed Large Prime, Enc((Agreed Generator)A(CLIENT chosen random) MOD (Agreed large Prime))), Co.Pu)).

COMPANY finishes the modified Diffie-Helman protocol by generating the key SYMKEY and encrypting a message containing the CLIENT part with SYMKEY and returning this to CLIENT together with the unencrypted COMPANY part of the Diffie-Hellman protocol.

CLIENT can now calculate SYMKEY. If CLIENT is not able to reproduce the originally forwarded value ((Agreed Generator)A(CLIENT chosen random) MOD (Agreed large Prime)) when decrypting the message with SYMKEY, CLIENT has calculated, then the protocol has gone wrong, indicating a potential attempt to intercept the communication by TP.

See FIG. 5.

Establish Relation (CLIENT/COMPANY)

CLIENTs have private, semi-private and business relationships with other CLIENTs. These relationships are specifically supported over lifetime. Each CLIENT can approve another CLIENT as a personal relationship that TP is permitted/requested to maintain.

TP creates the link (FIG. 2) between two CLIENT VIDs to handle this. CLIENT communication channel intermediation is still in place because this is convenient due to channel changes (new phone number, moving etc.) and routing (Receiver controlled). Each relation will have a specification on the type (father, friend, etc) and group. Note that this is a one-way solution. CLIENT A can approve CLIENT B without CLIENT B approving CLIENT A. To create two-way links two separate relations need to be created.

CLIENT can create non-TP Customer RELATION VIDs without a link to the actual CLIENT B this VID is representing. On behalf of CLIENT can TP contact.

CLIENT can create Groups of Relations (FIG. 2 reference numeral 140). Groups can be nested.

CLIENT uses VIDs and Groups to define interaction options. This includes communication channels, access to private data, access control filtering and routing.

For instance, family RELATIONs can see most private data and lists. All communication channels are open, but re-routing is enabled so that channels are intermediated and VID is identified with full name etc. A business associate is limited to the intermediated business communication channels and business information, but without access to private data, address or communication channels.

CLINT determines how encryption is to be maintained. The VID can have a general SYMKEY for all RELATIONS linked to the specific VID. A RELATION can have a Relation-specific SYMKEY or communication can be based on session-keys created and saved in connection with communication.

Establishing SYMKEY works just as well with a CLIENT/CLIENT relationship as a COMPANY/CLIENT relationship where at least one CLIENT or one communication channel is identified. The main issue is to exchange information that TP is not able to access.

When two anonymous parties—such as two CLIENTs—want to establish an anonymous relationship the problem of TP as man-in-the-middle is un-resolvable. They can choose to exchange a SYMKEY in unencrypted form or better do a Diffe-Holmann to making it more difficult for TP to handle. But they cannot have any guarantee that TP is not listening in.

For each RELATION, CLIENT can maintain a special Note Space containing preferences (e.g., food and people, likes and dislikes, event history, birthday, etc.).

Private Data

Central to the invention is that TP has no built-in interest in accessing CLIENT PRIVATE DATA except to confirm the existence of signed documents and providing a minimum of traceability in case of fraud. TP under this invention has no interest in knowing contents of communication or trade.

In case TP services are provided on PRIVATE DATA, this can be done under full anonymous conditions equal to that of an outsider. However this can in nature give reason for distrust by CLIENT.

Private data are stored in a privacy storage attached to the CLIENT, a CLIENT role or a CLIENT identity default in encrypted format using either a CLIENT generated symmetric KEY or in the form of an anonymous Attribute Certificates [S. A. Brands 1999 PHD thesis later published as “Re-thinking Public Structures and Digital Certificates”, MIT Press, 2000, ISBN 0-262-02491-8]. Decryption keys are stored either on the CLIENT side or together with the data in encrypted form using the public part of the CLIENT Digital Signature.

The CLIENT is able to produce additional symmetric or asymmetric encryption keys for the data storage, or to change encryption, add, move or remove any attribute data according to CLIENT's privacy wishes.

For each combination of VID, COMPANY the CLIENT can attach specific attributes in a form that can be decrypted by TP in a secure mode on request by a COMPANY for customization purposes. Requesting other attributes will by definition require active acceptance by CLIENT. If CLIENT accepts, attributes can be stored together with the VID in question for documentation or a generally changed privacy profile.

Negative credentials can often be a question from a COMPANY. In order to show anonymously that one has not been to prison etc., attribute certificates are central.

When CLIENT approves someone to access private data, CLIENT creates a new Symmetric Key, selects the attributes to be stored encrypted with this new key and forwards the key to COMPANY or AGENT who is granted access. CLIENT informs (automatically) TP by linking the attribute to the relevant VID or Role that COMPANY can access attribute, and TP can control access without knowing contents.

Private data are stored in the most appropriate data format with or without an identifier for convenience. The default format is assumed to be XML. Attached to the private data is a Meta Data description of what the piece of data contains, together with link to data definitions.

If CLIENT allows the TP INVOICE AGENT to handle Invoices, then the invoice is stored separately and product codes are stored in the collaborative filtering server together with reference to a special Analysis VID. The INVOICE AGENT is the only agent that can access invoice data.

The INVOICE AGENT have no external communication and can only report findings back to the Invoice recommendations part of the CLIENT Suggestion House.

CLIENT can give other agents access to the Invoice Recommendations part, but not to the Invoice Data themselves.

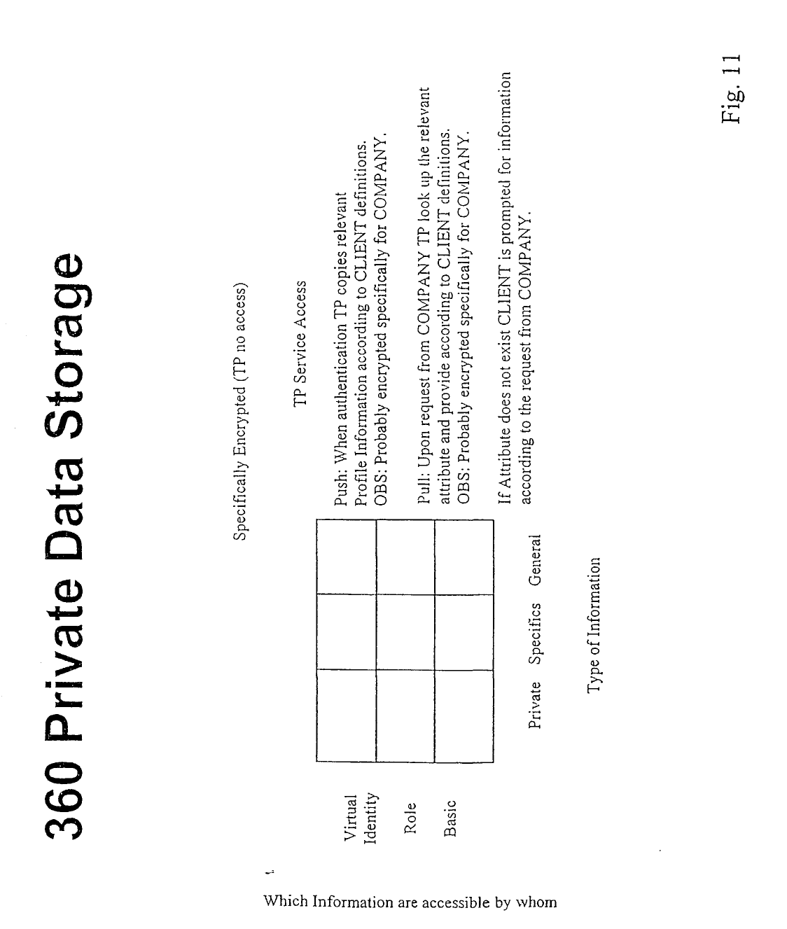

See FIG. 11 <Privacy Data Storage>.

Login

In the general solution CLIENT will authenticate towards TP and the TP will handle authentication towards a specific COMPANY. The base level of security is extended to a given COMPANY building a general security service only limited by COMPANY's ability to integrate. Given the security problems with simple login/password solutions, COMPANY has a heavy incentive to move to an integrated authentication solution.

Key to this is a central database (see FIG. 2). The CLIENT Virtual ID 30 plus related entities cover all COMPANIES where CLIENT has registered both offline and online. TP maintains a database of specific VIDs (both anonymous and identified) and information to authenticate the VID towards COMPANY. This includes necessary login information, passwords, digital signatures and SPECIFIC COMPANY communication rules.

In the general case the client-side part of TP will implement a Single Sign-on procedure so that CLIENT first authenticates towards TP and from there chooses actions (the sequence can vary depending on channel and situation) without any need to re-authenticate.

Choose a role (Work, Private etc) to indicate the context in which CLIENT wishes to act. Choose a VID/COMPANY to interact with. When CLIENT chooses (or switches to) a specific VID, TP issues an implicit auto-authentication with COMPANY.

Chose action. CLIENT can use the Identity Switcher and change VID to another VID/COMPANY. TP uses the original authentication and carries out an auto-authentication using the new VID.

A central specific embodiment of this is a portal solution, e.g., WAP-based, where the CLIENT menus are dynamically created based on CLIENT registered VIDs with automatic Sign-on/authentication of VID towards COMPANY.

The VID can be supplied with information about Profile and wishes from the private data storage controlled by CLIENT. This profile information can include an anonymous proof of credit worthiness, a credential such as a formal educational degree or an anonymous proof of absence of a negative credential such as a criminal record or outstanding debts. One embodiment includes an XML format collection of parameters, encrypted according to the structure of roles and VIDs and manageable by TP only on reference but not by access to contents.

Authentication

For secure transactions authentication has to be strong. Software-only sign-on is not 100% secure—even the strongest PC-based encryption solution is vulnerabe to a virus attached to a keyboard driver in combination with a remote control mechanism.

Basically two forms of authentication can be considered strong: Either simple single-use challenge-response solutions or tamper-safe SmartCards with an encryption authentication mechanism that can be either standard signature or a more complex zero-knowledge authentication procedure. See for instance S. A. Brands 1999 PHD thesis later published as “Re-thinking Public Structures and Digital Certificates”, MIT Press, 2000, ISBN 0-262-02491-8.

The central authentication for this invention makes use of different forms of authentication. The central tool is an Authenticator in the form of a portable wireless device such as a WAP mobile phone able to access a SmartCard/Simcard either installed or using a mobile reader. Using infrared or other local communication protocols such as Bluetooth to communicate with computers, in store located communication tools or the built-in access to the wireless network this device covers all general purpose authentication. The basic technology is known and almost a commodity product, such as for example the Ericsson mobile phone R320s.

The SmartCard is able to carry out simple encryption functions:

1) Asymmetrically encrypting small pieces of data for zero-knowledge authentication and authorization.

2) Symmetrically decrypting and encrypting messages to and from TP.

3) Receiving a random seed-factor to generate one-time-only challenge/response key-pairs based on a shared secret key and an agreed algorithm.

4) Maintaining a list of not-used key-pairs.

5) Providing a local authentication access mechanism using biometrics like a fingerprint reader, pincodes or other method.

The Smart Card does not contain the Identified Digital Signature of CLIENT (CLIENT Private Key). Prior to use CLIENT has used his digital signature to sign the Public Key of a key pair unique to the SmartCard towards TP. The signature has to be confirmed by TP to be traceable to CLIENT through a VID. This means that if the SmartCard is stolen or otherwise violated the SmartCard key can be revoked by TP with minimum damage.

The authentication procedure sequence towards TP is channel dependent, e.g. some channels will require cross authentication, while others do not need this. This will apply specifically in connection with the migration services where, for instance, standard Credit Card Payments are implemented in a strong authentication/verification solution.

The authentication procedure can be complex, including post-verification in a later session of a previous weak authentication (will locate problems and initiate a fraud investigation).

A more interesting complexity in the authentication procedure is the incorporation of general Procura-principle using principles known from workflow systems. This is directly relevant if CLIENT is a COMPANY or for COMPANY integration. But the same principle is also very useful in non-company situations. In some cases a parent has to co-authenticate child authentications—this can be done in real-time or prior by a set of rules. Thresholds can be set according to a price maximum over which a spouse or legal guardian has to co-authenticate. A weak channel can require co-authentication in another weak channel and thus be considered strong like a weak web authentication combined with a return phone call to a previously agreed telephone number to cross-authenticate by.

There are three basic ways technical authentication protocols are in place and used depending on CLIENT and COMPANY technical implementation:

Manually by CLIENT. From the outset this can mean CLIENT entering a one-time-only identity key hinting to his identity. TP responds by a challenge number related to a one-time-only key-pair and in return getting the related response. This procedure does not require any special electronics implemented at either CLIENT or COMPANY. It only requires CLIENT to have interacted with TP prior to the authentication procedure to receive the one-time-only keys in advance.

Directly using the mobile wireless interface to interact directly with TP. Messages can be signed and sessions/other channels can be cross-authenticated.

Indirectly using the mobile device off-line as a SmartCard reader with infrared, Bluetooth or other local communication protocols to access the electronic SmartCard authentication. As this is zero-knowledge this can be done through COMPANY communication channels without linkability.

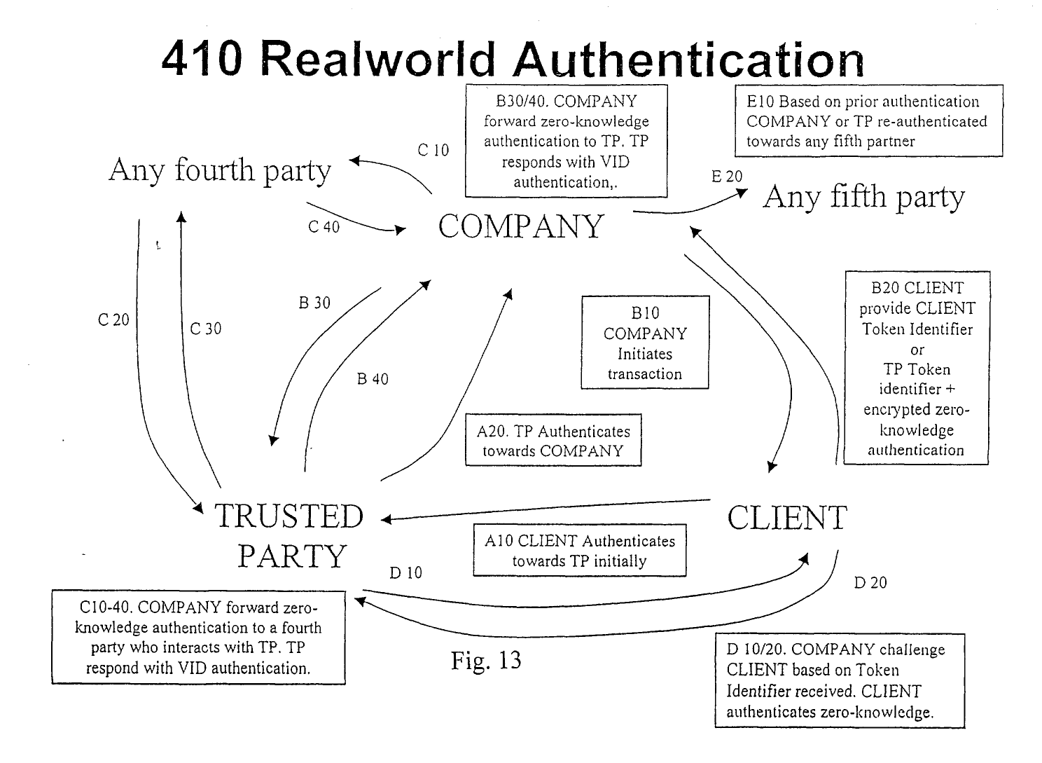

Different authentication procedures are implemented in parallel (see FIG. 13). Actions A10 and A20 are the standard authentication procedure where CLIENT first authenticates towards TP either online or through a mobile authenticator. TP then authenticates CLIENT towards COMPANY. An example of this is when CLIENT is accessing his list of existing VIDs and choosing one related to an online shop. The online shop this way gets an anonymous customer relationship linkable over multiple interactions valuable to build continuity into the service. Measurements, preferences, purchases etc. all can be taken into consideration dealing with CLIENT.

Actions B10 and B40 cover the situation where CLIENT has no direct link to TP. CLIENT authenticates zero-knowledge towards TP though a COMPANY link with TP and then TP authenticates the correct related VID towards COMPANY. An example of this is a physical grocery where CLIENT interacts with TP though a mobile device with an infrared communication link to in-store communication points. Alternatively the authentication procedure can work through an in-store located computer with a standard Internet browser. CLIENT gets a transaction code from COMPANY and enters this number in connection with the authentication procedure. TP can then forward the related VID identifier together with the transaction code through any communication channel such as encrypted email.

Actions C10 and C40 cover the situation where COMPANY itself has no direct contact to TP. A fourth party authenticates towards TP in the transaction verification process to get a transaction confirmation. Examples of this are credit card payments combined with a strong authentication procedure implemented through the card verifier.

Action E10 covers the case where an initial authentication is re-used to authenticate towards a new fifth partner. This can be done either by COMPANY or by TP intermediating the relationship between COMPANY and the fifth partner. Examples of this can be an online news-service requiring payment or a new introduction in this invention in the form of a TP intermediated purchase directly from a supplier using B2B trade standards.

Privacy Trade Platform

The Privacy Trade Platform is a generic collection of services on top of the Virtual Identity Platform that together makes long-term commercial customer relationships possible on an anonymous basis.

The range of service covers a full customer life cycle from communication to one-time-only purchases to signing of agreements, purchasing and delivering electronic and physical goods, returning goods and anonymous dispute arbitration.

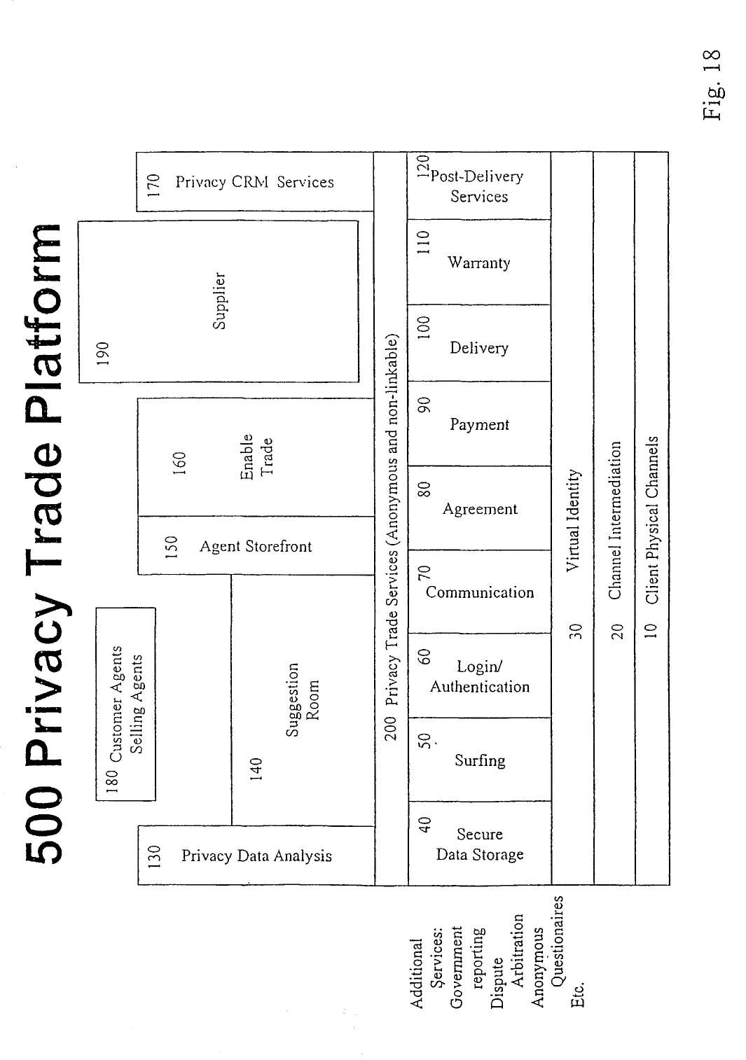

FIG. 18 shows the entire Privacy Trade Platform with interfaces to important services. Reference numerals 10 to 30 cover the Core Virtual Identity Services. Reference numerals 40 to 120 cover the full range of services necessary to trade online and real-world. Reference numeral 130 represents the services that enable CLIENTs to let third party customer agents and selling agents 180 to work with private data under CLIENT control. Reference numeral 140 is the special area where all selling suggestions are directed. Reference numerals 150 and 160 cover a fully hosted virtual shopping facility where agent suggestions are converted into transactions according to Open Trading standards such as Open Buying on the Internet (such as www.openbuy.org) with the necessary modifications to support privacy. A central note here is that agents are interfacing with one Virtual Identity, whereas suppliers see another in order to minimize linkage. Reference numeral 170 covers the privacy-enabled Customer Relationship Management Business Services to support the virtual relationship build-up between Supplier and CLIENT under full CLIENT control.

Traceability Route

The central part of all Trade is the ability to enter into legally binding commitments. Enabling legally binding commitments in an anonymous trade system is the key. The simplest solution would be based on a Power of Attorney to TP from CLIENT. TP can the sign using the Virtual Identity Signature (Cl.Vir.Pr) on behalf of CLIENT. This would however open up for TP fraud towards CLIENT and for TP to take risks of CLIENT accusing TP of fraud. These problems can be handled by agreement. However the central problem of TP needing to know contents of the legally binding commitments is in line with a privacy priority.

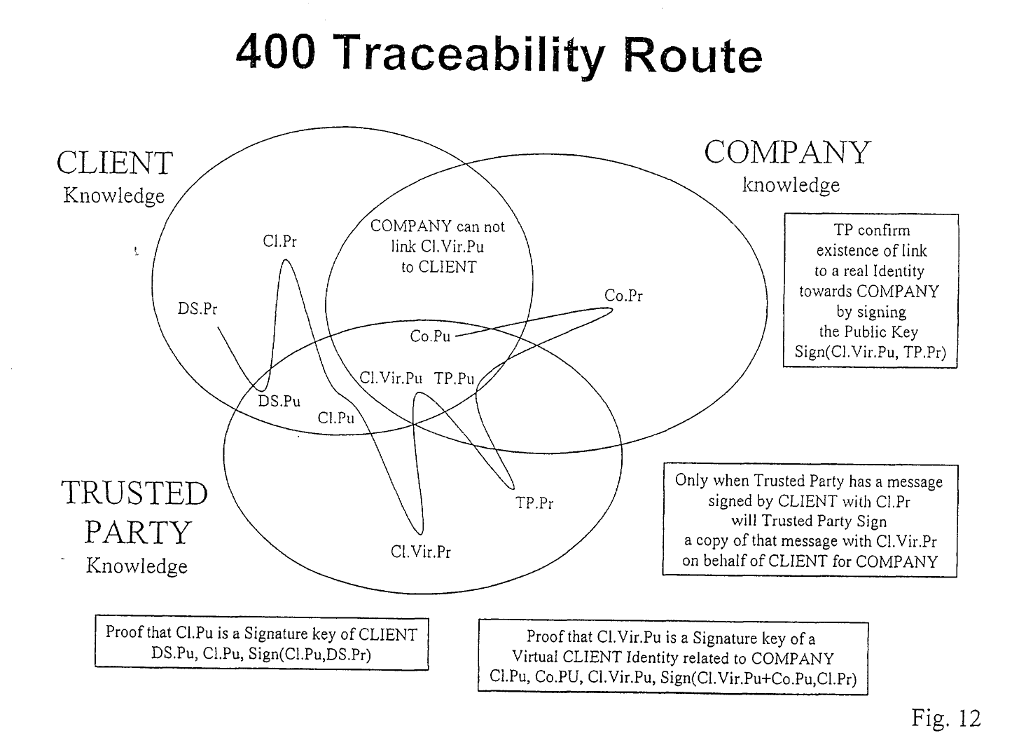

A better solution involves a double signature system implementing protection to all parts in the process. See FIG. 12 for an overview.

CLIENT creates a new set of Signature Keys (Cl.Pr and Cl.Pu). CLIENT keeps the private key Cl.Pr, which is not revealed to anyone else. CLIENT signs the public key Cl.Pu with either a nationally implemented Digital Signature (DS.Pr) or by other traditional means. The public key Cl.Pu and the Signed public key Sign (Cl.Pu, DS.Pr) are forwarded to TP. TP can now prove, non-refutably by CLIENT, that anything signed by Cl.Pr is signed by and only by CLIENT without anyone else being able to identify CLIENT. This principle is a technically well-known set-up implemented in PKI standards.

However a central advantage is that CLIENT is protected from escrow-systems, where the Certificate authority can create copies of the CLIENT Private Signature Key. Even if the national standard is based on escrow systems CLIENT can establish privacy. The server handling CLIENT identity anonymization can be located outside the national borders of CLIENT's nationality. As a general principle, implementation of CLIENT identity anonymization is dynamic so that identification information can be moved from one server to another server in another country if the situation so requires. This can for instance be the situation if military coups or other non-democratic developments are expected or feared.

When creating a virtual identity on behalf of CLIENT, TP creates a new set of signature keys (Cl.Vir.Pr and Cl.Vir.Pu). TP keeps the private key Cl.Vir.Pr which is not revealed to anyone else.

If the virtual identity is a general purpose identity the public key Cl.Vir.Pu is forwarded to CLIENT. CLIENT signs the public key with his private signature key Sign (Cl.Vir.Pu, Cl.Pr) and returns this to TP.

If the virtual identity is for a specific company then TP signs the combination of the public key of the virtual identity and the public key of COMPANY Sign (Cl.Vir.Pu+Co.Pu, TP.Pr) and forwards this together with the public key of the virtual identity and the public key of COMPANY to CLIENT. CLIENT signs the same combination Sign (Cl.Vir.Pu+Co.Pu, Cl.Pr) and returns this to TP.

The signature Sign((Cl.Vir.Pu, Cl.Pr) or Sign(Cl.Vir.Pu+Co.Pu, Cl.Pr) establishes a provable, and non-refutable by CLIENT, route between the virtual identity and CLIENT.

TP is not able to use the same virtual identity towards multiple CLIENTs because the first CLIENT decides the symmetric encryption key SYMKEY and forwards this to COMPANY. If SYMKEY is used for encryption, only CLIENT will be able to decrypt messages from COMPANY.

CLIENT can sign any message non-refutably with his signature private key Cl.Pr. TP cannot forge CLIENT's signature because TP does not know Cl.Pr. Only TP can verify this signature using Cl.Pu because only TP knows the link between Cl.Pr and DS.Pu. TP can provide this proof of link.

When TP has in possession a message signed by Cl.Pr, TP can sign the same message using the private key of the virtual identity Cl.Vir.Pr. TP will be able to provide the signed message by CLIENT and therefore does not need to know the contents of the message. CLIENT cannot forge the signature of the virtual Identity because only TP knows the private key of the virtual identity Cl.Vir.Pr.

If TP signs an agreement using the private key of the virtual identity without having a signature from CLIENT of an identical message, CLIENT is not legally committed.

If messages from COMPANY are encrypted by SYMKEY only known to CLIENT and COMPANY, then TP cannot create and sign messages on CLIENT's behalf. If messages are not encrypted and TP signs a message to COMPANY without having a CLIENT signature, then TP is responsible towards COMPANY. COMPANY will thus have a legal counterpart in any deal even though COMPANY does not know who unless the identity is freely revealed or legal disputes require revealing of the identity.

This is a general implementation of how CLIENT can enter into legally binding commitments anonymously without anyone but the deal parties needing to know the content of the commitment.

Anonymous Signature

For CLIENTs to be able to enter into committing agreements while retaining privacy, a process is set up for signing agreements electronically.

Using this invention TP is able to verify that a signed encrypted agreement exists without knowing the contents and then can forward an identical copy signed by the VID to COMPANY. TP is thus verifying that this piece of unknown content is signed unchanged without knowing what the message is about. A key requisite for this is that CLIENT is IDENTIFIED according to internal policies of TP.

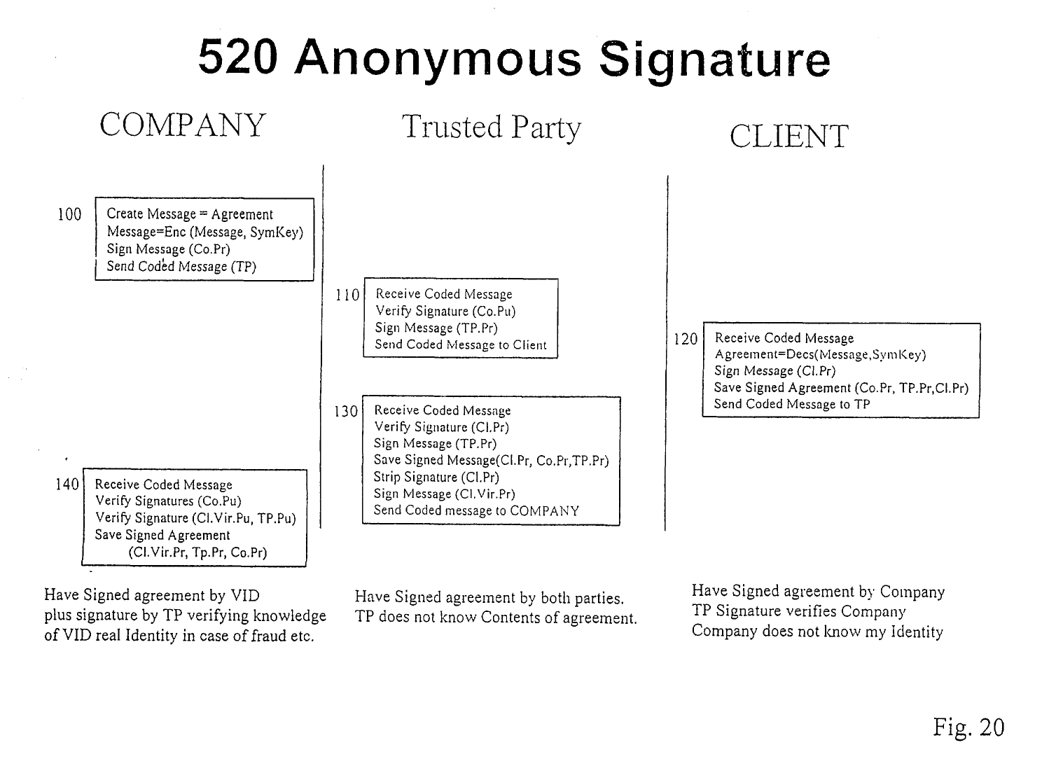

COMPANY generates an agreement that is encrypted with the symmetric SYMKEY not known by TP. COMPANY signs the encrypted message and forwards the message to TP (FIG. 20, reference numeral 100).

TP verifies the COMPANY signature and confirms this by signing the message and forwarding the message to the related CLIENT. TP does not know the encryption key SYMKEY so TP is not able to read the contents (FIG. 20, reference numeral 110). CLIENT verifies the TP signature (confirming COMPANY signature) and after checking the agreement, signs the message and returns the signed message to TP (FIG. 20, reference numeral 120).

TP verifies CLIENT's signature and the originality of message towards the original forwarded by COMPANY. TP now has an encrypted agreement signed by both COMPANY and CLIENT. The encrypted agreement signed by both parties is stored for safekeeping on behalf of both CLIENT and COMPANY. TP strips the CLIENT signature and signs on behalf of CLIENT using the private part of the CLIENT VID and by TP confirming the existence of a signed agreement in safe custody.

This message is forwarded to COMPANY (FIG. 20, reference numeral 130). COMPANY verifies signatures of VID and of TP, confirming the existence of an agreement signed by CLIENT.

It is important to note that CLIENT signs the Public Key of the CLIENT VID for verification on time of creation. TP therefore has a traceable and non-refutable line of signatures between CLIENT and COMPANY. CLIENT is protected from fraud by TP because TP cannot get CLIENT's signature on the agreement. TP will be responsible towards COMPANY if TP signs an agreement on behalf of CLIENT without having CLIENT's signature in place. TP is protected from fraud by CLIENT and COMPANY in union because CLIENT does not know the secret key of the CLIENT VID and is not able to generate deliberate fake anonymous signatures which are only signed by the VID.

Anonymous Two-Way Digital Signature

The anonymous Digital Signature shown in FIG. 20 is implemented in a two-way anonymous version between two CLIENTs by replacing step 110 in parallel with step 130 so that TP replaces the new anonymous CLIENT (Company in FIG. 20) signature with VID2 signature Cl.Vir.Pr.

Privacy-Enabled Payments

Payment intermediation involves acceptance by the paying CLIENT of an electronic invoice in a secure and anonymous environment. For one-time only purchasing of electronic goods this can be done using an electronic equivalent of cash—non-traceable token value certificates of a trusted party such as a bank etc. But for ongoing relationships. including, for instance, physical delivery or any form of credit from supplier to purchaser, additional means are advantageous.

The payment process itself is intermediated by TP acting as payer on behalf of CLIENT without COMPANY knowing the CLIENT identity unless CLIENT VID is identified. The principles for payments for an identified and an unidentified VID are fully parallel.

This principle works for credit transactions for both ordinary purchases and recurring purchases such a phone bills, TV-signals, rentals etc., in cases where COMPANY accepts the credit risk, provided that TP reveals the identity in situations where CLIENT can be proved to attempt fraud. If credit relationships are to be established, this will probably be accompanied by an anonymous agreement.

The payer can decide on multiple payment channels, including a default online account, purpose-restricted currencies, electronic anonymous money, credit card transfers and direct banking account transfers.

Since the bill is the property of the buyer, an electronic invoice is required. The invoice is stored in the protected customer files. Upon approval by the buyer, payment is confirmed according to conditions depending on the payment channel and the trade transaction involved.

Real-world payments include anonymized credit cards (with pin-code or order electronic authentication), Cash Cards, SmartCards, and direct access to a privacy server. Normal credit cards with signatures would not be included, because these will be identifiable.

Secure Non-cash Payments are implemented in several novel ways.

Electronic Bill Presentment with Payment Intermediation,

TP acts as an intermediary between CLIENT and COMPANY, with in principle, two separate payments: one from CLIENT to TP and one from TP to COMPANY.

The standard generic solution is for COMPANY to forward an electronic invoice to CLIENT via TP. The electronic invoice contains COMPANY identification information. TP presents this invoice to CLIENT. CLIENT approves this invoice and authorizes payment and the payment method in a secure channel. TP confirms payment towards COMPANY.

Payment can be against a CLIENT or COMPANY account with TP or any other means of payment including electronic cash certificates, account transfers directly against online banking accounts, credit payments, up-front payments, real-time loans etc.

TP confirmation of payment towards COMPANY can be optional so that additional services can be included such as payment upon privacy delivery, payment upon product verification, CLIENT approval or other criteria agreed.

The electronic invoice is in a structured format and stored in the CLIENT data space as documentation of the purchase.

Delivery

One of the big problems involved with establishing privacy is the delivery because the actual buyer address needs to be forwarded the shipper.

The classic solution is a mail-drop with a re-shipping involving two (in principle) separate shipments with a physically trusted party intermediating. This is a solution to the basic anonymization problem. U.S. Pat. No. 6,006,200, which suggests such a solution, is incorporated in this specification by reference.

However this solution will not fully solve the sender and context filtering and redirection needs, for instance, when the delivery address is copied by (or sold to) external parties, or when CLIENT has multiple delivery addresses (work, home, summer cottage, school, friend, family etc.).

In a networked economy, COMPANY needs the ability to pass the address back through the value chain to the actual supplier, with the delivery still being traceable to COMPANY. For instance, an online clothes store needs to be able to send a delivery request to a custom clothes manufacturer to deliver a customized dress to CLIENT without the custom clothes manufacturer being able to identify CLIENT or send additional communication to CLIENT.

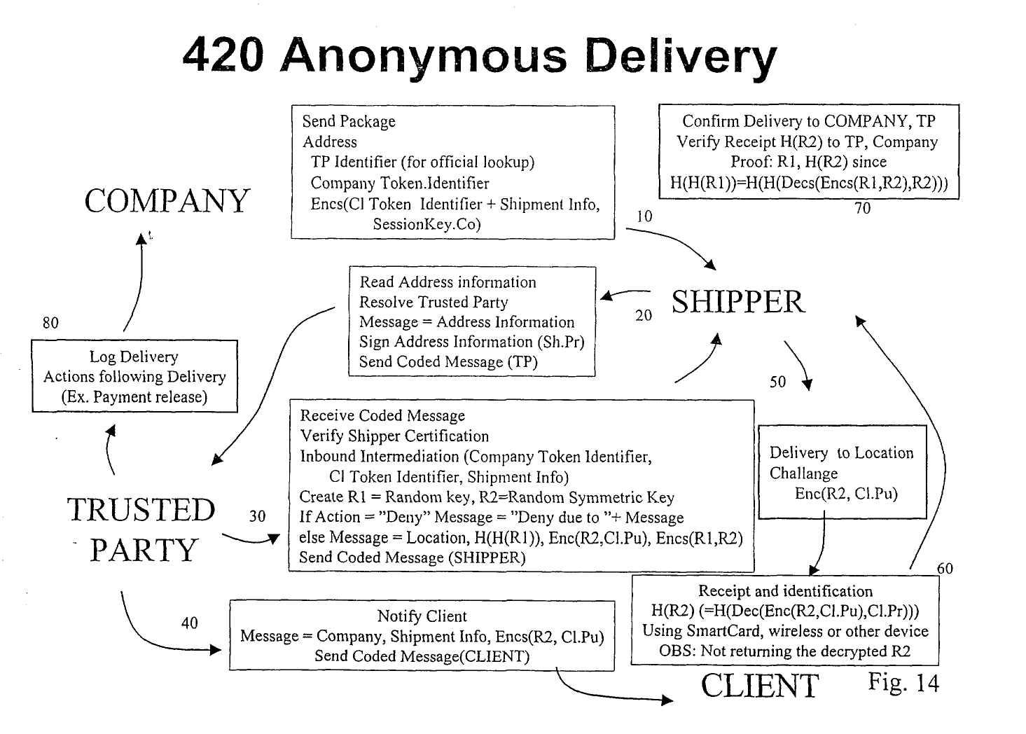

This invention works with an address identifying a) the Trusted Party, b) the sender (towards Trusted Party), and c) reference information combining CLIENT Token Identifier and shipment information. See FIG. 14.

In the COMPANY customer database, the default address for CLIENT (Cl.Vir.Pu) is

TP Token Identifier (for lookup in an official registry like a X.509),

Co Token Identifier (for TP to identify sender for Access Control filtering),

[Encs(CLIENT Token Identifier+Timestamp, CompanyKey)].

This default address can be used in standard word processors for any manual mailings such as direct marketing etc.

For package deliveries and special mailings a new address is created because shipment information is changed to a transaction or dialog identifier. The SHIPPER or other third party has thus no way to construct an address that does not resemble a default manually time-stamped address. If abused and regularly this address can be renewed, leaving no external access for abuse not involving either SHIPPER or third party. COMPANY can actively sell the address plus CompanyKey but in this case COMPANY is punished for any SPAM since mailings will be traceable to COMPANY and thus can be stopped in the filter process.

COMPANY can make an agreement with CLIENT about Special Shipment Information that can be used to differentiate manual mailings by type. CLIENT can then build these rules into the Access Filter. SHIPPER can anonymously and Zero-knowledge identify Client and prove delivery (FIG. 14, reference numerals 30 to 70) by receiving:

a) information to challenge CLIENT at point of delivery; and

b) data to verify by a cryptographic algorithm that the response is valid. In one embodiment this can be accomplished by generating two random keys R1 and R2. The SHIPPER is informed of the Hash result H(R1), a challenge for CLIENT (Enc(R2,Cl.Pu)) and the result of Encs(R1,R2) to verify the response. When challenging CLIENT with Enc(R2,Cl.Pu), SHIPPER will receive the answer R2 that resolves H(R1)=H(Decs(Encs(R1,R2))). Since only CLIENT can bring this missing piece to the puzzle R1=Decs(R1,X), answering R2 this identifies CLIENT to SHIPPER, and CLIENT cannot deny proof of delivery towards TP.

Note that SHIPPER does not know the identity of CLIENT and therefore does not know Cl.Pu. Cl.Pu is not the published actual digital public signature key of CLIENT but as the general principle part of a generated key pair signed by CLIENT's private digital signature key. R1 can be a complex message, and R2 can be chosen according to CLIENT's means of authenticating.

For SHIPPER to prove that he has not generated a fake R1, R2, he saves the entire Signed Coded Message by TP (see FIG. 5, reference numeral 120).

The special case where a pickup service is arranged complies with the same principles, but in a different sequence of activities.

CLIENT can, on top of the intermediated delivery service, add a mail-drop partner with, for instance, a nearby friend, a nearby shop or a local community organized drop-point. CLIENT will notify this mail-drop partner of (Enc(R2,Cl.Pu) and R2) when expecting shipments. When challenged with Encs(R1,R2), the mail-drop partner can give the solution without knowing the CLIENT Secret Key (Cl.Pr). This will protect against the situation where SHIPPER abuses the trusted relationship and informs COMPANY of CLIENT's identity. However, it adds a level of inconvenience since CLIENT will not receive the shipment to his house.

For the CLIENT to protect himself against abuse by TP in liaison with SHIPPER, CLIENT can provide TP with H(R1) and the encrypted parts Enc(R2, Cl.Pu) and Encs(R1,R2) but not R2 itself, or CLIENT can generate the challenge sequence at time of purchase or dialog. This is built into advanced trade and dialogue solutions. Optionally CLIENT can continuously forward combinations of generated keys to TP for this purpose to avoid being a delaying factor in the costly and sensitive physical distribution process from shipment to delivery.

Most SHIPPERs have standard Track/Trace Services to build COMPANY and CLIENT services which will be used in different parts of this Invention.

This process supports both a cross-border package delivery, a local grocery delivery and ordinary mail. Local adaptations of the general principle can be necessary. An embodiment of the present invention comprises a Postal Services Move-Database used for fast redirection of Mail and parcels. A further embodiment of the present Invention comprises a SHIPPER delivering directly to the CLIENT residence.

Anonymous Internet Letter of Credit

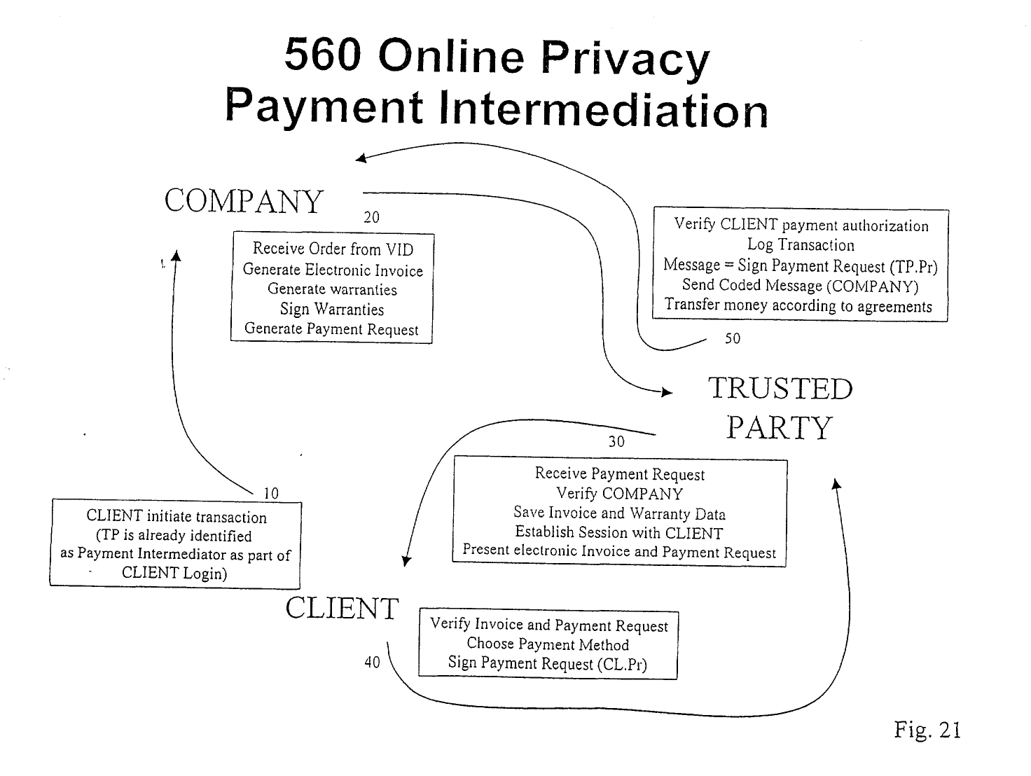

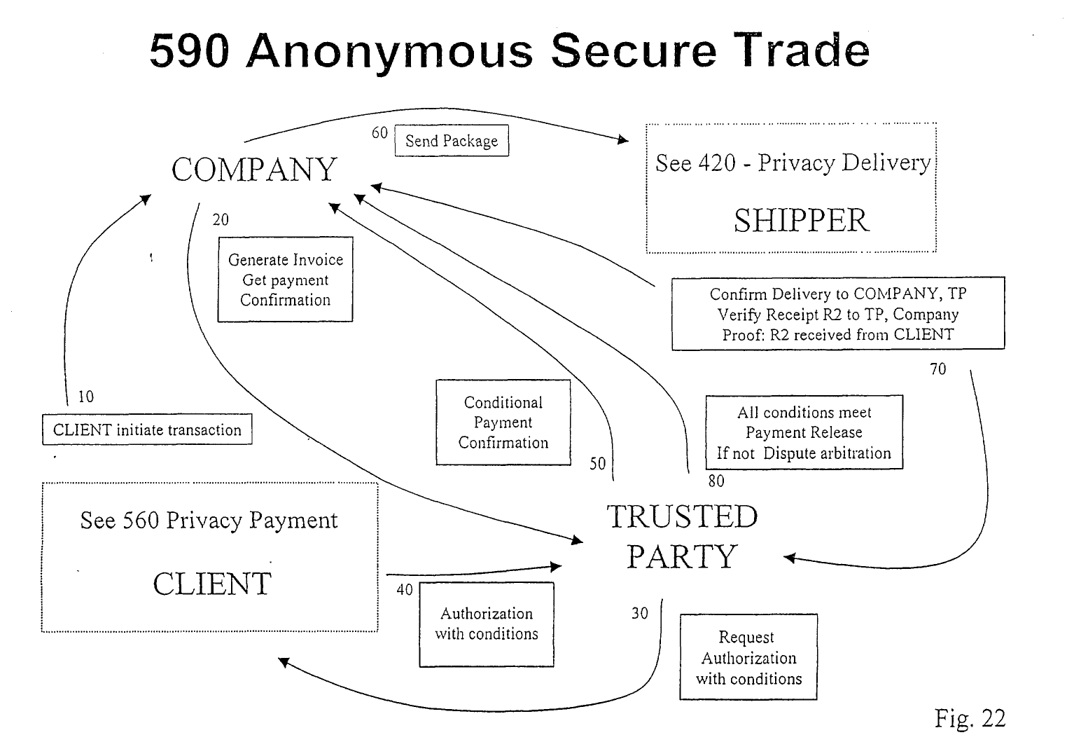

A new level of Internet Trade Security is established by combining a Trusted Party and anonymization with the dual control of delivery and payment (See FIG. 22 combining FIG. 14 showing Anonymous Delivery and FIG. 21 showing Anonymous Payment).

Towards CLIENT, TP ensures privacy and non-release of Payment until actual delivery and approval of conditions. Towards COMPANY, TP will ensure release of payment when delivery is verified and approval of conditions. Conditions can be incorporated so that CLIENT has time to control the goods before the release of payment.

Conditions are normally based purely on time from delivery proof. If no objection has been raised by CLIENT payment is released. However special conditions can be met where CLIENT has to approve payment release.

CLIENT surfs COMPANY Website and determines what to purchase. An order request (according to OBI or other trade standard) or invoice is forwarded to TP for approval.

TP gets CLIENT's approval and confirmation of payment. Payment is secured until delivery is confirmed. TP confirms conditional payment authorization towards COMPANY. COMPANY ships the purchased goods according to agreement (reference numeral 420). The TP receives the proof of delivery when confirmation from shipper is received, and when the conditional terms have been met, payment is released.

A fully parallel solution exists for Interactive TV purchases, telephone purchases, and other channels. The same secure principle works for semi- or fully identified VIDs without privacy.

Product Responsibility

In the standard Anonymous Letter of Credit, Buyer has no guarantee that the goods delivered are the right goods or that the goods have sufficient quality.

Additional services can be offered on top of the base service.

A simple solution is for the anonymous Letter of Credit to be extended for BUYER to have time to verify quality of goods before release of payment. Terms can be agreed between Buyer and Seller. One embodiment will include a fixed time before release of payment. Unless Buyer objects, payment is released.

Another embodiment includes a third party product verifier in the delivery process so that Buyer and Seller have unbiased verification.

In situations of dispute a legal arbitration can be initiated.

Privacy-Enabling Trade Standards along the Full Value Chain

This invention incorporates Privacy Enabling the full value chain back to the originating supplier with intermediated shipping directly to CLIENT.

Through a Trusted Party a CLIENT is able to trade using Open Trading Specifications such as OBI TM (Open Buying on the Internet—www.openbuy,org) and other standards. This invention incorporates a Privacy Enabling implementation of open Business to Business specifications.

TP will intermediate the transaction including payment, delivery control, warranty and post-delivery service according to the Privacy Trade Platform. In the generic technical solution TP will act as the Buying Company and CLIENT will be technically be disguised as an employee of the Buying Organization.

By default COMPANY will be informed by agreement that the real purchaser is a CLIENT not employed by TP. The Virtual CLIENT Identity can be a one-time-only Identity or a COMPANY known virtual identity according to the purchase background.

If it is a one-time-only identity then the customer type (private, corporate role) will be part of the initial profile presentation—important to ensure CLIENT's rights according to law such as warranty rights, etc.

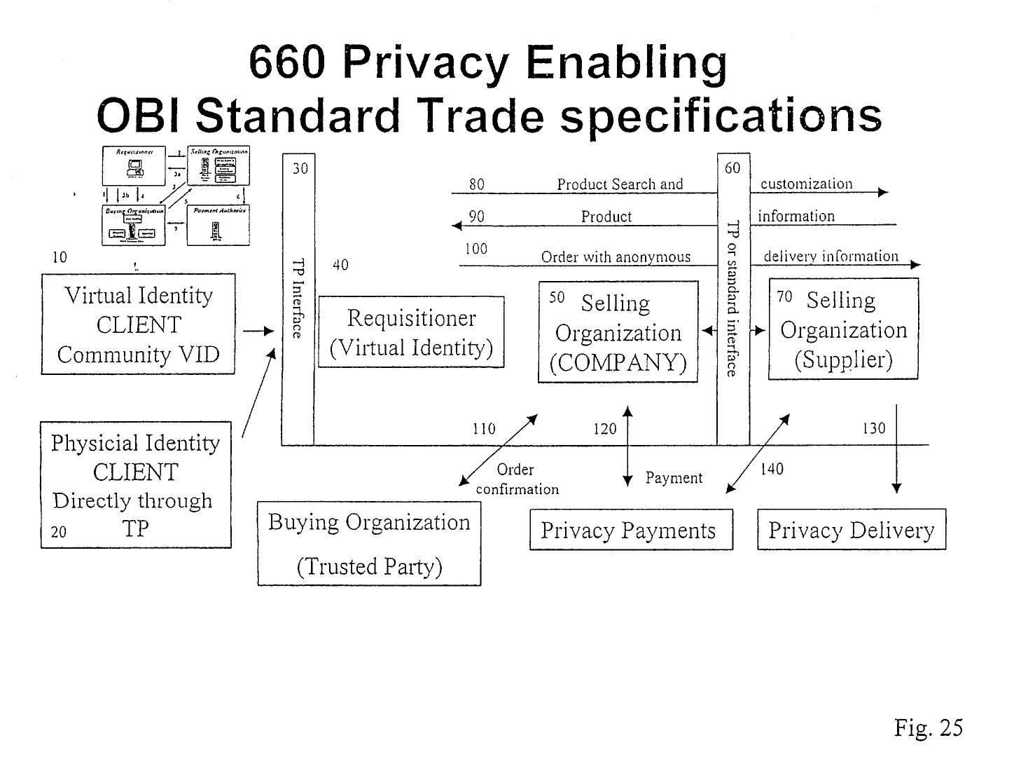

An embodiment according to OBI 2.1 is shown in FIG. 25. Please note that FIG. 25 can have additional suppliers in a multi-party Value Chain without changing the basic concept.

CLIENT has an intention to buy a specific product knowing the product and/or the desired supplier. Acquiring this information can be the result of additional TP services not relevant to the OBI Standard. TP supply CLIENT with the correct VID. CLIENT goes to the selected supplier Website and is technically identified by Selling Organization as an employee of TP and is presented with products and prices according to agreement. CLIENT selects products according to standard shopping methods.

When CLIENT has selected products to buy, an Order Request is forwarded to TP as buying organization. TP gets authorization for the order and payment terms from CLIENT and issues a formal order with an Intermediated Delivery Address supplied with the encrypted shipment information. COMPANY issues an Electronic Invoice, which is forwarded to TP for payment according to terms and ships the goods.

When SHIPPER documents delivery, the payment transaction is released exclusive of fees according to agreement.

This method can easily be implemented in other parallel B2B trade specifications. Since TP can translate between standards, this method also opens for trade across regions with different standard trade specifications so that a European CLIENT can purchase from an American supplier, creating a truly homogenous trade flow for suppliers across segments and standards.

If the product/supplier selection originates from a virtual online store, these principles fully support and intermediate the trade solution between a virtual stockless online store and suppliers. The virtual store can concentrate on the communication with CLIENT and receive the agreed fee for any resulting transaction. TP protects the virtual store/CLIENT customer relationship from the supplier, as the supplier is not aware of CLIENT's identity.

If CLIENT is identified to the virtual store, a one-time-only identity will ensure that collaboration between the store and supplier cannot be linked to other purchases.

This invention also incorporates a solution where TP uses and supports a third-party broker for locating the cheapest supplier able to supply or the best product according to Common Business Library Product Catalogue with standard Product Identification and references to suppliers.

Note this is not distinguishable from FIG. 25 if the third-party broker is not using TP services for supplier transactions, since shipping information is transferable down the value chain without changes.

If CLIENT is acting as a Corporate Purchaser, this solution also incorporates a fully anonymized Business to Business trade service.

Anonymous Transfer of Ownership

In parallel to the Anonymous Signature, CLIENT can wish to transfer ownership including rights and obligations to a third-party. This can be in situations of gifts bought for someone else transferring warranties or a simple trading of purchased goods between CLIENTs.

New requirements to this service are the ability for the Buying CLIENT to accept obligations anonymously, for the Selling CLIENT to accept transferring rights, and for COMPANY to verify transfer of rights.

For some products or services COMPANY has a right to refuse transfer of ownership, rights and obligations. This is a special case to be handled by the parties in between with possible dispute arbitration.

Implementation is parallel to Anonymous Signature except that additional parallel steps are involved. Please note that CLIENT, COMPANY and CLIENT 2, even though they do not share a common encryption key, can still verify the originality of an agreement by providing a Hash value of the unencrypted message.

Anonymous Post-Sales Service

Warranty

Upon purchase warranties are separately registered in order to facilitate support and to issue reminders to CLIENT that just before the warranty runs out to check if any repairs are necessary.

COMPANY can issue a special electronic warranty stating clearly what is covered by warranty and how repairs, upgrades etc. should be handled. This electronic document can contain links to the COMPANY Website for detailed information.

CLIENT can at any point show the original electronic invoice regarding the purchase and use this to claim warranty services.

Anonymous Repairing

For products with warranty or just defects, returning products to the supplier needs co-ordination. CLIENT interacts with supplier using his VID and receives a reference numeral to use for returning the product. CLIENT packages the product and issues the return slip with the reference numeral and ships it using any shipper.

In case the shipper has problems, or in returning the product to CLIENT after repair, the same procedure will be followed as when originally sent (see FIG. 14 Anonymous Delivery). As his own return address he uses the address of the VID with the reference numeral encoded into the address (ENCS(CLIENT token Identifier+reference numeral, SYMKEY)).

Anonymous Legal Representation

A mediation process is enabled for crime investigation, enabling legal representation of unidentified individuals. Under these circumstances a suspicion by the police is not enough for TP to release the identity of a CLIENT. A judge will have to be involved and the individual informed of the proceedings.

The rights and procedures will depend on national and international law and will be subject to change. The base principle is to ensure that no privacy violation is possible without legal representation. In this it is assumed that CLIENT has a fundamental right of remaining non-identified until just cause is proven.

A full legal proceeding handling commercial disputes can be carried out with lawyer representation without CLIENT's identity being disclosed. Unless criminal activities are involved, CLIENT's right of non-identification is defended by TP.

In case of investigation of a possible criminal offense, the police or other authority may wish to contact CLIENT. If it is only for information they can interact with a VID not knowing the real identity of CLIENT unless CLIENT decides to be identified. Assuming the police want to identify CLIENT, they will need a reason for this. In order to justify a reason, they need to have a judge grant identification.

TP can and must as minimum ensure that proper proceedings are in place before releasing identity. For this CLIENT must be issued a lawyer representation. A special VID of CLIENT is created to Interact with his lawyer so that not even the lawyer knows his identity.

If the police fear the crime is of a type that may lead to a possible escape they can ask to have a lawyer representing the CLIENT without CLIENT's knowledge of the proceedings. This has to be justified to the judge, and the lawyer will have to contest this violation of CLIENT's rights of privacy.

TP and the lawyer and the CLIENT (unless he is not informed due to a decision by a judge) can now interact to defend CLIENT's right of non-identification.

PrivId Card

A PrivId Card (PIC) is a tamper-resistant SMARTCARD containing as a minimum the private key of a VID, the public key of TP and an ability to encrypt. Additionally it can have an internal clock to time-limit the private key. Asymmetric, Symmetric encryption, Sign, hash, Random, One-time-only key pairs are possible.

When entering into agreements or purchases requiring identification, the privacy server will act as a guarantee of identification and/or intermediary in legally binding agreements. Specifically this will also apply when purchasing communication services, making new communication channels anonymous by definition.

When entering a shop a CLIENT can virtually identify himself after which the shop can offer specialized services based on his prior purchases and private information given. A login procedure is taking place in order to protect against theft or abuse of PIC's.

The Shop Internal Identification can either be transferred from the privacy server, using wireless communication units (infrared, mobile etc.) or from the PIC itself. See the Authentication procedure.

If CLIENT is a member of a customer club, special services can be suggested using a variety of different interactive communication channels. For instance special purchase suggestions (a specific item), special services (information support) or individual discounts (based on the full customer knowledge). The Client can have individual pricing on all goods and services as being previously virtually identified.

When receiving payment, the club will forward an electronic invoice to the privacy server. The Client can accept this for payment through a one-time only verification. This can be done using a request-answer protocol or through alternative interactive channels such as a Mobile Communication Unit. The club will then receive verification from the privacy server that payment is approved.

A technically reduced version of the PrivId Card is an anonymized credit card only featuring an identifier, an end date, and a TP Company name not related to CLIENT and information as to the card issuer. This anonymized credit card can be accompanied with a partnership agreement with credit card verifiers to enable Strong Authentication—see Migration Services Payments. In this version, no fraud is possible without additional traceability having been established in the form of a strong authenticated authorization.

This version of the PrivId Card will enable anonymous payments in existing COMPANY infrastructure without changes. However one weakness will remain. The identifier itself (card number) will be usable for cross-COMPANY linkability.

Privacy Trust Program

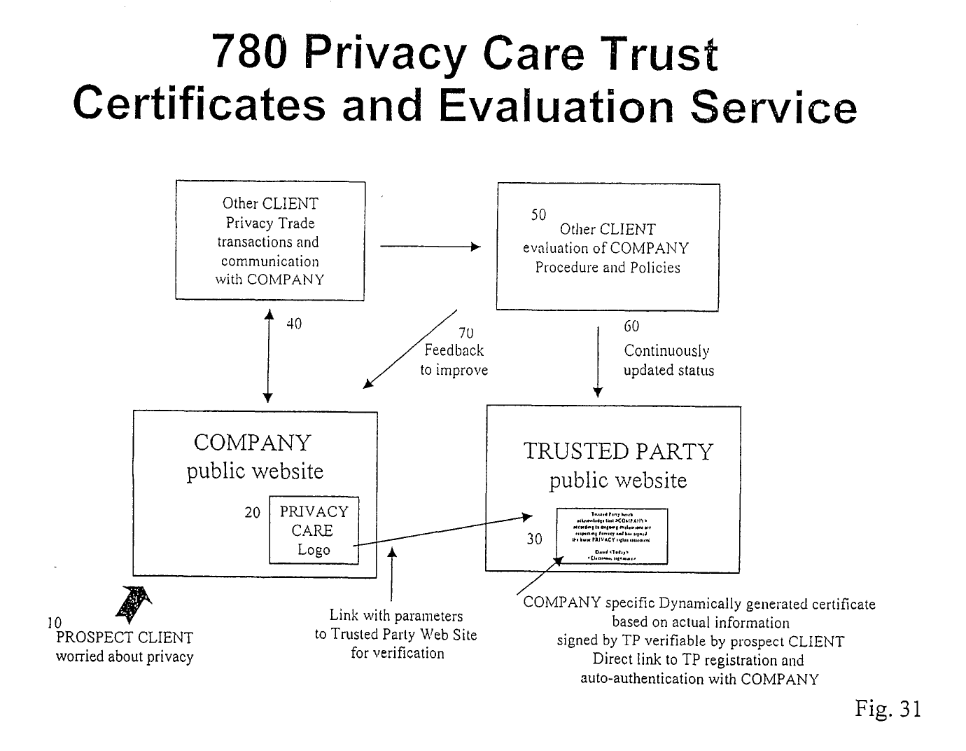

A central solution in this invention is the establishment of close-loop customer privacy trust certificates for companies (see FIG. 31).

A Privacy Trust logo icon can be located at the COMPANY homepage (FIG. 31, reference numeral 20). When a new prospective customer of COMPANY looks at the COMPANY Website, he can look for the Privacy Trust logo. In order to prevent abuse by COMPANY, the prospective customer can press the Trust Logo and through a link reach a TP Website where a Trust Certificate is created, verifying that COMPANY is abiding by the principles of privacy both in signature and in actions (FIG. 31, reference numeral 30).

A Trust Certificate requires:

Firstly COMPANY has agreed to establish Privacy Policies. These policies are subject to change but include basic acceptance of customer rights to remain anonymous, how to handle Privacy violations etc.

Secondly a continuous closed-loop feedback system is established in order for other CLIENTs of COMPANY to continuously evaluate COMPANY communications and practices based on Privacy Trade Interaction (FIG. 31, reference numerals 4 and 50). COMPANY violation of critical privacy issues can instantaneously lead to a revocation of the Privacy Trust Certificate. This is a strong incentive for COMPANY to handle complaints respectfully and fast.

Non-CLIENTs of TP can, from the Trust Certificate, register with TP and get immediate anonymous auto-authentication (FIG. 31, reference numeral 30). TP CLIENTs authenticating with COMPANY will receive warnings if the Trust Certificate is revoked.

Communication Intermediation

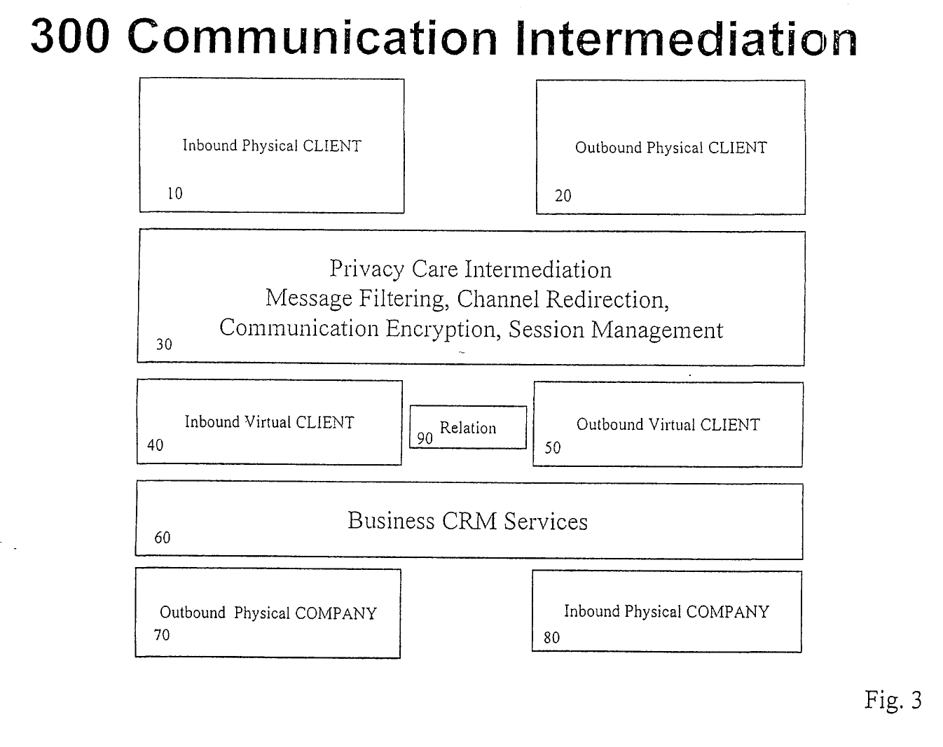

The communication intermediation process includes a) catching the communication attempt in a virtual manner, b) identifying involved actors, c) filtering according to setup rules (inbound communication only), d) routing the session according to rules and receiver instructions (inbound communication only) and e) managing the session to establish and manage the communication. See FIG. 3.

Intermediation of All Channels

Central to establishing Privacy is intermediation of communication channels for anonymization, blocking, filtering and rerouting purposes. On top of privacy, however, significantly added value out of convenience and flexibility is achieved.

This is done by different methods depending on the channel. The general methods are as follows:

Mail-Drop

The strongest level of intermediation is where the channel has no direct physical outgoing channel.

This includes, for instance, Web-browsing using strong cloaking services, online email accounts, physical partner-intermediated package delivery, filtering to Suggestion House, payment intermediation etc.

Virtualization

The next strongest level of intermediation is where the channel has different appearance towards COMPANY than physically.

The process of virtualization requires that communications pass through an active part of TP where communications are re-addressed and re-packed without the possibility of linking physically outgoing to the virtually incoming communication.

The weak spot of virtualization is the physical address not being under control of TP. This include email re-routing, fixed line and mobile telephone, strongly encrypted wireless, and intermediated communication such as mobile phones passing through TP and letters with rerouting.

Strong Anonymization

This is defined as intermediation where the channel is acquired using an anonymous VID and used for another VID. Strong anonymization is linkable by the ID of the communication channel itself. The ID must be subject to frequent rollover.

This includes Anonymous Credit Cards, Mobile Phones without intermediation, Satellite Interactive TV.

Weak Anonymization

This type of intermediation occurs where anonymity depends on an external partner such as a postal service or a fixed telephone line with direct connection without an active TP component.

Blocking

If Intermediation cannot be established, the communication channel cannot be used in connection with a non-identified VID.

Catching the Communication Attempt

All virtually defined channels will by definition go through TP in order to be linked to the appropriate physical channel. The Catch process default involves defining the Inbound Access point integrated with the Token Channel Identifier. Emails reach a TP-controlled mail-server, inbound telephone numbers are TP-controlled numbers with imbedded CLIENT token information (e.g. as an extension) etc.

The Catch Process will in some cases also involve alliances. For instance, delivery, SmartCard, credit card etc. all require a partner active contacting TP in order to attain critical information to establish a session.

A central concept is that intermediation requires CLIENT participation (active or passive) and this leaves CLIENT in control. This includes the possibility of bypassing TP whether this is temporary for Web-surfing or dealing with relations or suppliers that CLIENT does not want TP to know about. The CLIENT can always login identified (even with a supplier where CLIENT has a VID-relation), inform relations of the physical channel identifier or establish additional communication channels such as Web-mailboxes, ISP-dialups etc.

A central embodiment will be WAP Push Proxy filtering because the WAP Push service will be misused for SPAM. Privacy enabling in devices such as mobile phones and interactive television is key to SPAM protection. Anonymization is the first step in achieving this.

In catching outbound communication attempts it is important to realize that CLIENT will always be the weak link. It will not be possible for TP to catch all outbound communication attempts, face-to-face communication being the extreme case. CLIENT needs to be mentally aware of the role he chooses when contacting COMPANY. It will thus always be the responsibility of CLIENT not to reveal information that will compromise anonymity. TP will provide services that help minimize these problems.

Outbound communication attempts made using TP operated means of communication can be caught in the same way as inbound communication attempts. Communication attempts using non-TP operated means of communication can be supported by providing switching facilities, e.g. a TP dial in service that can be used to establish contact with a given COMPANY.

Identification of Sender/Receiver

The CLIENT receiver will by nature of definition be easily identified inbound, since the Token Identifier of the Communication Channel is uniquely traceable to the CLIENT by TP only. When entering through reference numeral 10 in FIG. 2, the Token Identifier can be translated into the VID using reference numeral 20 and from there be matched with the related Role or Base Identity.

A Channel Partner requires special identification and authentication to verify privacy protection agreements and risk of leakage. This especially includes Delivery where address conversion is requested.

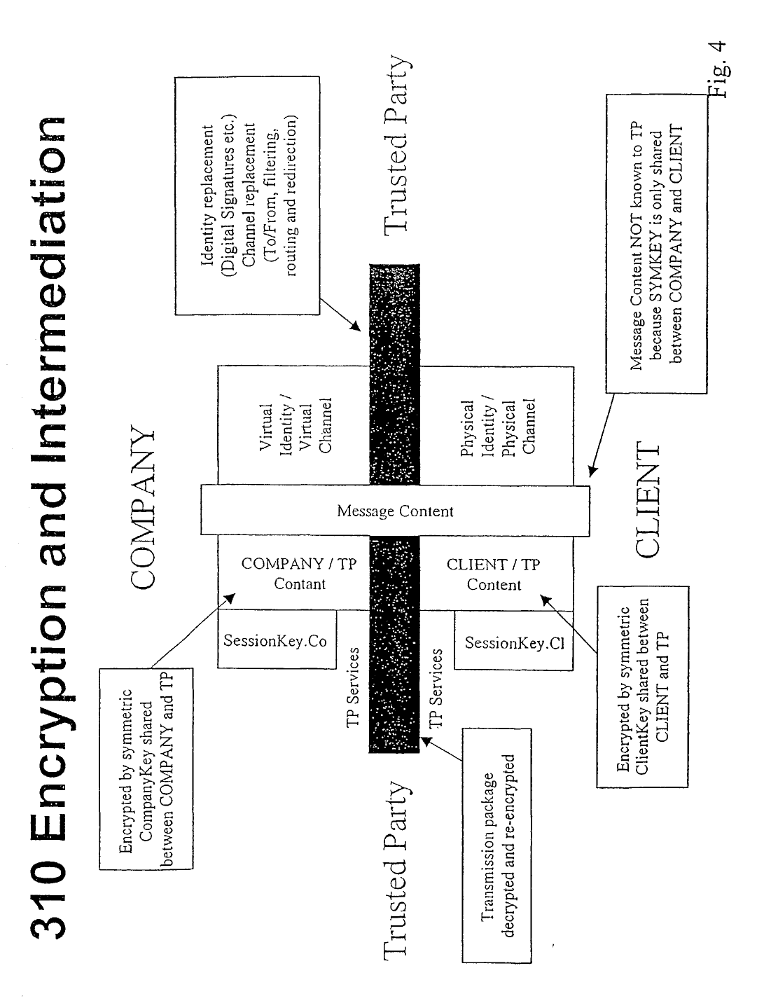

Sender will in most cases be identified using a Token Identifier and authenticated using a PKI Scheme. Using email, this can be achieved by combining sender with email encryption. See FIG. 4.

Authentication

Stronger or verified channels can be used to verify weak security channels. A strong channel is an identified and access-controlled channel that can be used to communicate control messages that, upon being used in a weaker channel (or vice versa), verifies the weaker channel to the level of the stronger channel. For some weak channels this can only be a session verification. For instance credit cards can be stolen, and normal telephone lines have general access and are without standard login procedures.

A specific feature of the invention is the use of a mobile phone to verify credit card payments. The digital signature verifies the online email and the browser interface. Using this, channel telephone, physical address, mobile etc. can be verified.

Identified/Non-Identified Sessions

A sender cannot be identified in every circumstance; for example, a friend calling from a public pay phone. It is then up to the CLIENT receiver to decide. This decision can be built into the VID so that non-identified communication attempts will only be accepted in special semi-identified VIDs used for personal relations, i.e. if the SENDER knows the Token Identifier, then SENDER is likely acceptable, and RECEIVER accepts the call by default. On the other hand, for the general surfing VID, the CLIENT can decide not to accept non-identified SENDER communications and not even be prompted in advance.

If identification is a requirement, a caller can authenticate interactively using previously agreed-upon methods if caller is already known to TP.

Mapping between VID and Physical Communication Channel

Identification will include establishing a mapping between physical identifiers and VID, enabling session management to perform this mapping with an insignificant overhead.

Session Management

The mapping provided by session management has to be divided into two separate parts, each encrypted with a separate session key to avoid breaking anonymity by monitoring and pairing inbound and outbound communication. See FIG. 4 describing the basic set-up.

Basically two separate processes parts are involved.

Encryption is central to protect against eavesdropping and surveillance of communication. This is multi-layered.

Central is the core message encryption using SYMKEY between CLIENT and COMPANY. The purpose is to ensure nobody but CLIENT, COMPANY and anyone trusted by either of these will have access to the actual message content.

Added to the central message are functions, data, and messages to and from TP encrypted with ClientKey or CompanyKey respectively. Messages will thus be decrypted and re-encrypted in the intermediation process.

Basic communication encryption is established in addition to this using session-specific encryption keys, such as Sessionkey.Cl and Sessionkey.Co in, for instance, SSL or Virtual Private Network solutions dependant on national implementations and CLIENT/COMPANY technical abilities.

In addition to the encryption process. communication packages are continuously re-addressed including changing to and from addresses, stripping identifiable signatures ad replacing them with the appropriate Virtual Identify or Channel specific information.

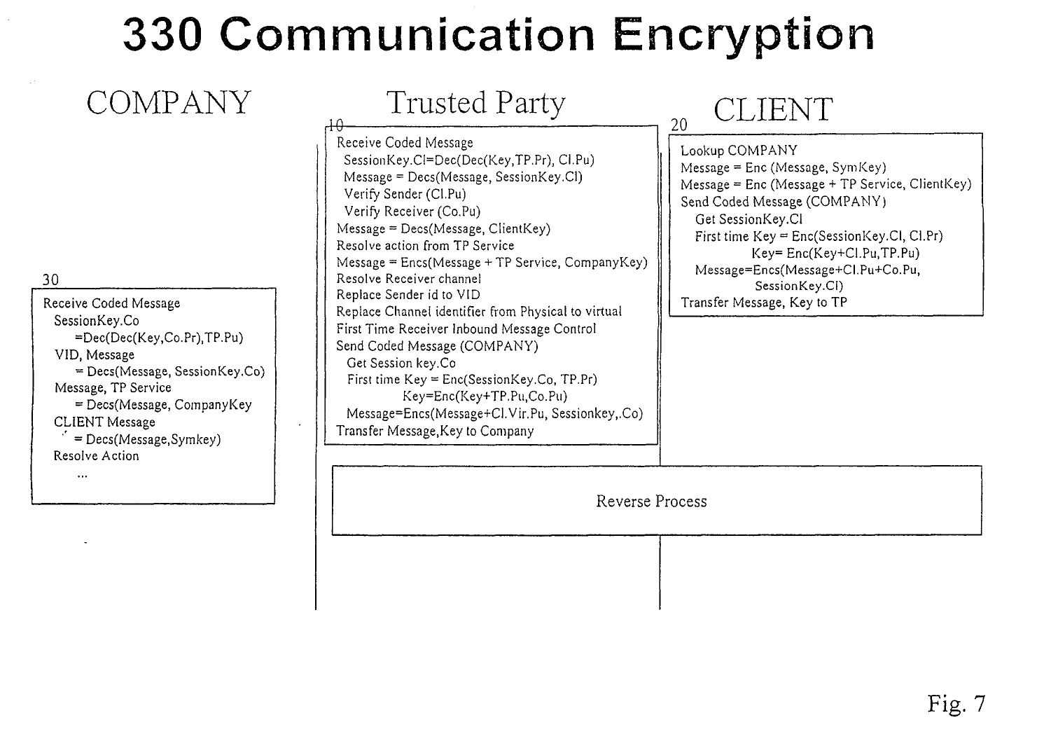

Session management facilitates real-time mapping of physical to virtual information. See FIG. 7.

Inbound Channel Intermediation

Inbound Intermediation is a central process with the objective to identify and block SPAM at the same time as letting through all relevant interactions in a way where the CLIENT-receiver is not identifiable beyond existing knowledge by the COMPANY-Sender.

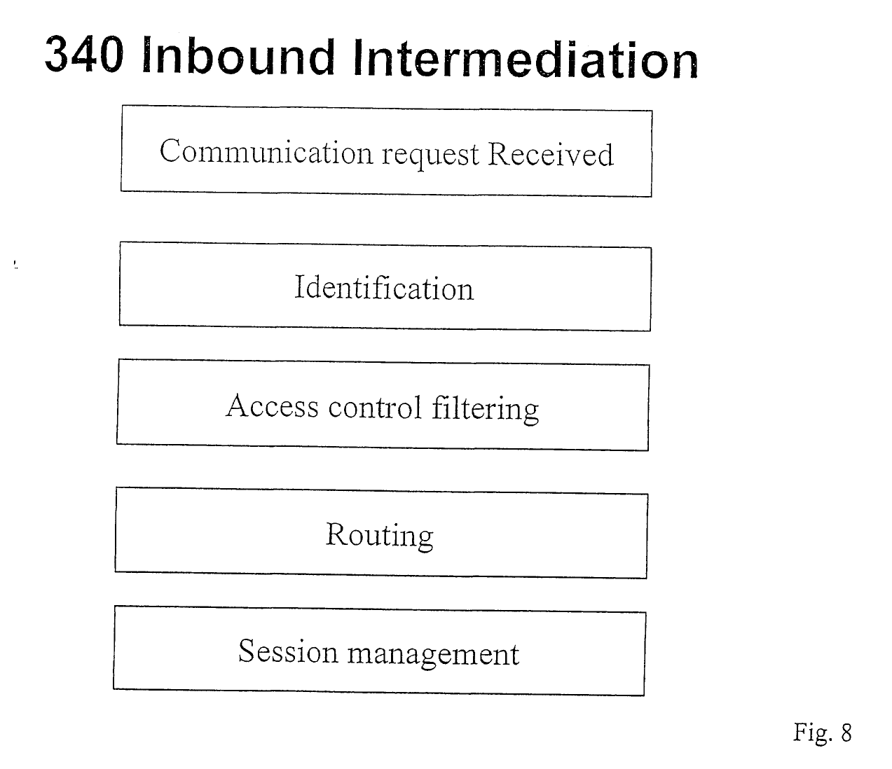

Access Control Filtering, redirection and quality evaluation are steps unique to inbound channel intermediation. See FIG. 8.

Access Control Filtering

When TP receives a message bound for a CLIENT it will act as the CLIENT agent deciding if the message is to be denied access, let through, routed to Suggestion House (see Personal Services) or other action taken. One possible further action is a request for additional information from sender/caller.

CLIENT can, prior to the event, establish a set of communication rules. These communication rules are based on the richness of information available to decide.

Available information includes sender identity, channel, purpose (if available), importance, receiver temporary rules, receiver actual status, sender history, dialog status, commercial transactions status, sender history with other CLIENTs, etc. Additionally, special references can be set up in an agreement between CLIENT and COMPANY. A specific example of this is the delivery channel where COMPANY can incorporate reference information in the encrypted part of the address.

If sender is previously unknown to receiver and/or TP, then sender can be identified and classified afterwards to control future communication attempts.

| Example of rule: | | Comment |
|---|---|---|
| If | Identity_Type=MAILLINGS | Special VID used email NEWSLISTS |
| and | Channel in (EMAIL, MAIL) | Using a channel relevant to the VID |

| | | |
|---|---|---|
| and | Sender in Opt_In List | Sender accepted by CLIENT |
| prior? | | |

If not SPAM risk high

| | | |
|---|---|---|
| and | SENDER_HISTORY = NON_SPAMMER | (Global Opt-Out blacklist) |

| | | |
|---|---|---|
| then | Return | (Action=“Forward”, Priority=2, Message=“News”) |

Rules can be increasingly intelligent. SPAM messages from previously unknown sources are readable by TP due to lack of secret encryption keys. These messages can optionally for CLIENT be subject to filtering using automatic Text Scanning rules and evaluation by other CLIENTs of earlier communications from the same source. Using neural networks combined with CLIENT evaluation of earlier unencrypted messages, a quasi-intelligent neural net simulating CLIENT preferences can be trained and available for future communications. If CLIENT does not establish an encryption key not known to TP Symkey, then TP can be asked to scan messages from known sources also.

Sender history makes it possible for an access control filter to condition the rule on evaluations by CLIENT or other CLIENTs of COMPANY (see evaluation of quality). This is especially interesting if a COMPANY suddenly starts to abuse emails for SPAM marketing. As soon as the first significant group of CLIENTs has characterized COMPANY actions as SPAM, COMPANY can be reclassified as a potential spammer leading some access control filters to block further communication. Central here is the link to the Privacy Trust Program because the same problem will be visible to CLIENTs in the authentication process, thereby reaching a large subset of the COMPANY's customers shortly after change of policy putting a heavy pressure on non-accepted behavior.

The output from the access control filtering can be either a denial, a routing to the suggestion house for sales/marketing messages, a request for additional input (such as a password or an identification), an individual message requesting or serving as input for the redirection service.

Individual blocking can be useful in a general concept to avoid bothersome contacts ranging from press-people to unwanted earlier boyfriends.

The Priority parameter can be used both to speed a message and to slow it down. It serves as a control for how extensively receiver shall be searched through all channels. For instance, an emergency call from a child of a receiver can lead to a search through all channels. On the other hand, a low priority message is more likely to end up in the electronic answering service.

The function of receiver (role-dependant) is very important because an email to a workplace, for instance, most likely is to be routed to a colleague rather than to a private communication channel.

Receiver Actual Status parameters are parameters of situation-specific rules that can be dynamically altered to the specific situation of CLIENT. CLIENT can be in a shopping mode, letting through more sales-related messages. These rules are to be seen in close connection with the following routing rules which are almost 100% situation-based. For instance, if CLIENT is in a shopping mode with a GPS-enabled WAP mobile phone, CLIENT can accept receiving Calls for Action based on location. These SPAM calls are normally filtered out.

Routing

Routing is the central CLIENT Communication Path Control ensuring that communication is best suited to actual wishes, communication type, security, convenience and cost.

CLIENT can contact TP to inform TP of CLIENT mode and the presently preferred communication channel. This highly very valuable feature provides the ability to dynamically change status without sender knowing or having to consider it.

Similar temporary communication channels like a phone number of a friend or hotel room or a temporary replacement of a broken mobile phone is easily included on equal terms as other communication channels again without sender knowing or having to care.

Low priority messages not relevant for the actual situation can be routed to the universal answering service. High priority messages can involve extensive search in all communication channels or notification in mobile or other channels.

A very central example of a high priority message is where a relative under the care of a CLIENT is in need of help. This could be a child, an elderly person, or a disabled person. These relatives are often troubled by the difficulty in locating CLIENT. Instead a single alarm number can be setup and pre-programmed into telephones or Wireless beepers where a call will automatically trigger a Top-Priority establishment of a Communication Path to CLIENT.

Another example of a high priority message is an online real-time payment authentication where a user is purchasing using a credit card. In this case routing options could be prioritized in the following order:

a) link to an active User Session

b) authenticate through wireless means of communication

c) verify against previously approved list.

An example of a situation-specific contact protection is when CLIENT is in an important meeting or otherwise attending something that should not be disturbed. Instead of shutting off, for instance, a mobile phone, CLIENT can go into a meeting mode and increase the threshold of importance before being disturbed. More messages will be routed to the answering service but emergency calls will still be put through. When attending a meeting, RELATIONS with relevance to the meeting can temporarily get higher priority and thus enable user controlled relevance criteria.

During the routing phase a request for additional information about purpose or importance from sender can be collected in interactive channels using automated interaction such as voice response etc.

Communications of the same type can be routed between physical channels of the same type, e.g. routing email to a role-based email address to the email address currently most reachable (e.g. home address after office hours). Communication can be redirected between two channels of different types, where content translation is possible (e.g. translating a telephone call to Voice-over IP, Voicemail etc.). Calls failing to reach CLIENT can be routed to other receivers such as a permanently-staffed emergency call center, a secretary, a spouse, a backup colleague etc.

Evaluation of Quality

CLIENT evaluation of COMPANY communications will be a solid indicator of SPAM. If a COMPANY's communications to customers are evaluated and determined to add little in terms of relevant information or suggestions, this information will, in itself, indicate a likelihood of SPAM, thus lowering the priority of a new communication not identifiable as responding to a CLIENT request.

Potential SPAM communications will not be rejected but instead will be routed into a special Suggestion House where marketing messages are directed. A low priority will severely limit the likelihood that a CLIENT will see this message.

A PRIVACY CARE rating will be as strong an indicator of good marketing performance as financial ratings and a strong indicator of future financial performance. A drop in rating signifies or indicates a drop in financial performance.

Special rules are allowed based on advance conditions, such as product categories, supplier categories etc. A specific embodiment of the invention includes token information used to open for third-party emailing when, for instance, a customer agent is asked to collect quotes.

Outbound Channel Intermediation

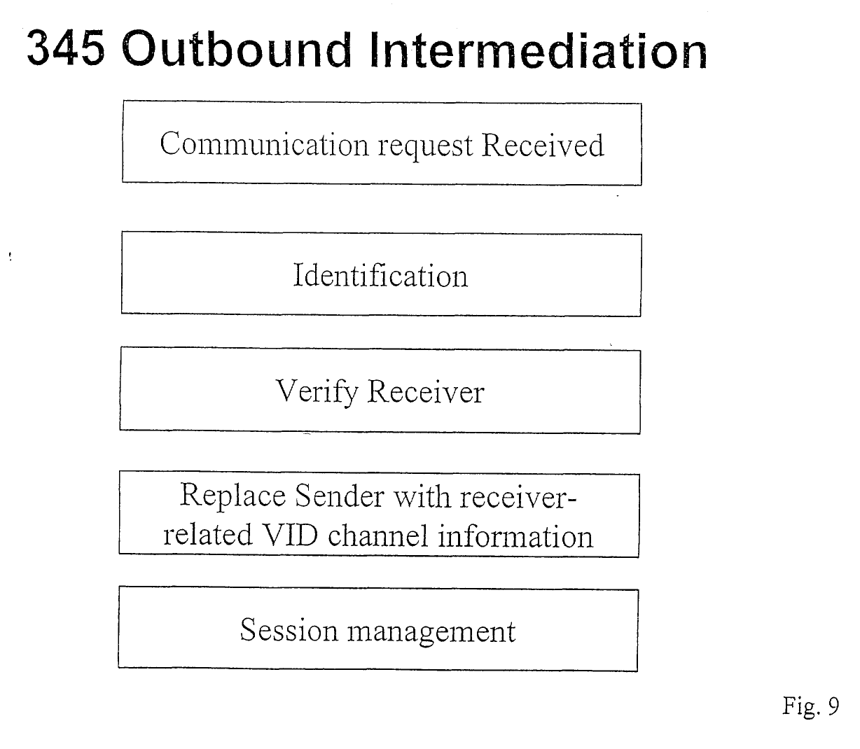

This element of outbound channel intermediation, when CLIENT contacts a COMPANY or another CLIENT, is illustrated in FIG. 9.

Establishing a Virtual outbound channel requires TP intermediation. By providing a TP intermediated communication channel, it is possible for CLIENT only to specify the receiver and channel type (indirectly indicated by choice of device—email, phone, etc.) and optionally the purpose, but not the channel or actual address. TP looks up the correct receiver address. Establishing communication includes looking up and switching to the relevant VID.

This is a general convenience concept implemented for both CLIENT-CLIENT, CLIENT-COMPANY and COMPANY-CLIENT outbound communication. The communication initiator may work with virtual channels.

Browsing

The central principle about Browsing is that no trace or registration about behavior is performed. If CLIENT so wishes, third-party anonymizers can be used when browsing.

TP will supply CLIENT-side software that can be used optionally, including services like cookie handling, browser anonymization, auto-registering, auto-login and the core one-stop sign-in with the related identity-switcher. Additionally special services are available for supporting interaction with registered sites like forms filling and profile/wish presentment.

When implementing services like identity-switcher, special attention has to be paid to the possibility of linking a different VID to one identity. The means that the VID can not be switched within one session without introducing the possibility of linking the VID being used.

A lot of issues are related to anonymous browsing with increasing number of services available. These will continuously need to be developed as browsing technology evolves.

An embodiment using current technology must include browser anonymization and IP-number protection.

Browser anonymization is required to ensure that the browser does not reveal identifiable or linkable information. IP-number protection (proxy) is required to protect against tracing of behavior and linking based on the use of IP-number and other similar traceable information.

The use of session management technologies like cookies is limited to a minimum, e.g. by making sure that a cookie can survive only during a session and deleting other cookies after browsing. When TP assisted login and logout (identity switching) from registered sites take place, all non-relevant cookies are deleted.

When leaving a registered site cookies can be transferred into the VID data archive. These cookies can optionally be restored when entering the site again.

When browsing, CLIENT can assume different VIDs depending on the CLIENT's purpose.

The anonymous VID can be supplied with information about the CLIENT's profile and wishes from the Private Data Storage controlled by CLIENT. This profile information can include an anonymous proof of credit-worthiness, a credential such as a formal educational degree, or an anonymous proof of absence of a negative credential such as a criminal record or outstanding debts. One embodiment of the invention includes an XML format collection of parameters, encrypted according to the structure of roles and VIDs and manageable by TP only on reference but not by access to contents.

When filling out forms, a CLIENT-side companion helps fill out these forms and keeps a copy of information revealed.

When entering sites where CLIENT has created one or more VIDs, auto-login and auto-Identity-Switch can be enabled by the CLIENT-side.

When entering sites where CLIENT has not registered, TP can auto-register. When auto-registering, CLIENT is asked the type of VID and optionally under which role CLIENT wishes to register. Also special requirements as to channel availability are customizable. TP then creates a new VID and registers this VID with COMPANY.

When auto-registering to a COMPANY site with a Privacy agreement with TP, registration is done straight into COMPANY customer database, with the Company customer Database ID for Client becoming the common identifier.

Communication Channels

Email

Email and similar means of communication are characterised by being asynchronous, and hence not having an active session.

Standard email anonymization is well known in several types. The standard solution is to have a third-party re-mailer to act as an anonymizer by translating between an anonymous email address and the actual user email address.

In the multi- and rolling identity scenario a new anonymization concept is created, first because email addresses become obsolete over time, and second because email-addresses are created for specific purposes. In business services, corporate customers can have the option of using an email address in the format <Corporate Customer Identifier>.<Corporate Customer Internal Customer Identifier>@<Privacy>.com.

An email address is a Token Identifier where only uniqueness and a link to a role are key requisites.

Telephone etc.

When communication involves physical information such as a fixed line telephone, delivery of water, gas etc. the general principle will be to separate the provider of the physical connection from the content provider whenever possible.

This means that TP must set up means (both inbound and outbound) that make it possible for CLIENT to use the physical line without revealing the physical identity. For inbound calls this can be done by routing from a TP operated phone number to the physical phone number. In the advanced integrated solution, a Telco Alliance Partner will translate on the fly.

Basic to the concept is that the calling party will always reach a line controlled by TP. Information can be obtained from the calling party concerning purpose, validating identity, etc. before attempts to reach the receiving party. The receiving party will have some sort of log-in validation and advance notification of caller and purpose before connection is established.

The outbound Telephone number can be <Local Privacy Number>-<Token information>or <Local Privacy Number>-<Corporate Customer Internal Customer Identifier>. In the advanced integrated solution, a Telco Alliance Partner will translate on the fly.

Please note that the difference between voice-over IP and fixed or mobile telephone is primarily technical. The message type is very interchangeable between these channels.

A mobile telephone however has the advantage over fixed-line telephones that it is not identifiable by the physical location link to an address.

Voice-over IP also has the advantage that no permanent identifiers are linked to a voice-over IP session. Using an anonymized Internet connection combined with a virtualization of the voice-over IP receiver, a strong privacy communication channel is established. The key is to ensure that none of the underlying service providers can get access to identifiable or linkable information.

Mobile

Bluetooth

IR

Mobile phones or wireless communication devices are central to control. TP hosts a WAP gateway that controls access to the mobile device.

The basic service is to acquire the device anonymously so that not even the phone company knows the identity of the owner. The additional service is to intermediate the calls through the TP according to the generic specification. Security around mobile phones is already better than for Internet sessions. With

WAP 1.2, authentication is linked to built-in Simcards/Smartcards. This authentication is intermediated using two different steps.

Two new WAP-services are controlled specifically. First is the WAP Push ability where TP will act as a gateway and filter push messages. Second is upcoming GPS—possibilities. With this the phone company can trace the physical location of a mobile device.

Payment

Payment is an independent channel that can be fully intermediated. See “Electronic Bill Presentment and Intermediation Services,” supra.

Delivery

Intermediation of delivery of physical goods is described under “Privacy Trade Platform,” supra.

Cable Set Top Boxes

An important channel to intermediate is the future interactive television integrating with the Internet and other communication services.

This would, for example, enable parents to control advertising towards children, and in general it would provide a means for controlling the increasing marketing stream that may leave the individual defenseless.

This channel will be intermediated primarily using anonymized registration so that interactive service providers have to listen in order not be blacklisted. Content itself will not be streamed through a TP, but each atomized program or advertisement will. In addition the CLIENT-side browser is anonymized with integrated links to online services for ordering etc.

Two-Way Anonymous Communication

Privacy Trade Services are available in a two-way anonymous CLIENT/CLIENT version where COMPANY is replaced by another CLIENT VID. It is thus possible to email, talk, sign etc. without knowing the identity of the opposite party.

In the CLIENT/COMPANY version, COMPANY is known to CLIENT. In the CLIENT/CLIENT version, any combination of identified and anonymous CLIENTs is possible. This is useful in a number of marketplace or problem negotiation situations where two-way anonymity is required either by the parties or by the marketplace owner.

The only real difference with respect to the CLIENT/COMPANY version is the fact that in the CLIENT/CLIENT version it is difficult—if not practically impossible—to exchange encryption keys to keep communication private to a TP. The main problem is that a CLIENT cannot know if the TP is acting as the other CLIENT,

Migration Services

Anonymous payments, such as credit cards without name and channel, are cross authenticated with a TP.

Anonymized VID Identities are in the form of CLIENT login identifiers and information.

Payments

Securing Existing Credit Card Payment Solutions

A large proportion of payments online or in shops is today done using standard magnetic credit cards without any encryption authentication mechanism. These payments are today subject to massive fraud due to stolen credit cards (customer fraud) or false payments using credit card numbers without an agreement transaction or delivery (supplier fraud).

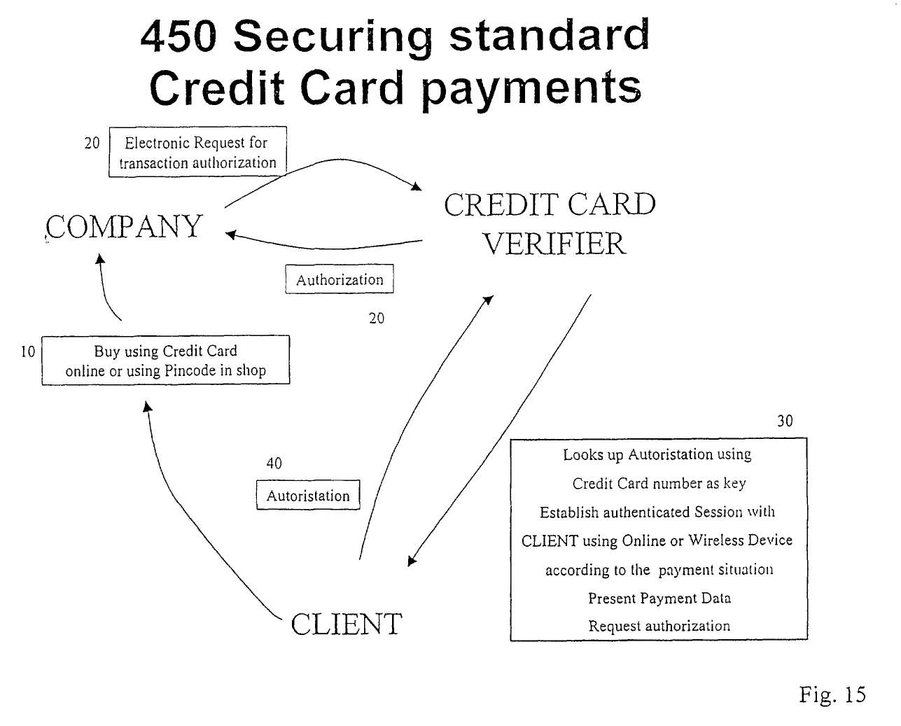

Using an online channel or a wireless device like a mobile phone to contact a credit card holder, the credit card verifier can get strong authentication in real-time before credit card payment is authorized (see FIG. 15). The present SSL and real-world shop pin-code based payment solutions can this way be cross-authenticated by a channel with higher security (FIG. 15, reference numeral 40). This authentication does not require an encryption process to increase the level of security significantly. Security is enhanced merely by adding a standard voice response service using a mobile phone as authorization channel. The significantly higher mobile phone theft protection is a product of unique identifiers, pin-codes and real-time closing of stolen phones, combined with the very basic fact that a criminal needs to have both the credit card information and the physical mobile phone.

It is important to observe that this solution can be implemented without changes in all the existing outlet payment systems (FIG. 15, reference numerals 10 and 20). Only the central credit card verifiers need to add a step in their authorization procedure where they look up credit card holder contact information and establish a real-time authorization session (FIG. 15, reference numeral 30).

Anonymizing Secure Credit Card Payments

Based on the secure credit card payment solution method, a Trusted Party can issue anonymous credit cards.

A general problem with this solution is that the anonymous credit card can be used as link information between COMPANY X and COMPANY Y. This will not identify the user unless linkage can be established to a COMPANY where Identified purchases using the same credit card have been made.

Strong Channel Authentication of Standard Credit Card

Most existing payments are done using ordinary credit cards using a pin-code or signature. Extensive and escalating fraud is a consequence of poor security for both CLIENT and SHIPPER. CLIENT is not protected against multiple drafts for the same or additional COMPANY based on credit card information acquired. SHIPPER is not sufficiently protected against abuse of stolen credit cards.

A central advantage to this approach is that this procedure does not require changes in COMPANY procedures and only requires an additional step in the credit card verifier setup to provide a significant increase in the known payment security, including credit cards already issued. Verification of telephone only purchases by credit card can be authenticated to the same level of security. In addition the credit card verifier can authenticate the COMPANY requesting information, thus increasing the protection of CLIENT against abuse.

Standard linkable credit cards can either be used offline or in online SSL trade in combination with an online Network-based payment authentication or a wireless authentication, as shown in FIG. 15. This is done in combination with credit card verifiers who will implement a table translating a credit card to a contact channel for CLIENT to be used for CLIENT payment authentication outside the reach of COMPANY, thus eliminating most credit card fraud. CLIENT will then authenticate payment with the credit card verifier outside the reach of COMPANY. The credit card verifier presents an electronic payment slip to CLIENT either directly or through a Trusted Agent. Upon authentication by CLIENT, the credit card verifier can authenticate payment towards COMPANY according to standard procedures with the credit card issuer. This procedure eliminates the need for credit card pin-codes since a stronger channel authentication is used.

The CLIENT payment verification channel will be according to the channel trade taking place. Offline in stores etc. the use of traceable wireless devices such as mobile phones with a separate authentication mechanism will significantly improve security, because fraud will require theft of both the credit card and the authentication device.

Since the credit card number is linkable across COMPANIES, a special VID for this purpose only is used with Trusted Agent authentication. By default the Token VID identifier can be the credit card number itself

This procedure is extended into an anonymous procedure. By issuing anonymous credit cards, COMPANY will not be informed of CLIENT's identity even with existing payment procedures. In addition, this is combined with a Trusted Agent intermediating payment verification so that the Trusted Agent authenticates payment towards the credit card verifier, and the credit card verifier then authenticates payment towards COMPANY.

Credit card information is linkable information, and, if conveyed to COMPANY, a breach of privacy may exist. By default the payment mechanism will include intermediation such that payment is guaranteed by a Trusted Party.

Address Book Transforming.

A new CLIENT can, after registration and identification, download a synchronization tool customized for standard personal automation tools (such as Palm Pilots, Outlook, Lotus Notes Personal Address Book etc.).

When setting this tool up there is an administration service that will create a replicable copy of the original address book and help build the TP address book of CLIENT.

Each contact will by definition be an Address Book Only type of VID.

CLIENT can reorganize his contacts according to his own roles and VIDs so that business contacts and personal contacts, family, suppliers, etc. are separated. In this process each contact will be separated into how much information each contact can access with CLIENT—wishlists, preferences, physical communication channels, etc.

When this process is over CLIENT can ask TP to contact all or some of the contacts and ask whether they will take it upon themselves to keep the address book updated. At the same time CLIENT offers to keep the personal address book updated. The individual confirmation ensures that control of access to contact information is retained by the individual. (Nobody can force a celebrity like a movie star to update contact information, but a specific fan service can be set up under the control of the celebrity, thus providing both privacy and convenience.).

Two major advantages are introduced, beyond convenience: First, one does not know or need to know contact information for one's relations. A CLIENT has his/her own relation database, and TP knows how to contact these relations. CLIENT decides the channel type (email, voice, postal mail) and sends it to TP together with the internal reference. TP takes care of delivering the message, including locating the best channel to use.

Second, the message delivery is according to the receiver's wishes. The receiver can decide the exact level of anonymity related to communication channels available and identifiable information rendered. Using TP services, the sending CLIENT can respect the receiving CLIENT by putting the receiver in control. Since CLIENT can not know the actual state of mind and the situation of the receiver, CLIENT can be violating privacy alone, by the choice of channel and the point in time CLIENT chooses to use it.

The receiving CLIENT can, through RELATIONS and GROUPS set up priorities in the Inbound communication filtering and routing to match the exact desired situation across relations, sender and receiver situations and communication channels.

Anonymizing Channel Identity

A temporary solution for privacy-enhancing communication channels is to acquire channels anonymously using support from TP. Wireless devices link mobile phones, PDAs, etc. Virtual channels like email, Internet gateway, WAP gateway, SmartCards for satellite, or wireless interactive TV.

A central issue about anonymization of channels without intermediation is the problem of linkage. Since the logical target of an anonymous non-intermediated channel is known to all COMPANIES with whom the channels have been in use, the channel identifier can act as a linkage device between COMPANIES.

Rollover will be the best way to minimize damage. It is important to rollover and anonymized channel identities to manage the rollover in such a way that no residual linkage is possible. This means that both all anonymized channels have to be rolled simultaneously, ensuring that COMPANY loses trace information.

For instance, CLIENT may have a login at a Website where he uses an anonymized Channel. Even if the anonymized channel is rolled, the basic login will establish a link between the former channel identifier and the new one. This information can be sold and linkage established, the consequence being canceling out the effect of rollover.

Personal Services

Multichannel Answering Service

For the individual CLIENT a major advantage of the TP service is the access to an answering service covering multiple (if not all) communication channels regardless of physical location, type or service provider involved.

Personal Address Book

A CLIENT's RELATIONs and members of his groups are in his address book, which can be online accessed or exported and stored in any device CLIENT uses. This can be an email address book, a mobile phone register, a wireless PDA etc. The main advantage for any CLIENT is that this address book is receiver maintained. If a CLIENT changes contact information, all other approved CLIENTs will receive automatic updates to their personal address books without any effort. A personal address book is always updated.

Even for friends, there are strong incentives for virtualization of communication channels, primarily for redirection purposes. When combining access control filtering with redirection, CLIENT can have one virtual phone number with one answering service facing towards RELATIONs, and CLIENT can have multiple physical phone numbers and alternative voice paths behind. This is an implementation of an individual permanent telephone number. Especially when moving, changing jobs etc., this is very advantageous. It can also be advantageous to start uploading the existing address book.

A specific identity will be created for each personal contact that is a member of a CLIENT's personal address book and that is not a registered TP. This is necessary for the inbound control and for notification of changes on behalf of CLIENT.

Private Data Access Control

CLIENT can set up different profiles related to roles, VIDs etc. These can be accessed either by CLIENT push (always presented or presented on request by CLIENT) or pull mechanisms (requiring specific request from receiver).

Suggestion House

The Suggestion House reverses the direct marketing/sales process to create an alternative to SPAM. Instead of CLIENTs being bombarded with sales signals, the Suggestion House is the place where sales messages are going. When—and only when—CLIENT enters this virtual Suggestion House, he is open to suggestions. Suggestions are qualified and separated clearly for CLIENT by TP, based on the source of all the available information.

Source of Suggestion (Both Company or Agent)

the relationship between CLIENT and SENDER

the SENDER's Spam history

Quality of SENDER's Suggestions

CLIENT specific Suggestion Evaluations

SENDER Suggestion Evaluation index (all CLIENTs)

CLIENT's Actual Wishes

Is the suggestion a response to a specific CLIENT request for offers ?

Is the suggestion based on access to private data?

Has the CLIENT indicated any special interest when entering Suggestion House?

CLIENT can set up his Suggestion House as he pleases. It can be divided into separate compartments (“rooms”) where different kinds of messages are directed. CLIENT is in control of inbound messages from the filtering function and from the agent access control.

By default there are a number of standard rooms related to important aspects of Individual life. These may include education, job, finance, vacation, house decoration and maintenance, children, hobby, etc. These rooms are pre-configured with access to information sources, agents to help analyze needs, product catalogues etc.

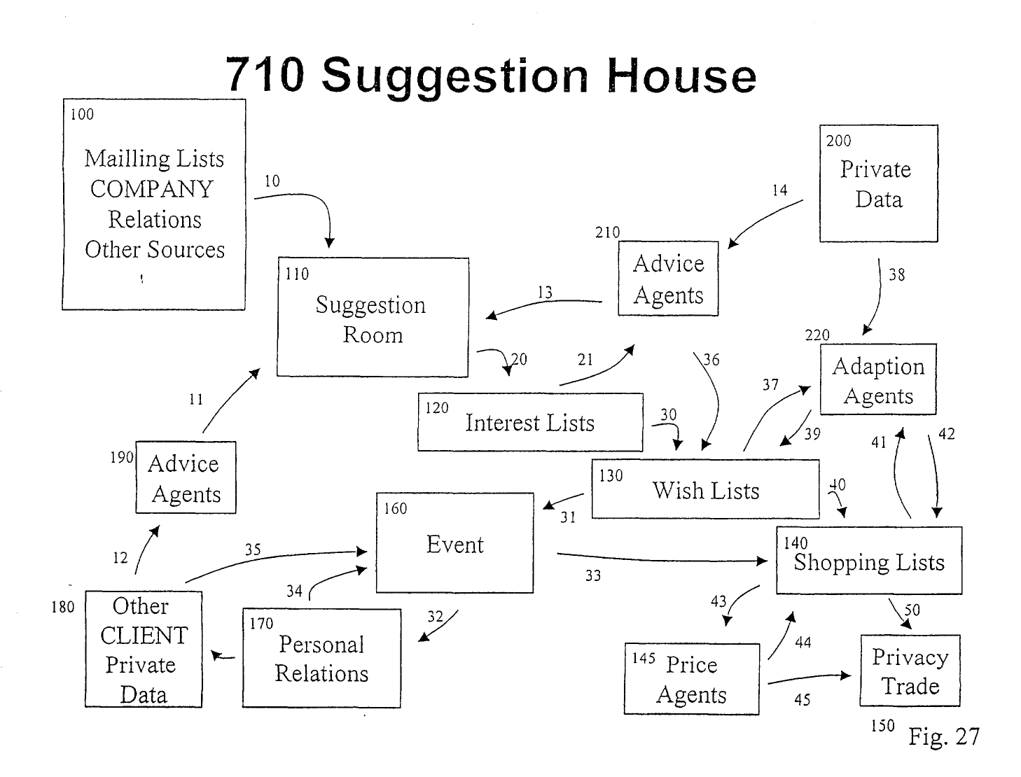

In addition there is a customizer to build the setup according to CLIENT's wishes and a Help service that is individualized so that it is sensitive to the user's technical level and preferred workings. When the help function suggests to help the CLIENT set up or refine the Suggestion House, CLIENT will, for instance, be able to respond either “Yes,” “Later,” “Tell me more,” “III take care of it myself,” and “Too Complicated.” See FIG. 27.

TP supports the privacy enabled process from suggestion to delivery. An important problem is that of containing detailed private data from identification. For a specific purchase, CLIENT gives information that is more detailed than is necessary and desired (by CLIENT) for the continued relationship. The solution to this problem involves the separation of identities.

If the suggestion originates from an existing COMPANY/CLIENT relationship, then the suggestion process is a natural continuation of the relationship and as such the purchase is made using COMPANY specific VID.

In the other end an agent given access to private data analysis and counseling is seeing one identity. The actual delivery is done under another one-time-only identity. The main purpose is to contain private data and still ensure an agent's interest in fees etc.

One key advantage is that so-called “selling agents” representing suppliers can participate on equal terms with customer agents having no supplier status. CLIENT is in control by accepting agent access to private data—optionally on a rental basis.

A suggestion does not have to be purchased to deliver value. CLIENT can add the suggested item to his wishlist (with reference to the original suggester to ensure the fee when delivered).

Promote Registered Sites to Clients

TP mediates CLIENT ratings of COMPANY to others, including new CLIENTs. TP will act as an independent party in the market place, but CLIENT ratings will have a strong impact on COMPANY success.

TP will establish a “Collaborative CRM,” meaning that evaluations of a COMPANY's practices plus the existence of signed principle documents will be used to rank COMPANIES to non-customer CLIENTs.

Especially in WAP or other small bandwidth devices, getting and maintaining a high rating will be a strong criterion of success for COMPANY, because this will increase the likelihood of a CLIENT choosing COMPANY as a supplier.

Interest Lists

Whenever CLIENT sees an interesting suggestion, CLIENT can add this to an interest list for later checking and potentially for transfer to a wishlist or a shopping list. See FIG. 27, reference numeral 110.

CLIENT looks through suggestions marking interesting ones for an interest list. The CLIENT can ask to receive advice from an advice agent accessing either CLIENT private data or by permission, getting gift suggestions for RELATIONs.

Wish List

CLIENT creates a privacy-enabled personal wishlist located in the private data storage. Access is controlled based on the personal address book. See FIG. 27, reference numeral 130. Main input will come from the Suggestion House through the interest lists where CLIENT picks up wishes as he goes (FIG. 27, reference numerals 20 and 30). Reserved wishes are copied to a shopping list (FIG. 27, reference numerals 50).

A main use of the wish lists in connection with events (FIG. 27, reference numeral 160). RELATIONs relevant for the event are invited to use the wish list as a coordination tool to get ideas, for several CLIENTs to group together for a purchase and for co-ordination of which wishes have been reserved.

For each Item a link to the origin of the suggestion and a link to another RELATION as a reservation for purchase are maintained.

CLIENT can appoint one or more RELATIONSs as a wishlist coordinator. Co-ordination of wedding gifts or parent supervising lists for children adding items are two examples of such use.

A wishlist coordinator can use agent for a privacy-enabled analysis of the private data of CLIENT to generate new ideas (FIG. 27, reference numeral 36) or get additional information about the wishlist such as sizes, color etc. from the adaption agent (FIG. 27, reference numerals 220, 37 and 39).

Dynamic Shopping Lists

A dynamic shopping list is related to a CLIENT, a Group of CLIENTs (a family or an event) and optionally an event. See FIG. 27, reference numeral 140. Each Client will have a relation with multiple shopping lists in order to separate purchases depending on purpose and timing. A point of purchase list can be combined into one operational list. A shopping list can be forwarded to a price agent (FIG. 27, reference numeral 20) for getting quotes and suggestions. A shopping list or single items can be forwarded to COMPANY for purchase according to the full privacy trade service (FIG. 27, reference numeral 50). Using a mobile device, shopping lists are available across different shops.

Event Management

Based on personal address books and wishlists, a special event management service is created. The arranging CLIENT creates an event and creates links to all participants. See FIG. 27.

Now very advanced personal services can be created:

a) Invitations, news co-ordination, participation confirmation etc., are easily distributed and controlled. This can be directly linked with CLIENT calendars across different calendar formats since TP can act as format converter.

b) The arranger CLIENT can have access to personal likes and dislikes of each participant without having to keep updated files or calling everyone. This ranges from being a vegetarian for meal selection to seating assistance based on jobs, interests and even prior events. Meal selection services are linked to recipe libraries and can feed into dynamic shopping lists that can be accessed at point of sales in shops etc.

c) The arranging CLIENT can, for each relation, maintain personal knowledge of a participating CLIENT regarding likes/dislikes, ideas, etc.

d) Participants can coordinate gift purchases based on the personal wishlist. Gift decision discussions, money collection, transfer of ownership of gifts, and warranties may be serviced by TP. A special wishlist coordinator can be appointed through the RELATION link (see FIG. 2, reference numeral 100),

e) Event dynamic shopping lists support group shopping. If each shopper has access to the same list through, for instance, a mobile wireless device, he or she can mark items in real-time and across different shops. Using one of the well-known mobile devices with built-in bar code readers will greatly enhance this service.

Agent Services

Private Data Analysis

As FIG. 27 shows, in some situations customers want to make some private data available for analysis in order to get relevant customized suggestions. This can include finance, house, style, clothes, literature, hobbies etc.

CLIENT will create a virtual identity towards each agent in order to control access to data.

CLIENT selection of agents is based on their price requirements and history. TP will ensure that each agent receives the agent's fee when a purchase is made (using TP services) and will maintain an individual and all over CLIENT evaluation of agent services.

CLIENTs will, over time, build loyalty with specific agents that are used repeatedly because of quality of suggestions.

Customer Profile Rent

Agent access to private data can be subject to fee payments from agent to CLIENT.

New agents not known to CLIENTs can rent access to private data with CLIENT's approval. CLIENT can show some basic profile, and TP can verify the purchase level for agents to bid.

CLIENT can be paid on the basis of time and profile access value. CLIENT can refuse to rent private date access, while the agent can terminate the arrangement by ceasing to pay the rent.

Reverse Marketing—Agent Marketing

Multiple Agents can be involved. See FIG. 27.

CLIENT may decide to build relations with one advice agent (FIG. 27, reference numeral 210) specializing in suggestions based on private data. Advice agents are separated in rooms in the Suggestion House according to specialization. Only agents adhering to the privacy principles will be allowed to register for access to CLIENT data.

Another price agent (FIG. 27, reference numeral 145) is then used to track the best offer for a specific suggestion. This agent only knows which Item to get bids for.

Finally, a third type of agent is the adaptation agent (FIG. 27, reference numeral 220) which is used for discussing customization of the item to purchase with the suppler.

Each agent is important to separate issues and data access.

Community Services

This invention implements an extensive list of online and off-line community services.

Basic Trade Services

The full list of privacy trade services is available for interaction between the community and CLIENT. This includes the use of purchases down the value-chain for anonymous CLIENT VIDs.

One-Time Only ID for Identified Community Trade

Communities may build on close relationships and therefore can involve semi- or fully-identified VIDs. To protect CLIENT privacy and community customer contact, a one-time-only VID combined with an intermediation service is implemented for transactions and interactions involving partners in the community.

The VID has to be one-time-only if CLIENT is identified by the community because of risks of linking CLIENT's identity to the VID related to the partner.

The one-time-only VIDs are generated on the fly and are normally prepared for safe trade involving anonymous same-time payment and delivery intermediation. Communication channels such as email, telephone or chat with supplier can be available depending on the wishes of the community. Guarantees or other post-transaction services may likewise be provided.

One-time-only VIDs will require setup of encryption keys between TP and the supplier to handle delivery address exchange and intermediation and payment agreements. These keys do not have to be one-time-only as they are specific for the supplier and do not contain, nor are they used to protect, identifying information about CLIENT.

This service will be able to take care of all aspects of the trade including a final transfer of a fee to the community account. This fee is an agreement between the community and the supplier for the community to setup a sales channel for the supplier.

TP can offer a service where suppliers registered with TP can be offered to the community or even managed by TP.

Anonymization of CLIENTs will open for much easier trade relations where communities can concentrate on their core business without the risk of suppliers starting to contact CLIENTs without paying the fees to the community. CLIENT does not necessarily need to know the supplier, further protecting the interests of the community.

Auction Service

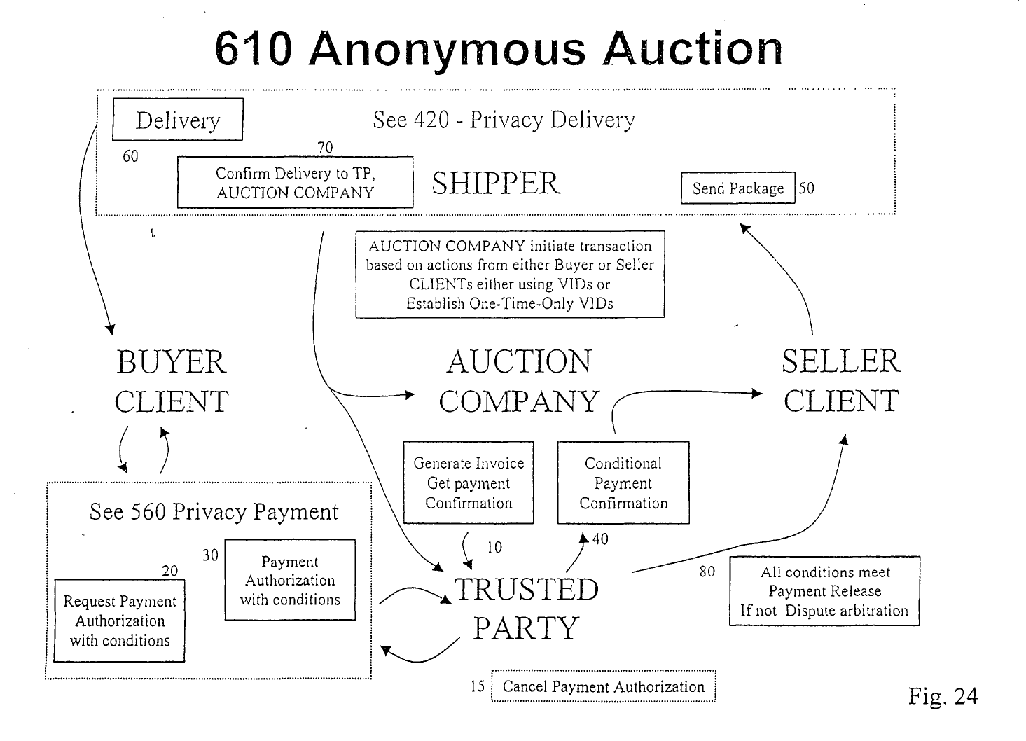

As FIG. 24 shows, a generic privacy auction service for online communities, portals, societies etc., combines delivery control, payment, communication intermediation, two-way anonymous signature and Trusted Party Service.

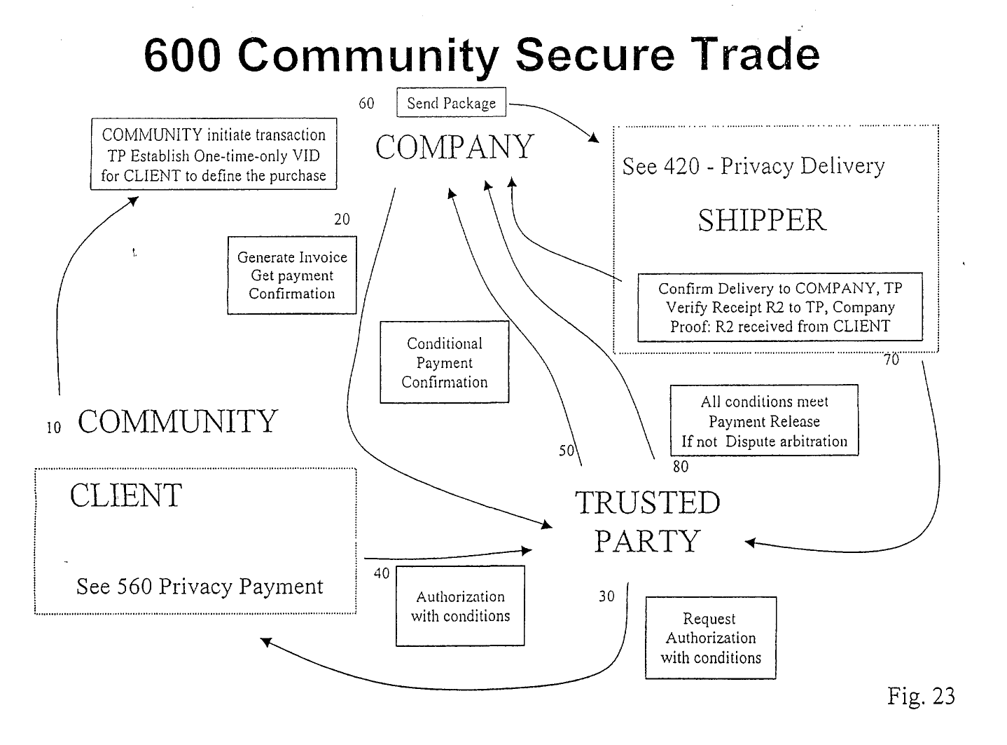

It is based on the same principles as the community secure trade (FIG. 23), but in addition to this is added the complexity of a two-way anonymous process.

In addition to this, the auction community can set up the rules for interactions between Buyer and Seller that are available according to the trade process. Also, the auction community can set up a default agreement that both buyer and seller have to accept anonymously in order to continue the trade process.

Transaction initiation will be dependant on the auction model. CLIENTs can be previously unknown to TP, for which TP will need to create one-time-only VIDs to establish privacy. Both buyer and seller can previously have registered with TP and already be using a VID for the specific community. Depending on the type of service, the VIDs can be identified or non-identified according to the wishes of CLIENT. Neither the seller nor the buyer ever needs to know each other's identity. TP can, in this set-up, be the only party knowing the identities of the players, thus adding trust to the auction community.

The communication channels that are open can be customized by the auction service. At one extreme is a fully open market place only focussing on matching supply and demand for anything. At the other extreme the actual trade is fully intermediated without free communication between CLIENTs. In the case of full Intermediation only specified messages can be transferred between CLIENTs without the CLIENTs being able to communicate.

With privacy payment, two-way privacy signature and privacy delivery, an auction trade can take place without either of the two CLIENTs ever revealing his/her identity to the other or to the auction site. This is true because the auction site requires this as part of its business (for instance a job matching service), or because either CLIENT wants it that way due to the nature of the item in question (tipping the police, etc.).

Central is the advantage that the auction site itself does not necessarily know either CLIENT but only acts as the branded market place getting a commission on deals. CLIENT is in control.

TP acts as the Trusted Party in the deal on behalf of the auction site.

In the communication phase, TP privacy communication services can be used to negotiate anonymously and to use the privacy agreement to create a formal agreement. For most auctions, the agreement will be in the form of an invoice (FIG. 24, reference numeral 10).

Buyer CLIENT then deposits payment, and TP confirms this to the seller and the auction company (FIG. 24, reference numerals 10 to 40). In some auction models, a buyer CLIENT will have to deposit payment with TP when bidding. This deposit can be cancelled or returned to buyer CLIENT by the auction company if, for instance, another buyer has a higher bid (FIG. 24, reference numeral 15).

Seller then ships the goods or delivers electronically using privacy delivery (FIG. 24 reference numerals 50 and 60). When Shipper proves delivery, the right to the payment transfers to a deposit in Seller's name (FIG. 24, reference numeral 70). Depending on the type of service, buyer has a right to verify the goods delivered before payment is released. This can either be upon delivery or within a fixed time period after delivery unless buyer objects due to problems (passive acceptance) or on specific acceptance from Buyer within a certain timeframes (active acceptance) (FIG. 24, reference numeral 80).

In case of disagreement, TP can enable dispute arbitration—a third identified party to act as an independent arbitrator. If this does not solve the problems, then legal proceedings can start. This can be totally anonymous, but at any point CLIENTs themselves can decide to reveal their identities or ask TP to reveal them simultaneously.

The fee for the auction site and for TP can be added to the payment from buyer or deducted from the payment forwarded to seller. Additionally there is an optional fee deposit from seller upon registration of the item in question at the auction site. This fee can be released to the auction company simultaneously with the release of payment to seller.

Membership and COMMUNITY Services

The community can outsource most basic community functionality to TP. This may be especially advantageous for the heavy membership management part, including membership payments (recurring payments), security (identification and authentication), and information management, which may be simple add-ons to the basic TP services.

As an example, the community may receive a list of one-time-only membership tokens. Whenever a new member to the community through any means has been approved to become a member, the CLIENT can supply the membership token. When CLIENT has been accepted for membership, an automatic registration as a member of the community is initiated, together with membership fee payments added to the list of recurring payments after confirmation by CLIENT. The community's costs of setup and management of communication channels and of membership payment collection are significantly reduced.

Since TP is taking care of identification and authentication procedures, the community IT complexity is greatly reduced because they can use a limited strong authentication access channel directly with TP instead of a more exposed weak authentication, such as only recurring simple passwords etc. Since TP already has an authentication service in place, the full TP services are available to community members.

Business Services

This invention opens up for a new type of long-term anonymous customer relationships where customers are in control. If COMPANY makes active use of this, it are likely to get better customer relationships because it can now focus on servicing customers the best way with customers being much less afraid that COMPANY can abuse information.

In addition to this a new form of very advanced services is made available to COMPANY. Due to history and legacy, many companies have big problems coordinating a single view of a customer across all interactions. But since all interactions for TP CLIENTs pass through a single filter outside the COMPANY legacy systems, a full history of interactions can be made available for the mutual benefit of both COMPANY and CLIENT. A central issue is still that TP only knows that interactions have taken place in a certain channel at a certain time, but COMPANY and CLIENT can encrypt the communication so that TP does not know its contents.

Also since all trade and payment transactions go through the same filter, COMPANY and CLIENT administration can be outsourced to TP or a TP partner as an integrated part of the relationship.

Customer Relationship Management Services

Security and Authentication

Because TP works with strong identification and authentication procedures, COMPANY can outsource these procedures to TP at considerable cost savings as compared to how they can do it on their own accord.

More importantly, since COMPANY cannot do the identification itself anonymously, it needs a trusted party to establish a secure identification and authentication path when dealing with anonymous virtual identities.

Using a combination of identified and anonymous virtual identities, TP can offer to handle the identification and authentication of the full COMPANY customer portfolio.

Privacy Loyalty Relationship Management

When handling realworld anonymous shopping, normal cash unidentified payments are the simple solution. However this solution does not support development of relationships and customized services.

This procedure enables anonymous linkage with a COMPANY Customer Account for realworld in-shop trade focussing on supporting high-value customer loyalty programs. While CLIENTs achieve privacy protection and total control, both COMPANY and CLIENT gain from the higher value delivery in the virtual relationship. CLIENTs will have a much lower threshold to give detailed private data when they know that they are in control and can pull out again.

An even bigger advantage is available for COMPANIES under legislative restrictions for analyzing customer data. Because formerly sensitive data are now anonymized, they gain access to analyze customer transaction data and use this to create customers' services and suggestions. With national differences these industries can be found in financial business, insurance, retail etc.

The problem of identifying the correct virtual CLIENT account with COMPANY can be solved in many ways. CLIENT must identify himself towards TP through COMPANY communication channels with the COMPANY receiving nothing but the VID and the necessary payment confirmation. It is critical that no identifiable information or data that can be used for cross-COMPANY linkage can be exchanged. Even an encrypted string that does not change can work as a linkage agent and violate privacy.

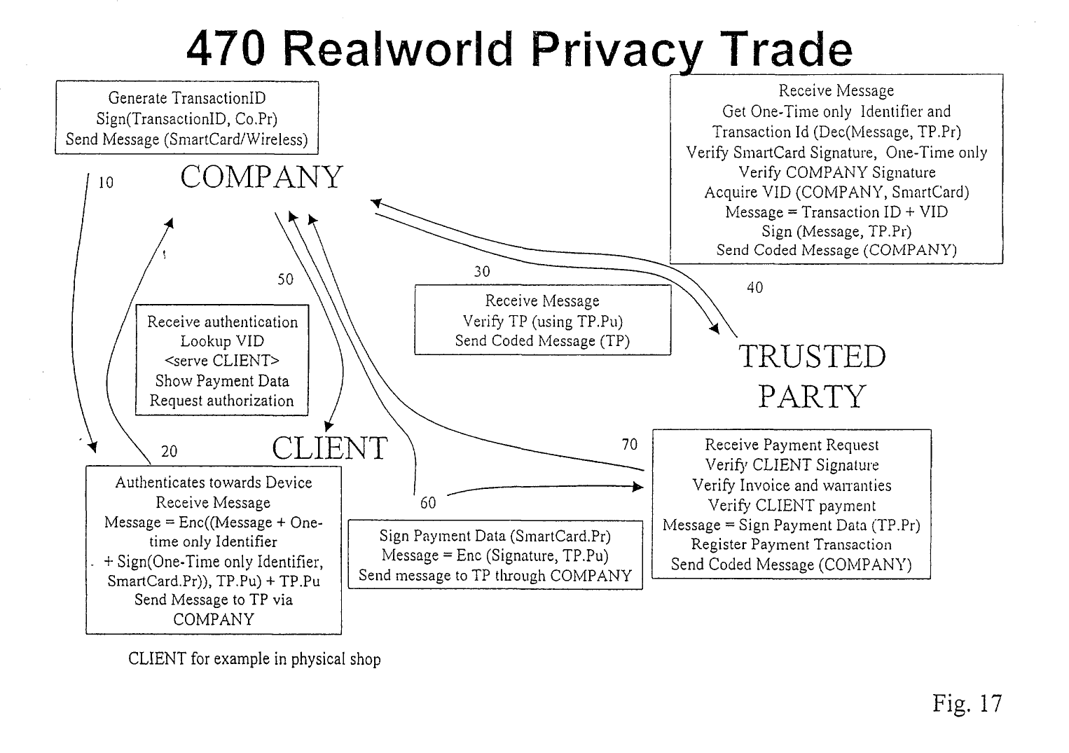

A general embodiment works as described in FIG. 17. Reference numerals 10 to 50 in FIG. 17 involve the identification part for COMPANY to offer customized service. Reference numerals 60 to 80 in FIG. 17 cover the purchase verification and payment procedure.

When CLIENT enters the store, COMPANY (FIG. 17 reference numeral 10) generates a transaction ID and signs this with the COMPANY private key.

This message is transferred to a TP-issued SmartCard capable of doing cryptographic calculations using standard mechanisms like a SmartCard reader or a wireless communications device such as a WAP mobile phone, or a device able to communicate infrared or other standards (like Bluetooth) (FIG. 17, reference numeral 20). CLIENT signs the message with a Token Client Identifier (an identifier of the Specific SmartCard), and encrypts the message using a random symmetric sessionkey. This message together with the sessionkey encrypted with TP.Pu is then transferred back to COMPANY.

COMPANY can use the TP Public Key TP.Pu to locate TP using a standard X.509 library and send the message over a communications network such as the Internet to TP (FIG. 17 reference numeral 30). TP receives the message and decrypts the encrypted sessionkey with TP.Pr (FIG. 17, reference numeral 40). TP extracts the symmetric sessionkey and decrypts the message to get the Transaction ID, the Company signature and the Token CLIENT Identifier. TP verifies COMPANY and identifies CLIENT using the Token CLIENT Identifier. TP then acquires the VID (or generates a new one if none is valid) related to (Company, CLIENT). The Pair VID, TransactionKey is sent as a coded message to COMPANY, and virtual identification link is established.

CLIENT locates the desired goods or services. COMPANY can look up the VID and offer customized service accordingly. When CLIENT is ready to check out, CLIENT can use the SmartCard to link to the Transaction ID (FIG. 17, reference numeral 50). The procedure (reference numerals 10 to 50) can be done at checkout, but then COMPANY has no information to customize service.

When the electronic invoice and related warranties are ready, CLIENT receives them in his SmartCard payment request. CLIENT signs the payment data part and encrypts the signature with TP.Pu (FIG. 17, reference numeral 60). COMPANY sends the electronic invoice together with the encrypted payment authorization to TP (FIG. 17, reference numeral 70). TP (FIG. 17, reference numeral 80) decrypts the payment authorization and verifies that the electronic invoice contains the related warranties. TP replies with a payment transaction code. Payment is carried out according to agreements between TP/CLIENT and TP/COMPANY respectively.

Secured Privacy Spaces

Because TP incorporates both accountability and privacy, dedicated secured spaces can be setup where TP provides the gatekeeper access based on credentials. This can for instance be an online playground for children where only identified children can enter with parental consent. Here the child can be presented to a learning program that is both secured from unidentified access by for instance pedophiles, customized to the child's age and special needs, under parental control and privacy-enabled.

Secured Spaces can be used for a multiplicity of purposes, setting up access criteria based any credential.

Multiple COMPANY Loyalty Programs

Partner—based loyalty programs with multiple companies involved are increasingly used to build loyalty toward a broader range of products. This is a direct threat to privacy, because these programs are based on cross-company linkability and the collection of profile information. Major incentives can be involved to get CLIENT to accept participating in such a program.

In order to facilitate such solutions without violating privacy, TP is offering a service where multiple COMPANIES can add loyalty points to a joint program. This is handled internally with TP on behalf of participating COMPANIES using an additional CLIENT bonus account.

Maintaining Customer Data/Profile Information

The corporate customer Internal identifier is a token information that is used in the corporate customer databases, and that serves as the unique anonymous identification for customers.

When requesting CLIENT attributes not allowed for this COMPANY, one sets up a list of ATTRIBUTES:

| | | |
|---|---|---|
| Attribute | Already stored at | Action |
| Age | Profile | Allow/Deny? |
| Haircolour | Not stored | Deny, Answer for this COMPANY only?, |

Answer and encrypt for
Identity/Profile/Base Privacy
Storage?

Anonymous Questionnaires/Votes Access Control

For less sensitive questionnaires etc., TP can offer a simple anonymization service. COMPANY provides TP with a list of VIDs that should participate in the survey and sends a message to CLIENTs through TP. TP sets up a one-time-only authorization scheme which each CLIENT can use only once to access a questionnaire form located outside TP control with either COMPANY or a questionnaire analysis outsourcing service.

TP guarantees that each CLIENT has accessed the questionnaire only once but does not have access to information rendered. TP can ask CLIENTs that have not answered the questionnaire to answer it.

Customs, VAT and Other Reporting

Handling of customs and VAT payment issues across borders depends on the countries of both buyer and seller. TP intermediation is necessary in order to calculate these values.

Public reporting is a service that TP does on-the-fly as part of the privacy payment service. All necessary information is available in electronic format.

All sorts of statistical reporting regarding trade and exports can be done on behalf of COMPANY since TP has most of the information. If CLIENT is acting on behalf of a Company Role, this service is also relevant to the buyer side for import reporting etc.

If all Company or CLIENT (in a Company role) trade is done through or reported to TP, then TP can offer a full-service public reporting, thus significantly lowering barriers to new startups or just outsourcing administration.

Total Business Service

TP can act as the central core in a total business service. Since privacy requires TP to intermediate all processes between a CLIENT and a COMPANY, this intermediation can include a total service concept related to the subset of COMPANY customers which are TP CLIENTs.

Since a CLIENT can choose to be identified towards COMPANY and authentication of these customers can take place at the TP module installed at the COMPANY side, this service can cover the full range of customers making TP a one-stop service.

Companies consist of Individuals with different roles. As such a COMPANY is just another virtual group of CLIENT roles, all customer, partner and supplier relationships are different virtual groups entangled in the COMPANY group.

When employees register as CLIENTs, the basics of a full workforce automation solution are possible. First, there is basic office automation intra-company and across company partnership boundaries using personal and work group automation service. This include communication, trade, project planning and support etc.

In collaboration with providers of eCommerce, trade servers implementing OBI or other commercial trade standards, a total eCommerce infrastructure including security and B2B and B2C integration can be offered.

In collaboration with CRM system providers a total CRM handling package can be offered.

When adding collaboration ERP vendors a full administrative package is available.

In collaboration with shippers outsourced supply chain management can be achieved.

Product Catalogue Presentment

COMPANY products can be made available for agent services as part of the trade server integration, thus facilitating availability in the marketplaces.

Government Services

Government services have a general tendency to increase in scope and depth of services and information required in the name of public good. The cost is a significant threat to privacy for the individual.

Just as for commercial relations this invention makes it possible to get the best of best worlds—both privacy and detailed service. The major requirement is that government and public services acknowledge that privacy is a basic right even from public services.

The general principles of identity atomization, non-linkability, and individual knowledge control apply just as well for most public services as they do for private services. For some even more.

Some special public services require strong identification, such as criminal records and health care.

But anonymous proof of credentials or proof of non-existence of negative credentials such as criminal records is sufficient in most cases.

For many uses anonymous interactions are even to be preferred. Voting and building DNA registers for criminal and disease purposes are strong examples.

Reporting and VAT/Customs Collection

When TP is intermediating trade processes sheltering CLIENT identity from COMPANY, problems related with public reporting requirements are introduced. TP introduces, depending on national requirements, public reporting and tax payment services related to the trade processes.

Key to this reporting is to bundle payments among multiple CLIENTs and potentially multiple COMPANIES. The main requirement is access to control verification of reported totals.

Voting

An anonymizing service like TP will open up for new types of digital voting services. A central condition is that TP cannot tamper with voting procedures. That CLIENT remains anonymous and sure that no one can link his/her vote with his/her identity even when TP acts in combination with a governmental operation.

Using non-traceable one-time-only certificates, a CLIENT can collect a vote token only once and get anonymous access to the voting booth delivering this token. The principle is based on division of control functions. TP ensures that each CLIENT votes only once by authenticating anonymously and zero-knowledge toward a Public Token control service. Using this Token, CLIENT can go to the voting booth outside TP control and provide the one-time-only certificate and give both physical and virtual votes. TP can supply government with a list of CLIENTs that have voted, and the list can be verified against the total number of votes. TP can prove that each of these CLIENTs has voted by having them sign a statement confirming that they have voted.

Sensitive Questions—HIV Etc

Anonymization services are very useful in the public context for services concerning sensitive questions that are related to fear, disgrace, and shame. These can be sexually-related questions, the reporting of criminal incidents anonymously etc.

Please note that CLIENT is free to use alternative informational-theoretical anonymizers for these purposes.

Anonymization of Public information Collection

DNA Register

There are regularly strong debates on the subject of collecting information on individuals for proactive crime protection, disease control etc. This is naturally a heavy invasion of privacy and as such unacceptable due to obvious abuse possibilities.

When this cannot be avoided, the last resort solution is to anonymize the identity behind a DNA profile so that only the ones who can be proven to be in connection with a crime will be identified.

In principle this is simple. A DNA sample is numbered and linked with an anonymous identification. This can be done using the same functionality as for real world loyalty programs. The government function creates a sample identifier and asks to get this sample linked to the CLIENT. CLIENT authenticates zero-knowledge toward TP, and TP confirms with a signed statement that traceable identification is created.

The combination of the sample number and a special VID is stored with TP. The unidentified numbered sample is stored and can be used for analysis purposes.

When a crime is committed, evidence on the crime scene can be matched against the anonymous DNA samples. The procedure when a match is established can involve anonymous legal presentation before identity is revealed.

Scientists can get access to analyze DNA without being able to trace the DNA back to the originator behind the DNA. Special rules can be set up regarding release of identity under different circumstances.

Car Registrations

Since a car number plate is linkable information in a world respecting privacy, the car registration should be anonymous but traceable in the same way. Simple offenses like parking tickets etc. do not necessarily lead to identification but fines can be paid anonymously.

In order to provide repeat offense control, some sort of linkability among cars can be established without violating privacy.

Separation of Public Authorities

Governmental services are expanding in reach to a point where government can build a total profile of all citizens. This situation worries many people. One alternative that this invention can supply is to disintegrate individual registrations into multiple non-linkable identities. This way one public employee only has limited access to information about the individual.

In cases where public authorities need information across offices, this can, in many cases, be handled through anonymous attribute certificates.

System for Establishing a Privacy Communication Path

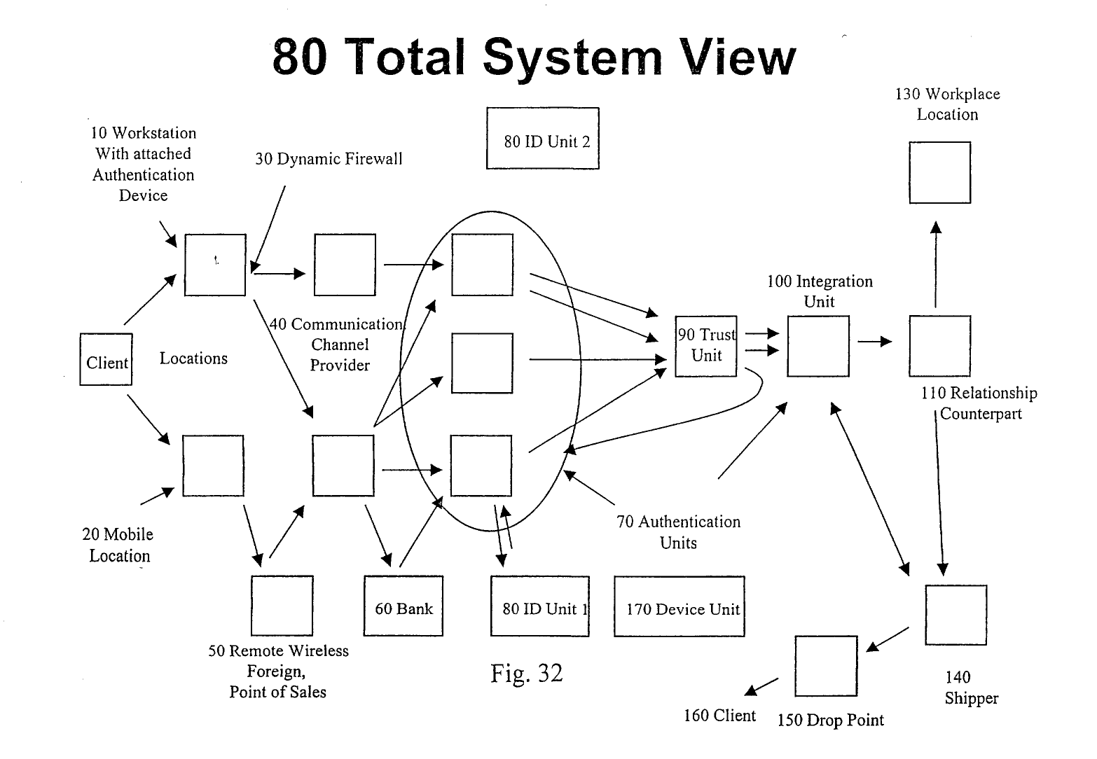

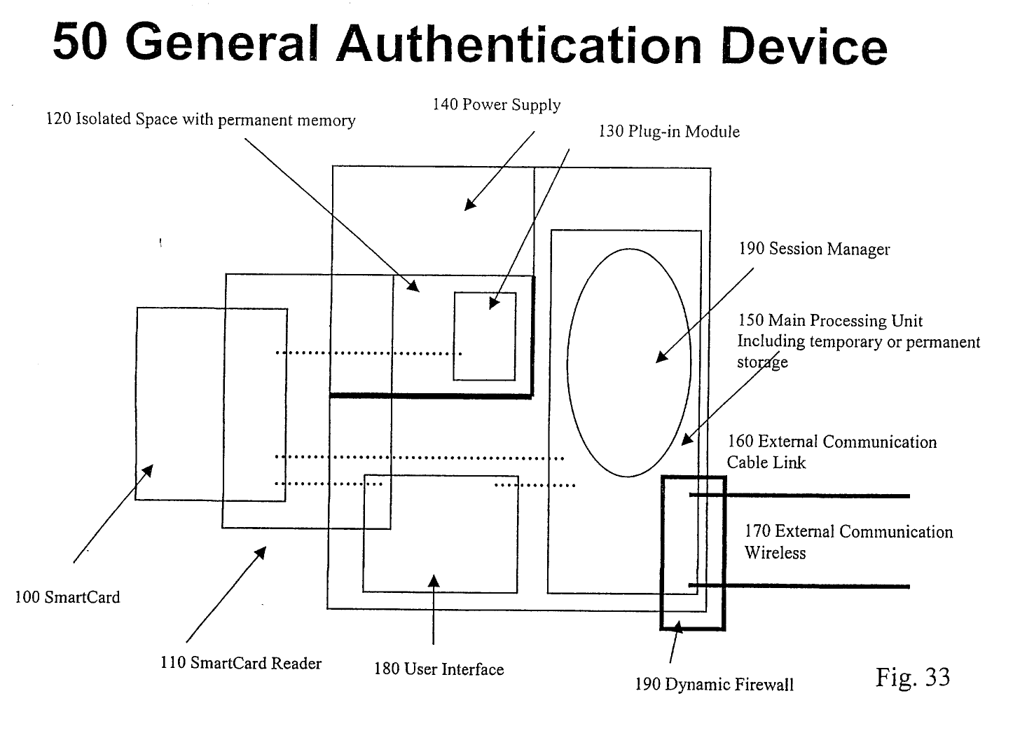

The system according to the preferred embodiment of the present invention for establishing a privacy communication path is shown in FIG. 32 and is designated in its entirety by reference numeral 80. The system comprises one of the more general authentication devices (shown in FIG. 33) to provide the CLIENT with control over private keys located in a SmartCard (shown in FIG. 33 as reference numeral 100) and the ability to do zero-knowledge authentication. Further, the system comprises one or more communication channel providers (shown in FIG. 32 as reference numerals 40, 50, 60, and 140) to establish privacy communication channels or a virtual identifier intermediating a physical communication channel as a privacy communication channel toward one or more authentication units (FIG. 32, reference numeral 70) acting as an intermediary to provide CLIENT with the ability to set up a rule-based communication routing scheme across communication channels and multiple virtual identities, each with a set of virtual communication channels, and the ability to sign legally binding agreements and authenticate toward any third-party based on a single sign-on identity.

The single sign-on identity is provided by one or more ID Units (FIG. 32, reference numeral 80) issuing SmartCards (FIG. 33, reference numeral 100) for the general authentication device (FIG. 33, reference numeral 80) and storing identifiable information according to Basic Accountability Principles.

The system according to the preferred embodiment of the present invention further comprises one or more device authentication units (FIG. 32, reference numeral 170) with the ability to provide a certificate to a general authentication device (FIG. 33, reference numeral 50) to authenticate online or offline toward any device and verify said certificates to protect against theft or fraud. Furthermore, the system comprises one or more Trust Units (FIG. 32, reference numeral 90) intermediating two or more Virtual Identities of different CLIENTs or Companies into relationships, providing storage, profile information encrypted under the control of CLIENT or Company, access to relationship information, relationship services, and protecting Authentication Units from knowledge related to virtual identities.

And finally, the system according to the preferred embodiment of the present invention comprises one or more Integration Units (FIG. 32, reference numeral 100) to provide companies with a single interface to Company Relationships with CLIENTs or other Companies

The system provides CLIENT with full privacy control of CLIENT's identity and information related to CLIENT, only subject to Basic Accountability Principles.

A CLIENT can chose a minimum set-up where no Units even in collaboration can violate CLIENT privacy, except for the Basic Accountability Principles. A CLIENT can chose a maximum convenience set-up in which both identified and non-identified relationships can be incorporated together with all relevant communication channels to provide CLIENT with full control of communication and relationships with minimum, but not zero, linkability.

According to the preferred embodiment of the present invention, both an Authenticating Unit and a Trust Unit are built around an IP-Proxy combined with IP-Mapping routers. Each communication channel is based on a separate mapping unit, such as an email gateway mapping email addresses to ensure that no linkable identifiers are present.

Basic Accountability Principles

The critical step concerning accountability is when the status of a CLIENT is changed from non-identified to identified.

Minimum accountability is achieved by ensuring isolation of identity and related information under CLIENT control combined with an unbroken, provable route to identification stored at an ID Unit requiring at minimum an algorithmic operation by a public institution according to law and a subsequent algorithmic operation by an agent of CLIENT.

The ID Unit has no knowledge as to the activities of CLIENT except for holding a number of multiple encrypted pieces of identifying information using different asymmetric encryption keys of which at least one is a public key of an encryption pair related to either an appropriate legal Institution such as a court or the individual.

The encrypted pieces of identifying information should in addition to an external encryption key be previously encrypted by at least one encryption key related to an agent of CLIENT to verify that individual fundamental rights are not violated.

CLIENT can thus perform a traceable voluntary identification, whereas an involuntary identification will require a proper legal procedure protecting individual rights.

This procedure of an Agent of CLIENT is to ensure a last privacy defense in a worst-case scenario, where, for instance, control of courts is not under democratic control and transferring out of physical reach or preferably actual deletion of identifiable information cannot be carried out prior to a worst case scenario taking place.

Basic Key Structure

According to the preferred embodiment, CLIENT generates an ID key pair and provides the ID Unit with proof of identity, for instance by signing the public key (Id.Pu) using a digital signature key (Cl.DS.Pr).

CLIENT then generates an asymmetric key pair for each Authentication Unit and forwards the public key Cl.Pu to the ID Unit together with a message linking the public key of each key pair with the ID key pair.

According to the preferred embodiment of the present invention the SmartCard shown in FIG. 33 (designated by reference numeral 100) is accessed through the General Authentication Unit where the private key part of any identity-related to CLIENT is accessed.

CLIENT can create a new Virtual Identity in any of the Authentication Units and use this to create a new relationship through the Trust Unit. CLIENT signs a link between the public key of a virtual identity with the key specific to the Authentication Unit (Cl.Pr) to ensure the unbroken traceability link back to the identifying information in the ID Unit.

CLIENT receives a verified proof of ownership from the Authentication Unit (Sign({Cl.Vir.Pu,Cl.Pu},Au.Pr) in order to be able to prove ownership to a third party.

According to the preferred embodiment of the present invention a Virtual Identity as presented by an Authentication Unit to a Trust Unit can comprise a set of signing, authentication and encryption keys (Cl.Vir.DS.Pu, Cl.Vir.Auth.Pu, Cl.Vir.Enc.Pu). The private part of the signature and authentication keys (Cl.Vir.DS.Pr and Cl.Vir.Auth.Pr) are only known to the Authentication Unit, whereas the private part of the encryption key (Cl.Vir.Enc.Pr) is known only by CLIENT through the General Authentication Device.

The encryption key known only by CLIENT provides the core protection from a Man-In-The-Middle attack in a two-way anonymous relationship. CLIENT can always have any third part verify that the correct public key is made available to the relationship party at the point of relationship initialization.

This principle implements a no-man's land between an Authentication Unit and a Trust Unit. The Authentication Unit protects the Trust Unit from information linking a relationship to the CLIENT part, meaning that the Trust Unit knows CLIENT as a number of non-linkable relationships not differentiable from relationships related to other CLIENTs. The Trust Unit prevents the Authentication Unit from knowledge about the relationship contents.

According to an alternative embodiment of the present invention, private keys (not the private SmartCard Key) can be transferred between Smart Cards and stored safely in a backup location, provided they are encrypted with a public key decryptable by a private key accessible through the SmartCard. No private key is in clear text outside the SmartCard.

A General Authentication Device (shown in FIG. 33 as Reference Numeral 50)

According to a preferred embodiment of the present invention, a privacy communication path is constructed around a General Authentication Device (shown in FIG. 33) incorporating a user interface (shown in FIG. 33 as reference numeral 180) and operable to communicate through a reader (shown in FIG. 33 as reference numeral 110) for a tamper-proof SmartCard (shown in FIG. 33 as reference numeral 100) able to communicate with the device and as a minimum store a set of data elements and perform standard operations and cryptographic algorithms such as to generate keys, random numbers, and zero-knowledge authentication.

According to a preferred embodiment, the General Authentication Device is characterized such that any persistent identifiers are physically separated from any external communication channel and only accessible under control by the SmartCard. Such a device can be achieved by incorporating an isolated area (shown in FIG. 33 as reference numerals 120 and 130) able to store persistent identifiers and optionally the ability to perform cryptographic algorithms.

Such a device can for instance be in the form of a PDA, mobile phone, satellite set-top box, a workstation, a combination such as of a mobile unit and a workstation, a lap-top computer or other device able to establish wireless (shown in FIG. 33 as reference numeral 170) or cable based communication channels (shown in FIG. 33 as reference numeral 160).

According to the preferred embodiment of the present invention, the General Authentication Device is able to establish a communication path through a Communication Channel Provider to an Authentication Unit and perform a Zero-Knowledge Authentication procedure with the Authentication Unit. The Authentication Unit subsequently authenticates the communication path toward the Communications Channel Provider without providing any persistent device with CLIENT identifiers.

According to the preferred embodiment of the present invention, the Authenticating Unit can require the General Authenticating Unit to authenticate zero-knowledge toward an ID Unit to check for revocation of the SmartCard or other fraud protection.

The Communication path can be based on a large variety of network protocols such as Wireless in the form of Bluetooth, Infared, GSM, WAP, GPRS, Wireless IP and direct cable-based over ADSL, ISDN, serial cable links etc. Any protocol able to carry IP-traffic is well suited for such solution.

According to the preferred embodiment of the present invention, in network protocols incorporating an identifier but not technically dependant on the identifier to be a persistent identifier, the General Authentication Device is provided with means to generate or access random or other non-persistent devices or CLIENT identifiers. This, for instance is the case in the most used network protocol where an IP-address can be dynamically assigned to a session using a DHCP. The non-optional MAC address is not from a technical viewpoint required to be globally unique except within the local surroundings of the network. The MAC address can be randomly generated or provided in any session from the Authenticating Unit for subsequent use in the next session.

According to the preferred embodiment of the present invention, the real MAC address to protect against theft etc. is located in the isolated space (FIG. 33, reference numeral 120), isolated and only presented to a Device Authentication Unit without providing any knowledge or persistent identifier regarding CLIENT. Other ways to circumvent is reuse of an address pointing at the Authentication Unit as a gateway.

According to the preferred embodiment of the present invention the future mobile IP standard incorporates the necessary principles for integrating the above modifications. This also covers even an always-on mobile phone as long as a session-switch is applied regularly. The telecom provider will know where a mobile device is, but by incorporating these principles the communication is privacy-enabled because the telecom provider only has a session identifier authenticated by an Authentication Unit. The telecom provider does not know persistent identifiers of either CLIENT or device, and yet still has both a loyal customer, protection against theft, and the ability to provide advanced-location based services simultaneously.

In case of a crime carried out near a mobile phone, there is a route for the police to both establish contact to the relevant CLIENT and a route to accountability (identification) according to the Basic Accountability Principles.

According to the preferred embodiment, this principle of delayed authentication works across location—home, mobile, work, foreign workstations, in-store and even through locations CLIENT has never before had any contact with because an Authentication Unit can instantly intermediate and establish a trusted connection, access to payment channels, and a route to accountability.

According to preferred embodiment, a General Authentication Device will have a mechanism for CLIENT to authenticate toward the SmartCard using biometrics, passwords, pin-code or any other authentication mechanism. The authenticated SmartCard can then verify the internal integrity of a General Authentication Device including a device authentication toward the physically isolated space.

According to a preferred embodiment, a General Authentication Device is able to store Device Certificates in the SmartCard for offline or online authentication of any device or system including the General Authentication Device itself. The SmartCard can specifically get external verification that the Authenticator Device is not reported stolen or otherwise inappropriate to deal with.

A device certificate can be in many forms ranging from a shared secret to an advanced Zero-knowledge Authentication Protocol depending on the type of device and the sensitivity and timing constraints in revoking a certificate. A SmartCard specific authentication key can be created as a Start/End date or a limited show certificate to reduce offline damage in case of theft. The Authenticator—SmartCard combination can after basic authentication create specific authentication with any other external unit made able to authenticate electronically, such as access doors, computers, home control systems, cars, and other specific systems using wireless or cable communication.

The SmartCard can store algorithms and one or more identified or pseudonymous digital signatures related to the user that can be verified through a publicly available register such as an X.509 or any other PKI compliant protocol whereby a General Authentication Device can replace most known designs for smart-card based identifying devices.

According to the preferred embodiment of the present invention, the General Authentication Device can be incorporated as a software-based solution even without physical changes as to the MAC-address. This is more vulnerable to abuse and requires more trust in the Trusted Party because the combination of a Communication Channel Provider and an Authentication Unit will know a persistent identifier even though it is not available to the Trust Unit nor any relationship counterparts. Unless CLIENT is very careful, the telecom provider can easily identify CLIENT using location analyses if for instance the mobile phone is used around the CLIENT's Home.

Zero-Knowledge Authentication.

According to the preferred embodiment of the present invention, the Zero-knowledge authentication mechanism is such that a message transferred is free of any persistent identifier that could be used to identify CLIENT. This means that even a third party able to decrypt communications cannot extract any identifiable information from the communication.

A Trust Unit A knows the public key of the Client B to authenticate because he is provided with an identifer B1. Trust Unit A can verifiy that Authentication Unit does not impersonate CLIENT by carrying out a Zero-knowledge authentication based on the CLIENT encryption key of the Virtual Identity (Cl.Vir.Enc.Pu/Pr).

Trust Unit A generates a random message M. A Sends to B−Challenge=Enc(M,B.Pu). B sends to A−Responds=Enc(H(Dec(Challenge),B.Pr), A.Pu). A can now verify that H(M) equals Dec(Respons,A.Pr) and that B is able to decrypt the message and has in his possession the private key part of B.Pu. Note that B returns the Hash of M and NOT the clear text of M because A would be able to make B decrypt any text including something B wants kept secret. This procedure can be repeated so that A can authenticate towards B and these procedures can also be combined in more efficient protocols.

When the verifying party is not able to make a good guess of the identity of the Authenticating party, then Zero-Knowledge Authentication can take place, making use of pre-arranged one-time-only identifiers. This is the case when a CLIENT carries out a Single Sign-on Authentication toward an Authenticating Unit. The preferred solution is based on a series of Hash values.

The protocol can be initiated and re-established later by a procedure where CLIENT use the General Authentication Device to Generate Hashkey(0) and Hashkey(20) such that Hashkey(t)=H(Hashkey(t−1)). Hashkey(0) and an indicator of status is saved related to the key pair that is authenticated. CLIENT forwards Enc(Cl.Pu+Enc(Hashkey(20),Cl.Pr),TP.Pu). The Authenticating Unit saves Cl.Pu, Hashkey(20) and responds with Enc(H(HashKey(20)),TP.Pr) to prove ability to decrypt the first message and thereby authenticate itself towards CLIENT.

Note that this message is not entirely Zero-knowledge because Cl.Pu is included even though it is encrypted. By signing Hashkey(20) protection against anyone else initiating a fake authentication sequence is provided. Further protection can be incorporated by a multi-step protocol where CLIENT, after having forwarded Cl.Pu, then authenticates Zero—before forwarding Hashkey(20) encrypted.

Whenever CLIENT wants to authenticate towards an Authenticating Unit. CLIENT forwards Enc(Enc(HashKey(t−1),Cl.Pr),HashKey(t)),TP.Pu) using the General Authentication Device. The Authenticating Unit can now decrypt the message and retrieve the One-Time-Only key Hashkey(20) as previously agreed. The Authenticating Unit can then lookup CLIENT and extract the next one-time-only key Hashkey(t−1)=Dec(Enc(HashKey(t−1),Cl.Pr),Cl.Pu)). The Authenticating Unit can verify authentication by verifying that (H(Hashkey(t−1))=Hashkey(t). The Authenticaing Unit then save Hashkey(t−1) for the next authentication operation and authenticate CLIENT toward any third-party such as a Communication Channel Provider.

Non-Linkability of Communication Channels

According to the preferred embodiment of the present invention, control over communication channels is be transferred to CLIENT such that a communication channel provider only knows what is absolutely necessary to perform its service

A mobile telecommunications provider servicing an always-on mobile device with location-tracking knowledge only knows a persistent session identifier and a way to ensure payment

A bank handling deposits only knows a communication channel to the holder of the deposit and a way to ensure authentication of a persistent virtual identifier of the deposit

A credit provider only knows information such as to evaluate credit worthiness and a way to ensure accountability in case the credit agreement is not abided to by the borrower.

A Shipper providing physical transportation of goods only knows information as to a drop point and a way to receive proof of delivery not containing any persistent identifier of the individual.

According to the preferred embodiment of the present invention, a Communication Channel Provider provides a virtual interface specific to the Authentication Unit only to a communication channel where the Communication Channel Provider knows a persistent identifier of CLIENT and/or the channel itself. Hereby the Authentication Unit can remain unknown to identifying information and thus reduce the risk of privacy violations even when CLIENT wants maximum convenience.

For instance a bank (FIG. 32, reference numeral 60) can forward payment with a pre-agreed one-time-only identifier without revealing the actual identity of the paying entity. A shipping drop point (FIG. 32, reference numeral 150) can provide the physical intermediation. An ISP can provide multiple aliases to the same email account.

A two-Way Anonymous Communication Path

The most difficult task is in a privacy- and accountability-enabled supported way to enter into a legally binding contract in a two-way anonymous relationship.

TABLE 1

| | | | Message | |
|---|---|---|---|---|
| | | | m* | |
| A | From | To | m* | |
| (CLIENT) | A | B3 | s*,s1*,s2* | Output |
| | | | mk=ENCS(m,s) | |
| | | | a2k=ENC(s,A2.Enc.Pu) | |
| | | | b2k=ENC(s,B2.Enc.Pu) | |
| | | | tu.m={ENCS(mk,s1),ENC(s1,TU.Pu),a2k,b2k} | |
| | | | mka.hash=H({mk,A2.Enc.Pu}) | |
| | | | m1.sign=ENC(mka.hash,A.DS.Pr) | |
| | | | m1={ENCS({tu.m,mka.hash,m1.sign},s2),ENC(s2, | |
| | | | AU.Pu)} | |
| Auth. | A | B3 | Verify: mka.hash==DEC(m1.sign,A.DS.PU) | Input |
| Unit 1 | | | m1 ok | |
| | A1 | B2 | s3* | Output |
| | | | mka.sign=ENC(mka.hash,A2.DS.Pr) | |
| | | | m2={ENCS({tu.m,mka.sign},s3),ENC(ENC(s3,AU- | |
| | | | 1.Pr),TU.Pu)} | |
| | | | Store: mka.hash,m1.sign | |
| | | | (according to basic accountability principles) | |
| Trust | A1 | B2 | Verify: | Input |
| Unit | | | H({mk,A2.Enc.Pu})==DEC(mka.sign,A2.DS.Pu) | |
| | | | m2 ok | |
| | A2 | B2 | mk - The encrypted message | Relation |
| | | | a2k - A's version of the key to decrypt the | storage |
| | | | message | |
| | | | b2k - B's version of the key to decrypt the | |
| | | | message | |
| | | | mka.sign - A's signature of the encrypted | |
| | | | message | |
| | | | The Trust Unit is able to verify sender, the | |
| | | | signature and provide filtering according to a set | |
| | | | of rules defined by B. | |
| | A2 | B1 | s4* | Output |
| | | | m3={ENCS({mk,mka.sign,b2k},s4),ENC(s4,B2.Enc.- | |
| | | | Pu)} | |
| Auth. | A2 | B1 | m3 | Input |
| Unit 2 | A3 | B | s5* | Output |
| | | | m4={ENCS(m3,s5),ENC(s5,B.Enc.Pu)} | |
| B | A3 | B | m4 | Input |
| (CLIENT) | | | m ok | |

AU1.Pr = Authentication Unit 1 Private Key, TU.Pu = Trust Unit Public Key; {a,b} means a and b concatenated

Table 1. AU1.Pr=Authentication Unit 1 Private Key, TU.Pu=Trust Unit Public Key; {a,b} means a and b concatenated As table 1 shows, multiple address mappings and encryption operations take place. Many of the encryption operations are a semantic description of a normal secured channel such as a Virtual Private Network or an SSL-connection. But the secured channel, such as a Virtual Private Network or an SSL-connection. But the above messages can, with proper protection against timing analyses among the units, be carried out over any long-distance IP-network.

A2 and B2 represents the fully privacy-enabled virtual identities. A2 is a relative address of A specific to the relationship, A3 is a relative address of A specific to B.

A key feature of the preferred embodiment of the present invention is that B3(@Auth1.com) as the TO-address in, for example, an email can be used irrespective of the sending address A, because the Authentication Unit maps A to A1 and ONLY from A1 does B3 provide the correct identifier to the correct relationship Al(@Auth1.com)->B2(@TUx.com). B3 can be any non-unique number or code in a range small enough to ensure a crowd-effect based on existences and use in different CLIENTs' address books and as identifier in communication to and from the Authentication Unit.

Addresses A and B are assumed either a POP-email account with the Authentication Unit over a fully privacy-enabled communication path or any Authentication Unit specific email alias provided by an email service provider.

B3 represents the virtual address of B in the Address Book of A. Al (@Auth1.Com) represents the address of the virtual identity of A in the no-man's land between the Authentication Unit and the Trust Unit. Al may only be unique to Authentication Unit 1 but not among all Authentication Units.

In this example of implementation of the present invention, B can respond with a signature parallel to A and this can without difficulty be extended to a multi-party agreement.

According to the preferred embodiment of the invention multiple CLIENTS or COMPANIES can have keys to any data part of the relationship under full control of the CLIENT A.

For instance only some CLIENT or COMPANIES can have access to data parts containing identifying information while others have only access to the non-identified profile information. This feature makes the invention highly suitable for e.g. Public Citizen records or electronic health care files where the CLIENT patient can give his doctor and the hospital access to identifying information whereas any third-parties such as a healthcare product supplier, a statistics project or medical research group can be granted access to specific parts of the healthcare file only.

According to a particular embodiment of the present invention the Authentication Unit and Trust Unit can in combination do translation of the asymmetric encryption key standard without either the Authentication Unit or the Trust Unit individually being able to read contents of the communication.

In this case the private key encryption key B2.Enc.Pu is known to the Authentication Unit only. The Trust Unit knows an additional asymmetric encryption key and requests Authentication Unit 2 to decrypt b2k and return the real b2k encryption with the correct encryption key. Authentication Unit 2 never has the encrypted message and thus cannot read the message. The Trust Unit never has an unencrypted key.

According to another particular embodiment of the present invention, B can be a non-customer and thus not able to understand mka.sign and mka.hash as these are non-standard to normal email-protocols. But in this case A will know B's standard and create mka.sign and mka.hash according to B's e-mail protocol.

According to a different embodiment of the present invention CLIENT can automatically be aided to create a Backup entry to the same relationship through a second Authentication Unit and store proof of ownership including an encrypted copy of the private encryption key in a generally accessible storage. If the first Authentication Unit is closed down for any reason or CLIENT so prefers he can switch to the second Authentication Unit and continue the relationship unidentified.

Session Manager and Dynamic Firewall

According to the preferred embodiment of the present invention the General Authentication Device preferably is closely shielded to prevent leakage of identifier or other information. This shield is in a preferred embodiment based on a Session Manager in close connection with the Device Firewall controlling all device communication channels.

On initiation the Firewall is totally closed. After offline authentication using the General Authenticator, the Firewall opens for authentication traffic toward the Authentication Unit for authentication only. The General Authenticator receive a session identifier from a Communication Channel Provider or generates a session identifier and forwards said session identifier through a Communication Channel Provider to perform a single sign-on to the Authentication Unit using a zero-knowledge authentication algorithm.

When receiving a request, the Authentication Unit checks if a Session Manager is running. If not the Authentication Unit responds with a Sessions Manager—it is either downloaded or initiated from a local storage area. CLIENT's SmartCard verifies the integrity of the Session Manager before activating. The Session Manager from then on controls the dynamic firewall and provides CLIENT with access to Virtual Identities and related storage and services.

A Session Manager is as such providing CLIENT with an interface able to simultaneously manage multiple sessions authenticated each as different virtual identities through the respective Authentication Unit.

All normal traffic can now leave and enter the workstation according to pre-specified rules without CLIENT involuntarily revealing any traceable information. Special services can be opened by the Session Manager according to pre-specified rules or CLIENT interaction. This can included a Peer-to-Peer connection with friends or a workgroup, a connection to another Authentication Unit, a virtual storage unit, a VPN Connection to a trusted Network (can also be done through an Authentication Unit) etc.

Inbound traffic to a previously verified session is accepted. Outgoing traffic can be filtered and re-routed by the firewall through the proxy where for instance IP-addresses are re-mapped unless specifically opened as a special service. A filter function under CLIENT control can be set up to strip identifying information such as footers in emails from the communication streams.

Privacy Profiler—Privacy Attributes

The Privacy Profiler works with a CLIENT-controlled storage containing a number of privacy attributes that can be either credentials signed by any third party (such as exams, citizenship documents, letters of credit, etc.), or self-signed profile attributes stating preferences, demographics, etc.

Only CLIENT can access these data. They can be stored on a encrypted virtual storage and accessed as a natural extension of the Session Manager and Address Book.

Privacy Credentials can be in the form of

Credential=Encs(“Anonymous Credential”,CredKey),

Enc(CredKey,Third.Party.Pr),—Verifying that Credential is issued by Third-Party

Enc(H(Credential)+Clent Digital Signature.Pu,Third.Party.Pr)—Verifying that Credential is Related to Cl.Pu

or Enc(H(Credential)+Client Digital Signature.Pu, Fourth.Party.Pr)—Fourth Party verifying that they have signature by Third-Party to link Credential to CLIENT.

CLIENT can verify that the credential is anonymous and correct by decrypting the credential using the public key of a third party:

Decs(Credential,Dec(Enc(CredKey,Third.Party.Pr), Third.Party.Pu).

When CLIENT wishes to share a privacy attribute as part of a relationship, the privacy attribute is re-encrypted accordingly by the Privacy Profiler and transferred to the Relationship Storage. Self-signed profile attributes are straightforwardly decrypted and re-encrypted with a random generated symmetric key. The symmetric key is attached in two encrypted versions—One with the CLIENT Relationship Encryption Key and One with the public key of the other relationship party CO.Pu.

An attribute can have a time-dependant certificate attached that limits validity.

When forwarding a credential to a relationship, CLIENT requires TP to verify the third-party or CLIENT signature linking the credential to CLIENT Virtual Identity. CLIENT forwards the Linking Signature only:

Enc(H(Credential)+Cl.Pu,Third.Party.Pr or Fourth.Party.Pr))

and receives

Enc(H(Credential)+Cl.Vir.Pu,Tp.Pr)

stating that TP knows of a signature linking the credential with the real identity of CLIENT. Note that in the preferred embodiment this is a two-step operation. First, the Trust Unit converts the credential link from Client Digital Signature to Client Authentication key toward an Authentication Unit and then the Authentication Unit can convert the credential link from the Client Authentication key to the CLIENT Virtual Identity

The attribute is forwarded to the relationship storage in such a way that TP cannot read the contents. Send-Message=Enc(Enc(Message, Cl.Vir.Enc.Pr), Trust Unit.Pu)

Note that TP never has access to the credential itself and therefore may be unaware of any Profile Information related to CLIENT.

A Form Filler can access the stored relationship attributes and automatically fill out Web forms etc. with attributes and the corresponding decryption keys already known to the relationship.

Dynamic Out-Out and Trust filtering

Trust requires privacy and security, but trust substance is basically to be made on history. According to another aspect of the preferred embodiment, this invention incorporates two main trust concepts for a relationship between a CLIENT or COMPANY A and a CLIENT or COMPANY B

a) Trust History: Establishing a communication path based on previous interactions in the same relationship.

b) Trust Network: Establishing a communication path from A to B based on previous interactions in other relationships with B.

According to this a CLIENT can set up relationship rules that operate on statistical summations of previous evaluations.

The set of Relationship Rules thus works dynamically together with evaluations to provide a user-controlled Dynamic Opt-Out and filtering of Privacy Enabled Communications. Evaluations are directly controlling threshold filters of both inbound and outbound communications.

CLIENT can set up or change the type of inbound messages acceptable based on previously-agreed standards and continuous feedback of evaluations.

If CLIENT is authenticating towards Company, and Company evaluations show a negative development below a threshold, then CLIENT can be informed BEFORE authentication.

Personal Relationship Management—The Extended Address Book

According to an aspect of the preferred embodiment CLIENT access to relationships is based on an address book implemented as part of a Session Manager.

Part of the Session Manager is an Address Book providing an object approach to relationships.

The Address Book accesses a table of bookmarked entries. This table can be stored within the SmartCard, encrypted at the workstation, encrypted as an attachment of the main identity with the Authentication Unit, at a virtual storage location accessible as a relationship or otherwise. If the table is stored outside the SmartCard it is encrypted so that only the SmartCard can decrypt the table refusing to do so unless a certified Session Manager is initiated.

CLIENT can now choose any entry in the Address Book. The Session Manager then establishes access to the target and presents the next dynamic level. For a standard relationship this contains, among other things, a set of relationship history, ongoing activities, a local bookmark list providing handles to relationships, data elements or actions etc.

Table Entry=Personal Ressource Locator|Encryption Key|Type

Personal Ressource Locator=Text Identifier|Logical Locator

Logical Locater=Authenticator.Identity.Nested Relationship

Nested Relationship=Relationship.{Object|Action|Nested Relationship}

According to the preferred embodiment of the present invention, addressing can be entirely relative to the viewpoint without any unique identifier. Any point can be reached as a series of steps from where it starts. Without knowledge of the starting point a Logical Locater is not dangerous because any starting point can give a reasonable answer. In the email example the Logical Locator is represented by A3 respectively B3.

Any unique identifier should be treated as an attribute of a relationship. Thus even strongly identified relationships can be anonymous and appear relative to any Unit in the set-up and to anyone listening in.

Company Customer Relationship Management

According to the preferred embodiment of the present invention Company will have access to the full profile of a Virtual CLIENT through the Integration Unit providing one Interface to Customer across Contact Points and Communication Channels.

Through the Privacy Profile Manage as part of the Session Manager and Address Book, CLIENT sets up a Privacy Profile of the Virtual CLIENT Identity attached to the relationship in the Trust Unit as a collection of profile information with keys encrypted with the public key of Company Co.Pu. Information is thus always available and up-to-date whenever CLIENT interacts with Company. The same storage can contain the dialog history, the trade history etc.

A Form Filler can automatically fill out COMPANY forms with attribute information already known to the relationship and thereby eliminate redundant requests for CLIENT information.

As the Relative Addressing Principle is reachable from any system or an employee or partner of Company with security clearance to act on behalf of Company, Company specifically gets the advantage of being able to address any item from any starting point. An item can for instance be a specific attribute of a CLIENT Customer such as age, an invoice, a Communication Channel Identifier or a Process Initiator. Customer management will thus become privacy enabled and made transparent across systems and organizations at the same time.

Explanation of Terms

TP—Trusted Party—the entity that implements the Privacy Services. Major parts of the services can be outsourced to sub-suppliers. TP covers both the Trusted party and Sub-suppliers.

In the preferred embodiment TP is split up into multiple units: AU—Authentication Unit, ID—ID Unit, TU—Trust Unit, Device Authentication Unit according to FIG. 32.

VID—Virtual Identity—An identified or non-identified pseudonym linked to a CLIENT Role and related to a number of COMPANY or RELATION.

VID TYPE—VIDs are divided into specific types with possibility to determine default access. For instance an identified VID will only offer limited access to Private Data.

PRIVACY SERVER—A server in a distributed network offering the full range of services. In implementation different physical or logical services will be servicing different types of tasks in order to balance load and ensure response times.

INVOICE SERVER—A specially isolated server handling the collection of invoices.

PRIVACY CLIENT—Software functionality operating on a CLIENT device. Can be a simple manually previously agreed information such as a challenge-response pair.

CLIENT—Individual Person that is Privacy Enabled. A CLIENT can be using a work role and acting on behalf of a COMPANY as a purchaser. The term “CLIENT” usually implies an individual.

ROLE—A CLIENT context. This can be private, family, employment, public function, member of a board etc.

RELATION—A link between CLIENTs representing a personal relationship (a friend, family, business connection etc.). RELATIONs are one-way and controlled by the information disclosing entity. A two-way relationship thus requires two RELATION entries.

COMPANY—An organizational entity. This can be any selling or service organization including a shop, an online community, a basic supplier etc. The term COMMUNITY is used to focus on the online COMPANY interacting with multiple CLIENTs. Often CLIENTs are provided with means to interact directly using tools such as online chat or discussion databases.

BUYER—An entity interested in acquiring a service or good. If not otherwise stated a BUYER is a CLIENT.

SELLER—An entity interesting in selling a service or good. If not otherwise stated a SELLER is a COMPANY. For different services involving two-way anonymity such as an Auction service a SELLER is CLIENT different from the BUYER.

AGENT—A service that analyzes CLIENT or COMPANY data in order to provide services for either CLIENT or COMPANY. AGENT comes in different versions.

A SHIPPER is a business offering transportation services of letters or parcels. If not otherwise stated the service involved is parcel transportation.

Encryption:

Encs(x,y)—The result of symmetrically Encrypting the String X with symmetric key Y.

Decs(x,y)—The result of symmetrically Decrypting the encrypted string X with the symmetric key Y.

Enc(x,y)—The result of asymmetrically Encrypting the String X with asymmetric key Y.

Dec(x,y)—The result of asymmetrically Decrypting the encrypted string X with the asymmetric key Y.

Co is a general abbreviation of COMPANY

TP is a general abbreviation of Trusted Party

TU is a general abbreviation of Trust Unit

AU is a general abbreviation of Authentication Unit

Sh is a general abbreviation of a SHIPPER

Cl is a general abbreviation of a CLIENT

Cl.Vir ia a general abbreviation of a virtual identity VID of CLIENT

Co.Pu, TP.Pu, AU.Pu, TU.Pu, Sh.Pu, Cl.Pu, Cl.Vir.Pu—The Public Key of a Private/Public encryption key pairs Co, TP, AU, TU, Sh, Cl, Cl.Vir

Co.Pr, TP,Pr, AU.PR, TU.Pr, Sh.Pr, Cl.Pr, Cl.Vir.Pr—The Private Key of a Private/Public encryption key pairs Co, TP, AU, TU, Sh, Cl, Cl.VIr

1. A method of establishing a communication path between a first and a second legal entity, comprising the steps of:
providing a first virtual identifier of the first legal entity to the second legal entity; and
establishing a communication path in accordance with a set of communication rules specified by the first legal entity between the first and the second legal entity, the first legal entity remaining anonymous to the second legal entity;
wherein the second legal entity is provided with means for obtaining a legal identification of the first legal entity based on the first virtual identifier, which means for legal identification is provided by a third legal entity according to a set of rules agreed between the first legal entity and the third legal entity;
wherein the means for legal identification is provided by the third legal entity according to a set of rules determined by a fourth legal entity,
and wherein the second legal entity is provided with means for obtaining information about a previous communication path for the first virtual identifier of the first legal entity.

2. A method according to claim 1, further comprising the steps of:
providing a second virtual identifier of the second legal entity to the first legal entity, the second legal entity remaining anonymous to the first legal entity; and
establishing the communication path in accordance with a second set of communication rules specified by the second legal entity.

3. A method according to claim 1, wherein the communication path is established between the first legal entity and a third legal entity in accordance with a first set of communication rules specified by the first legal entity;
and wherein another communication path is established between the second legal entity and the third legal entity in accordance with the second set of communication rules specified by the second legal entity, so as to establish communication between the first legal entity and the second legal entity.

4. A method according to claim 1, wherein selected information is transferred to a first information carrier based on the first set of communication rules, wherein the third legal entity is provided with a profile of the first legal entity, wherein the third legal entity is invited to-transfer selected information from the first information carrier to a second information carrier based on the profile, and wherein a commercial transaction is established based on information comprising at least one of the first and second information carriers.

5. A method according to claim 1, wherein the communication path is established between the first legal entity and the second legal entity based on information about the previous communication path established with the second legal entity.

6. A method according to claim 1, wherein the second legal entity is provided with a profile of the first legal entity and wherein the third legal entity can confirm the profile, the first legal entity remaining anonymous to the second legal entity.

7. A method for performing commercial transactions between a first legal entity and a second legal entity, wherein a communication path is established according to the method of claim 1, and wherein the communication path is adapted for providing a legal commitment of one of either the first or the second legal entity, the first legal entity remaining anonymous to the second legal entity, and wherein a third legal entity can confirm the existence of a traceable non-refutable legal commitment of the one of either the first or the second legal entity, and wherein the third legal entity can provide proof of existence of the legal commitment.

8. A method according to claim 7, further comprising the step of providing the second legal entity with means for associating a first virtual identifier of the first legal entity with previous legal commitments established with the first legal entity, and wherein the second legal entity is provided with means for obtaining information about previous legal commitments for a first virtual identifier of the first legal entity, and wherein a legal commitment is established between the first legal entity and the second legal entity based on information about previous legal commitments established with the second legal entity, and wherein the third legal entity is provided with information about legal commitments between the first legal entity and the second legal entity, and wherein the first legal entity remains anonymous to the third legal entity, and wherein the legal commitment comprises performing at least one of the following steps:
transferring legal rights between the first legal entity and the second legal entity,
transferring goods or services between the first legal entity and the second legal entity, arbitrating a dispute between the first legal entity and the second legal entity,
and wherein the first legal entity remains anonymous to the second legal entity,
and wherein the second legal entity remains anonymous to the first legal
entity,
and wherein the first legal entity transfers a financial instrument to the second legal entity, the first legal entity remaining anonymous to the second legal entity.

9. A method according claim 7, further comprising the steps of:
depositing a financial instrument with the third legal entity,
the first legal entity ordering a service from the second legal entity,
the second legal entity requesting confirmation of payment from the third legal entity,
the second legal entity delivering the service addressing the virtual identifier of the first legal entity upon receipt of the confirmation,
releasing payment according to a pre-defined set of trade rules.

10. A method according to claim 7, further comprising the step of addressing the virtual identifier, including the use of an identifier of the third legal entity, a virtual identifier of the second legal entity, an encrypted virtual identifier of the first legal entity, and an encrypted identifier of a service, wherein the encrypted identifiers are decrypted by a key common to the second legal entity and the third legal entity,
and wherein the step of delivering comprises the step of:
forwarding the service to a fourth legal entity,
the fourth legal entity requesting a physical delivery address from the third legal entity,
the third legal entity providing the physical delivery address to the fourth legal entity according to the first set of communication rules,
and wherein the step of delivering further comprises the step of: the fourth legal entity receiving a receipt proof of delivery acknowledging delivery of the service at the physical address and wherein the proof of delivery can be verified by the fourth legal entity.

11. A method for performing commercial transactions between a first legal entity and a second legal entity using communication paths are established by the method of claim 1, wherein a first communication path is established between the first legal entity and a third legal entity, wherein a second communication path is established between the second legal entity and the third legal entity, and wherein the first and second communication paths are adapted for providing a legal commitment of the first legal entity towards the second legal entity, the step of providing said legal commitment comprising the steps of:
the first legal entity providing the second legal entity with an identifier,
the second legal entity requesting the third legal entity a first legal commitment provided the identifier,
the third legal entity requesting the first legal entity a second legal commitment,
the third legal entity accepting the request from the second legal entity upon receipt of the second legal commitment,
and wherein the communication path between the third legal entity and the first legal entity is established by a fourth legal entity, the communication path to the first legal entity remaining unknown to the third legal entity.

12. A system for establishing a privacy communication channel between a first client and a second client, said system comprising:
(a) a general authentication device for providing said first client control with a private encryption key stored in a mobile processing and memory unit,
(b) a communication channel provider for communicating with said first client and for establishing a privacy communication channel for said first client,
(c) an authentication unit for communicating through said privacy communication channel with said first client and for providing a first intermediary between said first client and said second client, said authentication unit enabling said first client to establish a first virtual identity having a first virtual communication channel and to establish a rule-based communication routing scheme for said privacy communication channel,
(d) a trust unit for communicating with said authentication unit through said virtual communication channel providing a second intermediary between said first virtual identity and said second client and for providing storage of first client profile information and providing communication filtering on the basis of said profile information, and
wherein said first client applies said private encryption key for encrypting said profile information so as to enable anonymous communication from said first client to said second client.

13. A system according to claim 12, wherein said authentication unit further enables said second client for establishing a second virtual identity having a second virtual communication channel and establishing a rule-based communication routing scheme for a privacy communication channel between said authentication unit and said second client.

14. A system according to claim 12, further comprising an integration unit for communicating with said second client and for providing said second client an interface to said first virtual identity of said first client.

15. A general authentication device for establishing a privacy communication channel between an anonymous client and an authentication unit, said general authentication device comprising:
(a) a main processing unit for establishing and controlling communication with a communication channel provider interconnecting said general authentication device and said authentication unit,
(b) a unit reader for connecting a mobile processing and memory unit with the general authentication device,
(c) a memory space for containing persistent identifier of said general authentication device accessible by said mobile processing and memory unit,
wherein said mobile processing and memory unit authenticates the privacy communication channel to the authenticating unit on the basis of the persistent identifier in the memory space.
